(19) United States
(12) Patent Application Publication
(10) Pub. No.: US 2026/0176190 A1
(43) Pub. Date: Jun. 25, 2026

(54) GLASS-CERAMIC ARTICLES WITH IMPROVED FRACTURE TOUGHNESS AND CONTROLLABLE TRANSLUCENCY

(71) Applicant: CORNING INCORPORATED, CORNING, NY (US)

(72) Inventors: Carol Ann Click, Corning, NY (US); Anthony Vincent DeCeanne, Painted Post, NY (US); Mathieu Gerard Jacques Hubert, Corning, NY (US); Yuhui Jin, Painted Post, NY (US); Michael Morgan Oliver, Hammondsport, NY (US); Pascale Oram, Painted Post, NY (US); John Richard Ridge, Hammondsport, NY (US); John Robert Saltzer, JR., Beaver Dams, NY (US); Charlene Marie Smith, Corning, NY (US)

(21) Appl. No.: 19/421,806

(22) Filed: Dec. 16, 2025

Related U.S. Application Data
(60) Provisional application No. 63/737,597, filed on Dec. 20, 2024.

(51) Int. Cl. C03C 10/00; C03B 32/02; C03C 4/02

(52) U.S. Cl. CPC C03C 10/0027; C03B 32/02; C03C 4/02

(57) ABSTRACT

A glass-ceramic article comprises a phase assemblage comprising: greater than or equal to 10 wt % and less than or equal to 30 wt % residual amorphous glass phase; greater than or equal to 20 wt % and less than or equal to 42 wt % lithium disilicate crystalline phase; less than or equal to 42 wt % spodumene crystalline phase; and less than or equal to 40 wt % petalite crystalline phase. The glass-ceramic article has: an opacity greater than or equal to 10% and less than or equal to 65%, measured on a 0.55 mm thick glass-ceramic article; and a haze greater than or equal to 0.2% and less than or equal to 98%, measured on a 0.5 mm thick glass-ceramic article.

### CROSS REFERENCE TO RELATED APPLICATION

This application claims the benefit of priority under 35 U.S.C. § 119 of U.S. Provisional Application Ser. No. 63/737,597, filed on Dec. 20, 2024, the content of which is relied upon and incorporated herein by reference in its entirety.

### BACKGROUND

### Field

The present specification generally relates to glass-ceramic articles and, more particularly, to glass-ceramic articles having improved mechanical properties and controlled translucency.

### Technical Background

There is a demand for high strength glass-based articles that may be used in conjunction with, for example, portable electronic devices. Several materials are currently utilized on the market such as glass, zirconia, plastic, metal, and glass-ceramics.

Glass-ceramics have certain advantages over other materials. However, it can be difficult to form glass-ceramics having desired aesthetic features while maintaining the mechanical properties required for portable electronic devices.

Accordingly, a need exists for glass-ceramics having improved properties and methods for making the glass-ceramics.

### SUMMARY

According to a first aspect of the present disclosure, a glass-ceramic article comprises a phase assemblage comprising: greater than or equal to 10 wt % and less than or equal to 30 wt % residual amorphous glass phase; greater than or equal to 20 wt % and less than or equal to 42 wt % lithium disilicate crystalline phase; less than or equal to 42 wt % spodumene crystalline phase; and less than or equal to 40 wt % petalite crystalline phase, wherein the glass-ceramic article has: an opacity greater than or equal to 10% and less than or equal to 65%, measured on a 0.55 mm thick glass-ceramic article; and a haze greater than or equal to 0.2% and less than or equal to 98%, measured on a 0.5 mm thick glass-ceramic article.

A second aspect includes the first aspect, wherein the phase assemblage comprises greater than or equal to 2 wt % and less than or equal to 50 wt % of a sum of a virgilite crystalline phase and the spodumene crystalline phase.

A third aspect includes the second aspect, wherein the phase assemblage comprises greater than or equal to 30 wt % and less than or equal to 50 wt % of the sum of the virgilite crystalline phase and the spodumene crystalline phase, and wherein the glass-ceramic article has at least one of the following optical properties: an opacity greater than or equal to 18.5% and less than or equal to 65%, measured on a 0.55 mm thick glass-ceramic article; or a haze greater than or equal to 40% and less than or equal to 95%, measured on a 0.5 mm thick glass-ceramic article.

A fourth aspect includes the second aspect, wherein the phase assemblage comprises greater than or equal to 32.5 wt % and less than or equal to 50 wt % of the sum of the virgilite crystalline phase and the spodumene crystalline phase, and wherein the glass-ceramic article has at least one of the following optical properties: an opacity greater than or equal to 20% and less than or equal to 65%, measured on a 0.55 mm thick glass-ceramic article; or a haze greater than or equal to 40% and less than or equal to 95%, measured on a 0.5 mm thick glass-ceramic article.

A fifth aspect includes any one of the first through fourth aspects, wherein the phase assemblage comprises greater than or equal to 1 wt % and less than or equal to 40 wt % virgilite crystalline phase, and wherein the glass-ceramic article has a haze greater than or equal to 0.2% and less than or equal to 95%, measured on a 0.5 mm thick glass-ceramic article.

A sixth aspect includes any one of the first through fifth aspects, wherein the phase assemblage comprises greater than or equal to 2.5 wt % and less than or equal to 40 wt % of the virgilite crystalline phase, and wherein the glass-ceramic article has an opacity greater than or equal to 10% and less than or equal to 50%, measured on a 0.55 mm thick glass-ceramic article.

A seventh aspect includes any one of the first through sixth aspects, wherein the phase assemblage comprises less than or equal to 9 wt % of the petalite crystalline phase, and wherein the glass-ceramic article has an opacity greater than or equal to 20% and less than or equal to 50%, measured on a 0.55 mm thick glass-ceramic article.

An eighth aspect includes any one of the first through third, fifth, or sixth aspects, wherein the phase assemblage comprises greater than or equal to 30 wt % and less than or equal to 50 wt % of the sum of the virgilite crystalline phase and the spodumene crystalline phase, and wherein the glass-ceramic article has an opacity greater than or equal to 18.5% and less than or equal to 50%, measured on a 0.55 mm thick glass-ceramic article.

A ninth aspect includes the eighth aspect, wherein the phase assemblage comprises less than or equal to 9 wt % of the petalite crystalline phase, and wherein the glass-ceramic article has an opacity greater than or equal to 20% and less than or equal to 50%, measured on a 0.55 mm thick glass-ceramic article.

A tenth aspect include any one of the first through ninth aspects, wherein the phase assemblage comprises greater than or equal to 6 wt % and less than or equal to 40 wt % of the virgilite crystalline phase.

An eleventh aspect includes any one of the first through tenth aspects, wherein the phase assemblage comprises greater than 14 wt % and less than or equal to 30 wt % of the residual amorphous glass phase.

A twelfth aspect includes any one of the first through tenth aspects, wherein the phase assemblage comprises greater than or equal to 20 wt % and less than or equal to 30 wt % of the residual amorphous glass phase.

A thirteenth aspect includes any one of the first through twelfth aspects, wherein the phase assemblage comprises greater than or equal to 2 wt % and less than or equal to 42 wt % of the spodumene crystalline phase.

A fourteenth aspect includes any one of the first through twelfth aspects, wherein the phase assemblage comprises greater than or equal to 2 wt % and less than or equal to 33 wt % of the spodumene crystalline phase.

A fifteenth aspect includes any one of the first through fourteenth aspects, wherein the phase assemblage comprises greater than or equal to 1 wt % and less than or equal to 6 wt % lithium phosphate crystalline phase.

A sixteenth aspect includes any one of the first through fifteenth aspects, wherein the glass-ceramic article comprises: greater than or equal to 65 wt % and less than or equal to 80 wt % SiO₂; greater than 2 wt % and less than or equal to 12 wt % Al₂O₃; greater than or equal to 0.1 wt % and less than or equal to 3.5 wt % P₂O₅; greater than or equal to 8 wt % and less than or equal to 26 wt % Li₂O; greater than or equal to 1 wt % and less than or equal to 15 wt % ZrO₂; and less than or equal to 4 wt % CaO.

A seventeenth aspect includes any one of the first through sixteenth aspects, wherein the glass-ceramic article comprises: greater than 4 wt % and less than or equal to 12 wt % Al₂O₃; greater than or equal to 8 wt % and less than or equal to 17 wt % Li₂O; greater than or equal to 4 wt % and less than or equal to 15 wt % ZrO₂; and greater than or equal to 0.05 wt % and less than or equal to 4 wt % CaO.

An eighteenth aspect includes any one of the first through sixteenth aspects, wherein the glass-ceramic article comprises: greater than 2 wt % and less than or equal to 8 wt % Al₂O₃; greater than or equal to 0.1 wt % and less than or equal to 2 wt % P₂O₅; greater than or equal to 16 wt % and less than or equal to 26 wt % Li₂O; greater than or equal to 1 wt % and less than or equal to 6 wt % ZrO₂; and greater than or equal to 0.5 wt % and less than or equal to 5 wt % Na₂O.

A nineteenth aspect includes any one of the first through eighteenth aspects, wherein the glass-ceramic article comprises less than or equal to 0.1 wt % CaO.

A twentieth aspect includes any one of the first through nineteenth aspects, wherein the glass-ceramic article exhibits a transmitted color, measured on a 0.5 mm thick glass-ceramic article using a D-65-2 illuminant and presented in CIELAB color space coordinates: L*=80 to 99; a*=−5.0 to 10.0; and b*=−5.0 to 25.0.

A twenty-first aspect includes any one of the first through twentieth aspects, wherein the glass-ceramic article has an average total transmittance greater than or equal to 30% and less than or equal to 95%, measured on a 0.55 mm thick glass-ceramic article at wavelengths of 400 nm to 800 nm.

A twenty-second aspect includes any one of the first through twentieth aspects, wherein the glass-ceramic article has an average total transmittance greater than or equal to 30% and less than or equal to 91%, measured on a 0.55 mm thick glass-ceramic article at wavelengths of 400 nm to 800 nm.

A twenty-third aspect includes any one of the first through twenty-second aspects, wherein the glass-ceramic article has an average total transmittance greater than or equal to 30% and less than or equal to 95%, measured on a 0.55 mm thick glass-ceramic article at wavelengths of 400 nm to 1000 nm.

A twenty-fourth aspect includes any one of the first through twenty-second aspects, wherein the glass-ceramic article has an average total transmittance greater than or equal to 30% and less than or equal to 91%, measured on a 0.55 mm thick glass-ceramic article at wavelengths of 400 nm to 1000 nm.

A twenty-fifth aspect includes any one of the first through nineteenth or twenty-first through twenty-fourth aspects, wherein the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates: L*=50 to 99; a*=−5.0 to 10.0; and b*=−5.0 to 25.0.

A twenty-sixth aspect includes any one of the first through twenty-fifth aspects, wherein the glass-ceramic article exhibits a reflected color, measured using a D-65-2 illuminant with a black background on a glass-ceramic article having a thickness greater than or equal to 0.5 mm and less than or equal to 0.55 mm, presented in CIELAB color space coordinates: L*=30 to 85; a*=−10.0 to 10.0; and b*=−25.0 to 5.0.

A twenty-seventh aspect includes any one of the first through twenty-sixth aspects, wherein the glass-ceramic article exhibits a reflected color, measured using a D-65-2 illuminant with a white background on a glass-ceramic article having a thickness greater than or equal to 0.5 mm and less than or equal to 0.55 mm, presented in CIELAB color space coordinates: L*=80 to 98; a*=−10.0 to 5.0; and b*=−10.0 to 10.0.

A twenty-eighth aspect includes any one of the first through twenty-seventh aspects, wherein the glass-ceramic article has a thickness t great than or equal to 0.3 mm and less than or equal to 0.6 mm.

A twenty-ninth aspect includes any one of the first through twenty-seventh aspects, wherein the glass-ceramic article is ion-exchanged strengthened.

A thirtieth aspect includes any one of the first through twenty-ninth aspects, further comprising: a compressive stress layer extending from a surface of the glass-ceramic to a depth of compression; and a central tension, wherein the central tension is greater than or equal to 40 MPa and less than or equal to 170 MPa.

A thirty-first aspect includes the thirtieth aspect, wherein the compressive stress layer comprises a surface compressive stress greater than or equal to 150 MPa and less than or equal to 550 MPa.

A thirty-second aspect includes either one of the thirty or thirty-first aspects, wherein the glass-ceramic article has a thickness t and the depth of compression is greater than or equal to 0.09*t to less than or equal to 0.30*t.

A thirty-third aspect includes either one of the thirty or thirty-first aspects, wherein the depth of compression is greater than or equal to 0.15*t to less than or equal to 0.26*t.

A thirty-fourth aspect includes any one of the first through thirty-third aspects, wherein the glass-ceramic article has a fracture toughness greater than or equal to 1.0 MPa·m^{1/2} and less than or equal to 2.4 MPa·m^{1/2} prior to strengthening by ion exchange.

A thirty-fifth aspect includes any one of the first through thirty-fourth aspects, wherein the glass-ceramic article has an elastic modulus greater than or equal to 90 GPa and less than or equal to 200 GPa.

A thirty-sixth aspect includes any one of the first through thirty-fifth aspects, wherein the glass-ceramic article comprises a textured surface having a surface roughness Ra of greater than or equal to 0.2 μm and less than or equal to 1.2 μm.

A thirty-seventh aspect includes the thirty-sixth aspect, wherein the textured surface of the glass-ceramic article is provided with an antireflective coating having a total physical thickness between 200 nm and 500 nm.

According to a thirty-eighth aspect of the present disclosure, an electronic device comprises a protective substrate positioned on a back side of the electronic device, wherein the protective substrate comprises the glass-ceramic article of any one of the first through thirty-seventh aspects.

According to a thirty-ninth aspect of the present disclosure, a glass-ceramic article comprises a phase assemblage comprising: greater than or equal to 10 wt % and less than or equal to 30 wt % residual amorphous glass phase; greater than or equal to 20 wt % and less than or equal to 42 wt % lithium disilicate crystalline phase; less than or equal to 42 wt % spodumene crystalline phase; and greater than or equal to 2 wt % and less than or equal to 50 wt % of a sum of a virgilite crystalline phase and the spodumene crystalline phase, wherein the glass-ceramic article has: an opacity greater than or equal to 10% and less than or equal to 65%, measured on a 0.55 mm thick glass-ceramic article; and a haze greater than or equal to 0.2% and less than or equal to 95%, measured on a 0.5 mm thick glass-ceramic article.

A fortieth aspect includes the thirty-ninth aspect, wherein the phase assemblage comprises less than or equal to 35 wt % of the spodumene crystalline phase.

A forty-first aspect includes either one of the thirty-ninth or fortieth aspects, wherein the phase assemblage comprises less than or equal to 40 wt % petalite crystalline phase.

A forty-second aspect includes the forty-first aspect, wherein the phase assemblage comprises less than or equal to 9 wt % of the petalite crystalline phase, and wherein the glass-ceramic article has an opacity greater than or equal to 20% and less than or equal to 60%, measured on a 0.55 mm thick glass-ceramic article.

A forty-third aspect includes any one of the thirty-ninth through forty-second aspects, wherein the phase assemblage comprises greater than or equal to 2.5 wt % and less than or equal to 40 wt % of the virgilite crystalline phase, and wherein the glass-ceramic article has an opacity greater than or equal to 20% and less than or equal to 50%, measured on a 0.55 mm thick glass-ceramic article.

A forty-fourth aspect includes any one of the thirty-ninth through forty-first aspects, wherein the phase assemblage comprises greater than or equal to 1 wt % and less than or equal to 40 wt % of the virgilite crystalline phase, and wherein the glass-ceramic article has a haze greater than or equal to 0.2% and less than or equal to 95%, measured on a 0.5 mm thick glass-ceramic article.

A forty-fifth aspect includes any one of the thirty-ninth through forty-first or forty-fourth aspects, wherein the phase assemblage comprises greater than or equal to 2.5 wt % and less than or equal to 40 wt % of the virgilite crystalline phase, and wherein the glass-ceramic article has an opacity greater than or equal to 10% and less than or equal to 50%, measured on a 0.55 mm thick glass-ceramic article.

A forty-sixth aspect includes any one of the thirty-ninth through forty-first, forty-fourth, or forty-fifth aspects, wherein the phase assemblage comprises greater than or equal to 30 wt % and less than or equal to 50 wt % of the sum of the virgilite crystalline phase and the spodumene crystalline phase, and wherein the glass-ceramic article has an opacity greater than or equal to 18.5% and less than or equal to 50%, measured on a 0.55 mm thick glass-ceramic article.

A forty-seventh aspect includes any one of the thirty-ninth through forty-first, forty-fourth, or forty-fifth aspects, wherein the phase assemblage comprises greater than or equal to 32.5 wt % and less than or equal to 50 wt % of the sum of the virgilite crystalline phase and the spodumene crystalline phase, and wherein the glass-ceramic article has an opacity greater than or equal to 20% and less than or equal to 50%, measured on a 0.55 mm thick glass-ceramic article.

A forty-eighth aspect includes any one of the thirty-ninth through forty-seventh aspects, wherein the phase assemblage comprises greater than or equal to 6 wt % and less than or equal to 40 wt % of the virgilite crystalline phase.

A forty-ninth aspect includes any one of the thirty-ninth through forty-eighth aspects, wherein the phase assemblage comprises greater than 14 wt % and less than or equal to 30 wt % of the residual amorphous glass phase.

A fiftieth aspect includes any one of the thirty-ninth through forty-eighth aspects, wherein the phase assemblage comprises greater than or equal to 20 wt % and less than or equal to 30 wt % of the residual amorphous glass phase.

A fifty-first aspect includes any one of the thirty-ninth or forty-first through fiftieth aspects, wherein the phase assemblage comprises greater than or equal to 2 wt % and less than or equal to 42 wt % of the spodumene crystalline phase.

A fifty-second aspect includes any one of the thirty-ninth through fiftieth aspects, wherein the phase assemblage comprises greater than or equal to 2 wt % and less than or equal to 33 wt % of the spodumene crystalline phase.

A fifty-third aspect includes any one of the thirty-ninth through fifty-second aspects, wherein the phase assemblage comprises greater than or equal to 1 wt % and less than or equal to 6 wt % lithium phosphate crystalline phase.

A fifty-fourth aspect includes any one of the thirty-ninth through fifty-third aspects, wherein the glass-ceramic article comprises: greater than or equal to 65 wt % and less than or equal to 80 wt % SiO₂; greater than 2 wt % and less than or equal to 12 wt % Al₂O₃; greater than or equal to 0.1 wt % and less than or equal to 3.5 wt % P₂O₅; greater than or equal to 8 wt % and less than or equal to 26 wt % Li₂O; greater than or equal to 1 wt % and less than or equal to 15 wt % ZrO₂; and less than or equal to 4 wt % CaO.

A fifty-fifth aspect includes any one of the thirty-ninth through fifty-fourth aspects, wherein the glass-ceramic article comprises: greater than 4 wt % and less than or equal to 12 wt % Al₂O₃; greater than or equal to 8 wt % and less than or equal to 17 wt % Li₂O; greater than or equal to 4 wt % and less than or equal to 15 wt % ZrO₂; and greater than or equal to 0.05 wt % and less than or equal to 4 wt % CaO.

A fifty-sixth aspect includes any one of the thirty-ninth through fifty-fourth aspects, wherein the glass-ceramic article comprises: greater than 2 wt % and less than or equal to 8 wt % Al₂O₃; greater than or equal to 0.1 wt % and less than or equal to 2 wt % P₂O₅; greater than or equal to 16 wt % and less than or equal to 26 wt % Li₂O; greater than or equal to 1 wt % and less than or equal to 6 wt % ZrO₂; and greater than or equal to 0.5 wt % and less than or equal to 5 wt % Na₂O.

A fifty-seventh aspect includes any one of the thirty-ninth through fifty-sixth aspects, wherein the glass-ceramic article comprises comprising less than or equal to 0.1 wt % CaO.

A fifty-eighth aspect includes any one of the thirty-ninth through fifty-seventh aspects, wherein the glass-ceramic article exhibits a transmitted color, measured on a 0.5 mm thick glass-ceramic article using a D-65-2 illuminant and presented in CIELAB color space coordinates: L*=80 to 99; a*=−5.0 to 10.0; and b*=−5.0 to 25.0.

A fifty-ninth aspect includes any one of the thirty-ninth through fifty-eighth aspects, wherein the glass-ceramic article has an average total transmittance greater than or equal to 30% and less than or equal to 95%, measured on a 0.55 mm thick glass-ceramic article at wavelengths of 400 nm to 800 nm.

A sixtieth aspect includes any one of the thirty-ninth through fifty-eighth aspects, wherein the glass-ceramic article has an average total transmittance greater than or equal to 30% and less than or equal to 91%, measured on a 0.55 mm thick glass-ceramic article at wavelengths of 400 nm to 800 nm.

A sixty-first aspect includes any one of the thirty-ninth through sixtieth aspects, wherein the glass-ceramic article has an average total transmittance greater than or equal to 30% and less than or equal to 95%, measured on a 0.55 mm thick glass-ceramic article at wavelengths of 400 nm to 1000 nm.

A sixty-second aspect includes any one of the thirty-ninth through sixtieth aspects, wherein the glass-ceramic article has an average total transmittance greater than or equal to 30% and less than or equal to 91%, measured on a 0.55 mm thick glass-ceramic article at wavelengths of 400 nm to 1000 nm.

A sixty-third aspect includes any one of the thirty-ninth through fifty-seventh or fifty-ninth through sixty-second aspects, wherein the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates: L*=50 to 99; a*=−5.0 to 10.0; and b*=−5.0 to 25.0.

A sixty-fourth aspect includes any one of the thirty-ninth through sixty-third aspects, wherein the glass-ceramic article exhibits a reflected color, measured using a D-65-2 illuminant with a black background on a glass-ceramic article having a thickness greater than or equal to 0.5 mm and less than or equal to 0.55 mm, presented in CIELAB color space coordinates: L*=30 to 85; a*=−10.0 to 10.0; and b*=−25.0 to 5.0.

A sixty-fifth aspect includes any one of the thirty-ninth through sixty-fourth aspects, wherein the glass-ceramic article exhibits a reflected color, measured using a D-65-2 illuminant with a white background on a glass-ceramic article having a thickness greater than or equal to 0.5 mm and less than or equal to 0.55 mm, presented in CIELAB color space coordinates: L*=80 to 98; a*=−10.0 to 5.0; and b*=−10.0 to 10.0.

A sixty-sixth aspect includes any one of the thirty-ninth through sixty-fifth aspects, wherein the glass-ceramic article has a thickness t great than or equal to 0.3 mm and less than or equal to 0.6 mm.

A sixty-seventh aspect includes any one of the thirty-ninth through sixty-sixth aspects, wherein the glass-ceramic article is ion-exchanged strengthened.

A sixty-eighth aspect includes any one of the thirty-ninth through sixty-seventh aspects, further comprising: a compressive stress layer extending from a surface of the glass-ceramic to a depth of compression; and a central tension, wherein the central tension is greater than or equal to 40 MPa and less than or equal to 170 MPa.

A sixty-ninth aspect includes the sixty-eighth aspect, wherein the compressive stress layer comprises a surface compressive stress greater than or equal to 150 MPa and less than or equal to 550 MPa.

A seventieth aspect includes either one of the sixty-eighth or sixty-ninth aspects, wherein the glass-ceramic article has a thickness t and the depth of compression is greater than or equal to 0.09*t to less than or equal to 0.30*t.

A seventy-first aspect includes either one of the sixty-eighth or sixty-ninth aspects, wherein the depth of compression is greater than or equal to 0.15*t to less than or equal to 0.26*t.

A seventy-second aspect includes any one of the thirty-ninth through seventy-first aspects, wherein the glass-ceramic article has a fracture toughness greater than or equal to 1.0 MPa·m^{1/2} and less than or equal to 2.4 MPa·m^{1/2} prior to strengthening by ion exchange.

A seventy-third aspect includes any one of the thirty-ninth through seventy-second aspects, wherein the glass-ceramic article has an elastic modulus greater than or equal to 90 GPa and less than or equal to 200 GPa.

A seventy-fourth aspect includes any one of the thirty-ninth through seventy-third aspects, wherein the glass-ceramic article comprises a textured surface having a surface roughness Ra of greater than or equal to 0.2 μm and less than or equal to 1.2 μm.

A seventy-fifth aspect includes the seventy-fourth aspect, wherein the textured surface of the glass-ceramic article is provided with an antireflective coating having a total physical thickness between 200 nm and 500 nm.

According to a seventy-sixth aspect of the present disclosure, an electronic device comprises a protective substrate positioned on a back side of the electronic device, wherein the protective substrate comprises the glass-ceramic article of any one of the thirty-ninth through seventy fifth aspects.

According to a seventy-seventh aspect of the present disclosure, a method of manufacturing a glass-ceramic article comprises: maintaining a precursor glass at a nucleation temperature of from 560° C. to 720° C. for a first duration of from 0 to 4.5 hours, thereby forming a nucleated precursor glass, wherein the precursor glass comprises: greater than or equal to 65 wt % and less than or equal to 80 wt % SiO₂; greater than 2 wt % and less than or equal to 12 wt % Al₂O₃; greater than or equal to 0.1 wt % and less than or equal to 3.5 wt % P₂O₅; greater than or equal to 8 wt % and less than or equal to 26 wt % Li₂O; greater than or equal to 1 wt % and less than or equal to 15 wt % ZrO₂; and less than or equal to 4 wt % CaO; and maintaining the nucleated precursor glass at a growth temperature of from 740° C. to 880° C. for a second duration of from 0.25 to 4 hours, thereby forming the glass-ceramic article having a phase assemblage comprising: greater than or equal to 10 wt % and less than or equal to 30 wt % residual amorphous glass phase; greater than or equal to 20 wt % and less than or equal to 42 wt % lithium disilicate crystalline phase; less than or equal to 42 wt % spodumene crystalline phase; and greater than or equal to 2 wt % and less than or equal to 50 wt % of a sum of a virgilite crystalline phase and the spodumene crystalline phase, wherein the glass-ceramic article has: an opacity greater than or equal to 10% and less than or equal to 65%, measured on a 0.55 mm thick glass-ceramic article; and a haze greater than or equal to 0.2% and less than or equal to 98%, measured on a 0.5 mm thick glass-ceramic article.

A seventy-eighth aspect includes the seventy-seventh aspect, wherein the precursor glass comprises: greater than 4 wt % and less than or equal to 12 wt % Al₂O₃; greater than or equal to 8 wt % and less than or equal to 17 wt % Li₂O; greater than or equal to 4 wt % and less than or equal to 15 wt % ZrO₂; and greater than or equal to 0.05 wt % and less than or equal to 4 wt % CaO.

A seventy-ninth aspect includes either one of the seventy-seventh or seventy-eighth aspects, wherein: the nucleation temperature is from 560° C. to 680° C.; and the growth temperature is from 770° C. to 820° C.

A eightieth aspect includes any one of the seventy-seventh through seventy-ninth aspects, wherein the growth temperature is from 785° C. to 805° C.

An eighty-first aspect includes any one of the seventy-seventh through eightieth aspects, wherein the second duration is from 0.5 hours to 2.5 hours.

An eighty-second aspect includes any one of the seventy-seventh through eighty-first aspects, wherein the phase assemblage comprises greater than or equal to 30 wt % and less than or equal to 50 wt % of the sum of the virgilite crystalline phase and the spodumene crystalline phase, and wherein the glass-ceramic article has an opacity greater than or equal to 18.5% and less than or equal to 65%, measured on a 0.55 mm thick glass-ceramic article.

An eighty-third aspect includes any one of the seventy-seventh or seventy-ninth through eighty-first aspects, wherein the precursor glass comprises: greater than 2 wt % and less than or equal to 8 wt % Al₂O₃; greater than or equal to 0.1 wt % and less than or equal to 2 wt % P₂O₅; greater than or equal to 16 wt % and less than or equal to 26 wt % Li₂O; greater than or equal to 1 wt % and less than or equal to 6 wt % ZrO₂; and greater than or equal to 0.5 wt % and less than or equal to 5 wt % Na₂O.

An eighty-fourth aspect includes any one of the seventy-seventh or seventy-ninth through eighty-third aspects, wherein the phase assemblage comprises greater than or equal to 30 wt % and less than or equal to 50 wt % of the sum of the virgilite crystalline phase and the spodumene crystalline phase, and wherein the glass-ceramic article has a haze greater than or equal to 40% and less than or equal to 95%, measured on a 0.5 mm thick glass-ceramic article.

An eighty-fifth aspect includes any one of the seventy-seventh or eighty-first through eighty-fourth aspects, wherein: the first duration is from 3 hours to 4 hours; and the growth temperature is from 800° C. to 875° C.

An eighty-sixth aspect includes any one of the seventy-seventh or eighty-first through eighty-fifth aspects, wherein the growth temperature is from 820° C. to 860° C.

### BRIEF DESCRIPTION OF THE DRAWINGS

FIG. 1 is a flow chart that depicts methods according to embodiments disclosed and described herein;

FIG. 2 schematically depicts a cross section of a glass-ceramic article that has been chemically strengthened by ion-exchange treatment;

FIG. 3A schematically depicts a bottom view of an electronic device including a glass-ceramic article according to embodiments disclosed and described herein;

FIG. 3B schematically depicts a perspective view of an electronic device including a glass-ceramic article according to embodiments disclosed and described herein;

FIG. 4 is an x-ray diffraction (XRD) spectrum of a glass-ceramic article formed from precursor glass composition A, according to embodiments disclosed and described herein;

FIG. 5 is an XRD spectrum of another glass-ceramic article formed from precursor glass composition A, according to embodiments disclosed and described herein;

FIG. 6 is an XRD spectrum of a glass-ceramic article formed from precursor glass composition B, according to embodiments disclosed and described herein;

FIG. 7 graphically depicts the relationship between opacity (y-axis) and β-spodumene content (x-axis) for glass-ceramic articles according to embodiments disclosed and described herein;

FIG. 8 graphically depicts the relationship between lithium disilicate content (y-axis) and growth temperature (x-axis) for glass-ceramic articles according to embodiments disclosed and described herein;

FIG. 9 graphically depicts the relationship between β-spodumene, petalite, and virgilite content (y-axis) and growth temperature (x-axis) for glass-ceramic articles according to embodiments disclosed and described herein;

FIG. 10 graphically depicts opacity (y-axis) as a function of growth temperature (x-axis) for glass-ceramic articles according to embodiments disclosed and described herein;

FIG. 11A is a scanning electron microscopy (SEM) image showing the microstructure of a glass-ceramic article according to embodiments disclosed and described herein;

FIG. 11B is an SEM image showing the microstructure of a glass-ceramic article according to embodiments disclosed and described herein;

FIG. 12 is a photograph showing the varying optical properties of glass-ceramic articles according to embodiments disclosed and described herein;

FIG. 13A graphically depicts the total transmittance (y-axis) as a function of wavelength (x-axis) for glass-ceramic articles according to embodiments disclosed and described herein;

FIG. 13B graphically depicts the diffuse transmittance (y-axis) as a function of wavelength (x-axis) for glass-ceramic articles according to embodiments disclosed and described herein;

FIG. 13C graphically depicts the axial transmittance (y-axis) as a function of wavelength (x-axis) for glass-ceramic articles according to embodiments disclosed and described herein;

FIG. 14A is a set of photographs showing the varying levels of translucency of glass-ceramic articles according to embodiments disclosed and described herein;

FIG. 14B is a set of photographs showing the varying levels of translucency of glass-ceramics according to embodiments disclosed and described herein;

FIG. 15 graphically depicts the Na₂O concentration profile for glass-ceramic articles according to Examples 19 and 47 that have been ion-exchanged at 530° C. for 2 hours in a 60% KNO₃/40% NaNO₃ bath+0.12% LiNO₃;

FIG. 16A graphically depicts the Na₂O concentration profile for a glass-ceramic article according to embodiments disclosed and described herein, for two different ion-exchange treatments;

FIG. 16B graphically depicts the K₂O concentration profile for a glass-ceramic article according to embodiments disclosed and described herein, for two different ion-exchange treatments;

FIG. 17 graphically depicts surface roughness (y-axis) as a function of cycle time (x-axis) and air pressure (y-axis) for a glass-ceramic article according to an embodiment disclosed and described herein that have been subject to a media blasting process;

FIG. 18A is depicts surface roughness of a glass-ceramic article according to an embodiment disclosed and described herein that has been subject to a media blasting process; and

FIG. 18B is depicts surface roughness of a glass-ceramic article according to an embodiment disclosed and described herein that has been subject to a media blasting process.

### DETAILED DESCRIPTION

Reference will now be made in detail to embodiments of glass-ceramic articles and methods for manufacturing glass-ceramic articles having advantageous properties; embodiments of which are illustrated in the accompanying drawings. Whenever possible, the same reference numerals will be used throughout the drawings to refer to the same or like parts.

According to some embodiments, a glass-ceramic article includes a phase assemblage comprising greater than or equal to 10 wt % and less than or equal to 30 wt % residual amorphous glass phase, greater than or equal to 20 wt % and less than or equal to 42 wt % lithium disilicate crystalline phase, less than or equal to 42 wt % spodumene crystalline phase, and less than or equal to 40 wt % petalite crystalline phase. In one or more embodiments, a glass-ceramic article includes a phase assemblage comprising greater than or equal to 10 wt % and less than or equal to 30 wt % residual amorphous glass phase, greater than or equal to 20 wt % and less than or equal to 42 wt % lithium disilicate crystalline phase, less than or equal to 42 wt % spodumene crystalline phase, and greater than or equal to 2 wt % and less than or equal to 50 wt % of a sum of a virgilite crystalline phase and the spodumene crystalline phase. The glass-ceramic articles of the present disclosure have: an opacity greater than or equal to 10% and less than or equal to 65%, measured on a 0.55 mm thick glass-ceramic article; and a haze greater than or equal to 0.2% and less than or equal to 98%, measured on a 0.5 mm thick glass-ceramic article. Various embodiments of glass-ceramic articles will be described herein with specific reference to the appended figures.

As used herein, the term “glass-ceramic” refers to solids prepared by controlled crystallization of a precursor glass and have one or more crystalline phases and a residual amorphous glass phase.

As used herein, “depth of compression” or “DOC” refers to the depth of a compressive stress (CS) layer and is the depth at which the stress within a glass-ceramic article changes from compressive stress to tensile stress and has a stress value of zero. According to the convention normally used in the art, compressive stress is expressed as a negative (<0) stress and tensile stress is expressed as a positive (>0) stress. Throughout this description, however, and unless otherwise noted, CS is expressed as a positive or absolute value—that is, as recited herein, CS=|CS|.

The CS, DOC, and maximum central tension (CT) values are measured using a hybrid method that combines measurements made using evanescent prism coupling spectroscopy (EPCS) and light scattering polarimetry (LSP) as disclosed in U.S. Patent Application Publication No. 2020/0300615, which is incorporated herein by reference in its entirety.

Fracture toughness (K_{1C}) represents the ability of a precursor glass or glass-ceramic to resist fracture. Fracture toughness is measured on a non-chemically strengthened precursor glass article or glass-ceramic article, such as measuring the K_{1C} value prior to ion exchange (IOX) treatment of the precursor glass article or glass-ceramic article, thereby representing a feature of the article prior to IOX. The fracture toughness test methods described herein are not suitable for glasses that have been exposed to IOX treatment. However, fracture toughness measurements performed as described herein on the same article prior to IOX treatment (e.g., precursor glass or glass-ceramic substrates) correlate to fracture toughness after IOX treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). The double torsion method and fixture utilized to measure the K_{1C} value is described in Shyam, A. and Lara-Curzio, E., “The double-torsion testing technique for determination of fracture toughness and slow crack growth of materials: A review,” J. Mater. Sci., 41, pp. 4093-4104, (2006). The double torsion measurement method generally produces K_{1C} values that are slightly higher than the chevron notched short bar method. Unless otherwise specified, all fracture toughness values were measured by chevron notched short bar (CNSB) method.

Young's modulus, shear modulus, and Poisson's ratio are measured by a resonant ultrasonic spectroscopy technique of the general type set forth in ASTM E2001-13 (2018).

The haze of the glass-ceramic articles described herein is measured using a haze meter, such as the BYK Gardner Haze-Gard I, following ASTM D1003-21 (2021) or ASTM D1044-19 (2019) on a glass-ceramic article having a thickness of 0.5 mm, unless otherwise stated.

The color and opacity of the glass-ceramic articles described herein is measured using a CM3700 Colorimeter. Reflectance color may be measured with a F02-01 or D-65-2 illuminant, SCI, 25 mm aperture, using a white or black background behind the sample during the measurement. References to particular color properties of the glass-ceramic articles of the present disclosure will indicate which illuminant the color properties are achieved for. Transmittance color is measured with a D-65-2 illuminant, SCI, 25 mm aperture.

Optical transmission (also referred to herein as “transmittance”) is measured in the 250-1000 nm range on optically polished samples with plane parallel faces using a Perkin Elmer Lambda 950 spectrophotometer, with data interval of 2 nm. The transmission is measured on the glass-ceramic article itself without any coatings or other applications.

X-ray diffraction (XRD) is conducted on powdered samples using a Bruker D4 Endeavor equipped with Cu radiation and a LynxEye detector. The phase assemblage is determined using Rietveld method and using Bruker's Topas software package.

Density is measured according to as measured in accordance with ASTM C693-93 (2019).

The term “softening point,” as used herein, refers to the temperature at which the viscosity of the glass composition is 1×10^{7.6} poise. The softening point is determined using the parallel plate viscosity method of ASTM C1351M-96 (2012).

The term “annealing point” as used herein, refers to the temperature at which the viscosity of the precursor glass or glass-ceramic is 1×10¹³ poise. The annealing point is determined using the beam bending viscosity method of ASTM C598-93 (2013).

The term “strain point” and “Tₛₜᵣₐᵢₙ” as used herein, refer to the temperature at which the viscosity of the precursor glass or glass-ceramic is 3×10¹⁴ poise. The strain point is determined using the beam bending viscosity method of ASTM C598-93 (2013).

Scratch resistance was measured using an Anton Paar MicroCombi using a diamond tip with a 90 degree angle, 10 μm radius was used for testing; scratching at 5 mm/min, with a 0.14 N/sec load and unload rate. 10 mm scratches were performed.

Hardness is measured using a MITUTOYO HM 114 Hardness testing machine with a Vickers indenter with a 200 gram indentation load (Dwell time is 15 seconds). Measurement of indentation diagonals is performed using calibrated optical microscopy. Values are average of measurements from 5 indentations per sample. Tests are performed on optically polished samples with plane parallel faces.

The stored strain energy of the glass-ceramic article is calculated as described in Gulati, Suresh T., “Frangibility of Tempered Soda-Lime Glass Sheet,” Glass Processing Days, Sep. 13-15, 1997, pp. 72-76 (ISBN 952-90-8959-7), specifically equation (4) of the publication.

The terms “free” and “substantially free,” when used to describe the concentration and/or absence of a particular constituent component in a precursor glass composition or glass-ceramic article, means that the constituent component is not intentionally added to the precursor glass composition or glass-ceramic article. However, the precursor glass composition or glass-ceramic article may contain traces of the constituent component as a contaminant or tramp in amounts of less than 0.01 wt %.

Ranges can be expressed herein as from “less than or equal to” one particular value, and/or to “less than or equal to” another particular value. When such a range is expressed, another embodiment includes from the one particular value and/or to the other particular value. Similarly, when values are expressed as approximations, by use of the antecedent “less than or equal to,” it will be understood that the particular value forms another embodiment. It will be further understood that the endpoints of each of the ranges are significant both in relation to the other endpoint, and independently of the other endpoint. Any ranges used herein include all ranges and subranges and any values there between unless explicitly stated otherwise.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Glass-ceramics have attributes making them amenable for use as cover substrates and/or housings for mobile electronic devices. For example, without being bound by theory, glass-ceramics with high fracture toughness and/or Young's modulus can provide resistance to crack penetration and exhibit good drop performance. When such glass-ceramics are chemically strengthened, for example through ion exchange, the resistance to crack penetration and drop performance can be further enhanced. The high fracture toughness and/or Young's modulus may also increase the amount of stored tensile energy and maximum central tension that can be imparted to the glass-ceramics through chemical tempering (e.g., through ion exchange strengthening). In addition, as described in detail herein, the optical characteristics of the glass-ceramics, such as opacity and haze, can be tailored by adjusting the heating/ceramming schedule used to transform the precursor glass into a glass-ceramic.

As thinner glass and glass-ceramics are required to meet the needs of evolving electronic devices (such as electronic devices that are becoming smaller and thinner), it is desired to increase the strength of the thin precursor glasses and glass-ceramics formed therefrom by increasing the levels of stress (both compressive and tensile) installed in the glass-ceramics, such as through chemical tempering.

The composition of the precursor glasses and glass-ceramic articles disclosed herein allow for glass-ceramics which have a sufficiently high central tension (e.g., such as greater than or equal to 40 MPa to less than 170 MPa in a substrate having a thickness of less than 0.6 mm) following chemical tempering without exhibiting a highly fragmented breakage pattern. Without wishing to be bound by theory, it is believed that the relatively high central tension in the glass-ceramics described herein allows for higher compressive stresses at deeper depths from the surface of the glass-ceramic, thereby improving the mechanical performance of the glass-ceramic including, without limitation, drop height and fracture strength.

In some embodiments, an increased amount of Li₂O in precursor glass compositions described herein allows for increased stress levels in the glass-ceramic articles prepared from said precursor glass compositions. Lithium is the smallest of the alkali metal ions and when lithium is replaced in the glass network with sodium or potassium ions during ion exchange strengthening, relatively high compressive stress and central tension values may be achieved. However, including too much lithium in the precursor glass can make the glass difficult to form, which can make it difficult to achieve the thin glass-ceramic articles desirable for handheld electronic devices, such as mobile phones and tablets. Accordingly, one cannot simply increase the amount of lithium in a precursor glass to improve the compressive stress and central tension in a resulting glass-ceramic. Doing so will result in precursor glasses that cannot be easily and economically formed into thin sheets.

The present disclosure is specifically directed to the development of glass-ceramic articles that exhibit the mechanical properties needed for glass-ceramic applications such as portable electronic devices, while incorporating the ability to produce visually appealing effects. In various embodiments, the composition of the precursor glass is selected such that the resultant glass-ceramic has a particular phase assemblage associated with desired mechanical and optical properties, such as desired opacity and/or haze levels. Primary phases of the glass-ceramic articles described herein include lithium disilicate, β-spodumene, virgilite, and petalite, depending on precursor glass composition and ceramming schedule. Secondary phases of the glass-ceramic articles described herein may include lithium phosphate, ZrO₂ (tetragonal and baddeleyite), zircon, and K₂Zr₂O₅, again, depending on the depending on precursor glass composition and ceramming schedule used to prepare the glass-ceramic article.

In some embodiments, the composition of the precursor glass and the ceramming schedule is selected to promote the growth of a spodumene crystalline phase (e.g., β-spodumene) that may improve extent to which ion exchange processes can be used to strengthen the resulting glass-ceramic article. For example, lithium ions in β-spodumene can easily be replaced by Na ions using an ion-exchange process to increase the internal stress (compressive and tensile) of the glass-ceramic article. Additionally, in some embodiments, the composition of the precursor glass and the ceramming schedule is selected to promote the growth of lithium disilicate which can be ion exchanged through a surface amorphization mechanism. During ion exchange, the glass-ceramic is held in a salt bath for a sufficient time for exchange to occur on the surface and into some depth of the glass-ceramic article. As a result of the ion exchange process, a surface compressive layer is created by the substitution of Li and/or Na contained in a surface layer by Na or K having a larger ionic radius during chemical strengthening. In some embodiments, the glass-ceramic articles are chemically strengthened by placing them in a molten salt bath comprising NaNO₃, KNO₃, and/or AgNO₃ for a predetermined time period to achieve the desired level of ion exchange.

With regard to the optical properties of the glass-ceramic articles described herein, the composition of the precursor glass and the ceramming schedule may be selected to promote the growth of β-spodumene and virgilite crystalline phases which provide the glass-ceramic article with desired opacity and haze levels. In some embodiments, the composition of the precursor glass and the ceramming schedule may be selected to promote the growth ZrO₂ phases to further influence the optical properties of the glass-ceramic articles described herein. Further, the combined amount of β-spodumene and virgilite crystalline phases is controlled in some embodiments to achieve opacity and haze levels within desired ranges for aesthetic purposes. Without wishing to be bound by theory, it is believe that precursor glass compositions and ceramming schedules described herein allow for the nucleation and growth of a petalite crystalline phase which is converted to virgilite and β-spodumene during the growth step, and that by carefully controlling the growth temperature, varying amounts of virgilite and β-spodumene can be grown in the glass-ceramic articles so as to obtain a high degree of control over the resulting optical properties.

The glass-ceramic articles described herein may be generally described as lithium-containing aluminosilicate glass-ceramic articles and may comprise SiO₂, Al₂O₃, P₂O₅, ZrO₂, CaO, and Li₂O. In addition to SiO₂, Al₂O₃, and Li₂O, the precursor glass compositions and glass-ceramic articles embodied herein may further contain alkali oxides, such as Na₂O, K₂O, Rb₂O, or Cs₂O, as well as one or more other components as described herein. As noted herein, the major crystallite phases of the phase assemblage of the glass-ceramics described herein include residual amorphous glass, lithium disilicate (Li₂Si₂O₅), and various combinations of petalite (LiAlSi₄O₁₀), β-spodumene (LiAlSi₂O₆), and virgilite (LiₓAlₓSi₃₋ₓO₆) crystalline phases. In embodiments, the glass-ceramics may comprise less than 12 wt %, such as less than 11 wt %, less than 10 wt %, less than 9 wt %, less than 8 wt %, less than 7 wt %, less than 6 wt %, less than 5 wt %, less than 4 wt %, less than 3 wt %, less than 2 wt %, or even less than 1 wt %, of the sum of other crystalline phases (such as, but not limited to lithium metasilicate (Li₂SiO₃), cristabolite (SiO₂), Quartz (SiO₂), zirconia (ZrO₂), baddeleyite (ZrO₂), spodumene (LiAlSi₂O₆), and lithium phosphate (Li₃PO₄)). This phase assemblage provides a glass-ceramic that has aesthetically desirable opacity and haze feature while maintaining high mechanical properties.

SiO₂, an oxide involved in the formation of glass, can function to stabilize the network structure of precursor glasses and glass-ceramics. The concentration of SiO₂ should be sufficiently high to form the petalite crystalline phase during the nucleation step of the ceramming schedule used to convert the precursor glass to a glass-ceramic. The amount of SiO₂ may be limited to control the melting temperature of the glass, as the melting temperature of pure SiO₂ or high-SiO₂ glasses is undesirably high. In embodiments, the precursor glasses and glass-ceramics comprise greater than or equal to 55 wt % and less than or equal to 80 wt % SiO₂, greater than or equal to 55 wt % and less than or equal to 75 wt % SiO₂, greater than or equal to 55 wt % and less than or equal to 73 wt % SiO₂, greater than or equal to 60 wt % and less than or equal to 80 wt % SiO₂, greater than or equal to 60 wt % and less than or equal to 75 wt % SiO₂, greater than or equal to 60 wt % and less than or equal to 73 wt % SiO₂, greater than or equal to 65 wt % and less than or equal to 80 wt % SiO₂, greater than or equal to 65 wt % and less than or equal to 75 wt % SiO₂, greater than or equal to 65 wt % and less than or equal to 73 wt % SiO₂, greater than or equal to 68 wt % and less than or equal to 80 wt % SiO₂, greater than or equal to 68 wt % and less than or equal to 75 wt % SiO₂, greater than or equal to 68 wt % and less than or equal to 73 wt % SiO₂, or even greater than or equal to 70 wt % and less than or equal to 73 wt % SiO₂. It should be understood that the above ranges include all subranges within the explicitly disclosed ranges.

Al₂O₃ may also provide stabilization to the network and provides improved mechanical properties and chemical durability. If the amount of Al₂O₃ is too high, however, the fraction of lithium disilicate crystals may be decreased, possibly to the extent that an interlocking structure cannot be formed. The amount of Al₂O₃ can be tailored to control the viscosity of the precursor glass during melting and forming. Further, if the amount of Al₂O₃ is too high, the viscosity of the melt is also generally increased. In embodiments, the precursor glasses and glass-ceramics comprise greater than or equal to 2 wt % and less than or equal to 15 wt % Al₂O₃, greater than or equal to 3 wt % and less than or equal to 15 wt % Al₂O₃, greater than or equal to 4 wt % and less than or equal to 15 wt % Al₂O₃, greater than or equal to 5 wt % and less than or equal to 15 wt % Al₂O₃, greater than or equal to 2 wt % and less than or equal to 12 wt % Al₂O₃, greater than or equal to 3 wt % and less than or equal to 12 wt % Al₂O₃, greater than or equal to 4 wt % and less than or equal to 12 wt % Al₂O₃, greater than or equal to 5 wt % and less than or equal to 12 wt % Al₂O₃, greater than or equal to 2 wt % and less than or equal to 10 wt % Al₂O₃, greater than or equal to 3 wt % and less than or equal to 10 wt % Al₂O₃, greater than or equal to 4 wt % and less than or equal to 10 wt % Al₂O₃, greater than or equal to 5 wt % and less than or equal to 10 wt % Al₂O₃, greater than or equal to 2 wt % and less than or equal to 8 wt % Al₂O₃, greater than or equal to 3 wt % and less than or equal to 8 wt % Al₂O₃, greater than or equal to 4 wt % and less than or equal to 8 wt % Al₂O₃, greater than or equal to 4 wt % and less than or equal to 7 wt % Al₂O₃, greater than or equal to 2 wt % and less than or equal to 6 wt % Al₂O₃, greater than or equal to 3 wt % and less than or equal to 6 wt % Al₂O₃, or even greater than or equal to 4 wt % and less than or equal to 6 wt % Al₂O₃. It should be understood that the above ranges include all subranges within the explicitly disclosed ranges.

In the precursor glasses and glass-ceramic articles described herein, Li₂O aids in forming both petalite and lithium disilicate crystal phases. While petalite is ultimately removed in several embodiments during the growth step of the ceramming schedule, its initial formation is believed to be important for achieving the resulting controllability of the microstructure and associated translucence via control of the ceramming parameters such as, for example, the growth temperature. Accordingly, in embodiments, the precursor glasses and glass-ceramics can comprise greater than or equal to 7 wt % and less than or equal to 30 wt % Li₂O, greater than or equal to 8 wt % and less than or equal to 30 wt % Li₂O, greater than or equal to 8 wt % and less than or equal to 26 wt % Li₂O, greater than or equal to 9 wt % and less than or equal to 26 wt % Li₂O, greater than or equal to 9 wt % and less than or equal to 25 wt % Li₂O, greater than or equal to 10 wt % and less than or equal to 25 wt % Li₂O, greater than or equal to 10 wt % and less than or equal to 24 wt % Li₂O, greater than or equal to 10 wt % and less than or equal to 23 wt % Li₂O, greater than or equal to 11 wt % and less than or equal to 23 wt % Li₂O, greater than or equal to 11 wt % and less than or equal to 22 wt % Li₂O, greater than or equal to 8 wt % and less than or equal to 17 wt % Li₂O, greater than or equal to 8 wt % and less than or equal to 16 wt % Li₂O, greater than or equal to 8 wt % and less than or equal to 15 wt % Li₂O, greater than or equal to 8 wt % and less than or equal to 14 wt % Li₂O, greater than or equal to 9 wt % and less than or equal to 14 wt % Li₂O, greater than or equal to 9 wt % and less than or equal to 13 wt % Li₂O, greater than or equal to 10 wt % and less than or equal to 13 wt % Li₂O, greater than or equal to 10 wt % and less than or equal to 12 wt % Li₂O, greater than or equal to 16 wt % and less than or equal to 26 wt % Li₂O, greater than or equal to 18 wt % and less than or equal to 26 wt % Li₂O, greater than or equal to 20 wt % and less than or equal to 26 wt % Li₂O, greater than or equal to 20 wt % and less than or equal to 24 wt % Li₂O, or even greater than or equal to 20 wt % and less than or equal to 22 wt % Li₂O. It should be understood that the above ranges include all subranges within the explicitly disclosed ranges.

As noted herein, the alkali metal oxide Li₂O is generally useful for forming various glass-ceramics. However, other alkali metal oxides tend to decrease glass-ceramic formation and, instead, form an aluminosilicate residual amorphous glass in the glass-ceramics. It has been found that more than about 5 wt % Na₂O or K₂O, or combinations thereof, leads to excessive amorphous residual glass, which can lead to deformation during crystallization and undesirable microstructures from a mechanical property perspective. The composition of the amorphous residual glass may be tailored to control viscosity during crystallization, minimizing deformation or undesirable thermal expansion, or control microstructure properties. Therefore, in general, the precursor glass may comprise relatively low amounts of non-lithium alkali metal oxides. For example, in embodiments, the precursor glass or glass-ceramic can comprise greater than or equal to 0 wt % to less than or equal to 5.5 wt % R₂O, wherein R is one or more of the alkali cations Na and K. In embodiments, the precursor glass or glass-ceramic composition can comprise from greater than or equal to 1 wt % to less than or equal to 3 wt % R₂O, wherein R is one or more of the alkali cations Na and K. In embodiments, the precursor glass or glass-ceramic composition can comprise from greater than or equal to 0.1 wt % to less than or equal to 0.5 wt % R₂O, from greater than or equal to 0.1 wt % to less than or equal to 0.3 wt % R₂O, or even from greater than or equal to 0.1 wt % to less than or equal to 0.25 wt % R₂O, wherein R is one or more of the alkali cations Na and K. It should be understood that, in embodiments, the precursor glass and glass-ceramic does not comprise R₂O. In embodiments, the precursor glass and glass-ceramic are substantially free of R₂O.

In embodiments, the precursor glasses and glass-ceramics comprise greater than or equal to 0 wt % and less than or equal to 5.0 wt % Na₂O, greater than or equal to 0.5 wt % and less than or equal to 5.0 wt % Na₂O, greater than or equal to 0.5 wt % and less than or equal to 2.5 wt % Na₂O, greater than or equal to 1.0 wt % and less than or equal to 2.5 wt % Na₂O, greater than or equal to 1.5 wt % and less than or equal to 2.5 wt % Na₂O, greater than or equal to 0 wt % and less than or equal to 2.5 wt % Na₂O, greater than or equal to 0 wt % and less than or equal to 2 wt % Na₂O, greater than or equal to 0 wt % and less than or equal to 1.5 wt % Na₂O, greater than or equal to 0 wt % and less than or equal to 1 wt % Na₂O, greater than or equal to 0 wt % and less than or equal to 0.5 wt % Na₂O, or greater than or equal to 0 wt % and less than or equal to 0.25 wt %. In embodiments, the precursor glasses and glass-ceramics are substantially free of Na₂O. It should be understood that the above ranges include all subranges within the explicitly disclosed ranges.

In embodiments, the precursor glasses and glass-ceramics comprise greater than or equal to 0 wt % and less than or equal to 3 wt % K₂O, greater than or equal to 0 wt % and less than or equal to 2 wt % K₂O, greater than or equal to 0 wt % and less than or equal to 1 wt % K₂O, greater than or equal to 0 wt % and less than or equal to 1 wt % K₂O, greater than or equal to 0 wt % and less than or equal to 0.5 wt % K₂O, greater than or equal to 0 wt % and less than or equal to 0.4 wt % K₂O, greater than or equal to 0 wt % and less than or equal to 0.3 wt % K₂O, greater than or equal to 0 wt % and less than or equal to 0.2 wt % K₂O, greater than or equal to 0.05 wt % and less than or equal to 1 wt % K₂O, greater than or equal to 0.05 wt % and less than or equal to 0.5 wt % K₂O, greater than or equal to 0.05 wt % and less than or equal to 0.4 wt % K₂O, greater than or equal to 0.05 wt % and less than or equal to 0.3 wt % K₂O, greater than or equal to 0.05 wt % and less than or equal to 0.2 wt % K₂O, even greater than or equal to 0.1 wt % and less than or equal to 1 wt % K₂O, greater than or equal to 0.1 wt % and less than or equal to 1 wt % K₂O, greater than or equal to 0.1 wt % and less than or equal to 0.5 wt % K₂O, greater than or equal to 0.1 wt % and less than or equal to 0.4 wt % K₂O, greater than or equal to 0.1 wt % and less than or equal to 0.3 wt % K₂O, or greater than or equal to 0.1 wt % and less than or equal to 0.2 wt % K₂O. It should be understood that the above ranges include all subranges within the explicitly disclosed ranges.

The precursor glasses and glass-ceramic articles described herein include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body. However, if the concentration of P₂O₅ is too high, the devitrification, upon cooling during the formation of glass sheets, can be difficult to control. Embodiments of the precursor glasses and glass-ceramics comprise greater than or equal to 0.1 wt % and less than or equal to 5.0 wt % P₂O₅, greater than or equal to 0.5 wt % and less than or equal to 5.0 wt % P₂O₅, greater than or equal to 1.0 wt % and less than or equal to 5.0 wt % P₂O₅, greater than or equal to 1.5 wt % and less than or equal to 5.0 wt % P₂O₅, greater than or equal to 2.0 wt % and less than or equal to 5.0 wt % P₂O₅, greater than or equal to 2.25 wt % and less than or equal to 5.0 wt % P₂O₅, greater than or equal to 2.5 wt % and less than or equal to 5.0 wt % P₂O₅, greater than or equal to 3.0 wt % and less than or equal to 5.0 wt % P₂O₅, greater than or equal to 0.1 wt % and less than or equal to 4.5 wt % P₂O₅, greater than or equal to 0.5 wt % and less than or equal to 4.5 wt % P₂O₅, greater than or equal to 1.0 wt % and less than or equal to 4.5 wt % P₂O₅, greater than or equal to 1.5 wt % and less than or equal to 4.5 wt % P₂O₅, greater than or equal to 2.0 wt % and less than or equal to 4.5 wt % P₂O₅, greater than or equal to 2.25 wt % and less than or equal to 4.5 wt % P₂O₅, greater than or equal to 2.5 wt % and less than or equal to 4.5 wt % P₂O₅, greater than or equal to 3.0 wt % and less than or equal to 4.5 wt % P₂O₅, greater than or equal to 0.1 wt % and less than or equal to 4.0 wt % P₂O₅, greater than or equal to 0.5 wt % and less than or equal to 4.0 wt % P₂O₅, greater than or equal to 1.0 wt % and less than or equal to 4.0 wt % P₂O₅, greater than or equal to 1.5 wt % and less than or equal to 4.0 wt % P₂O₅, greater than or equal to 2.0 wt % and less than or equal to 4.0 wt % P₂O₅, greater than or equal to 2.25 wt % and less than or equal to 4.0 wt % P₂O₅, greater than or equal to 2.5 wt % and less than or equal to 4.0 wt % P₂O₅, greater than or equal to 3.0 wt % and less than or equal to 4.0 wt % P₂O₅, greater than or equal to 0.1 wt % and less than or equal to 3.5 wt % P₂O₅, greater than or equal to 0.5 wt % and less than or equal to 3.5 wt % P₂O₅, greater than or equal to 1.0 wt % and less than or equal to 3.5 wt % P₂O₅, greater than or equal to 1.5 wt % and less than or equal to 3.5 wt % P₂O₅, greater than or equal to 2.0 wt % and less than or equal to 3.5 wt % P₂O₅, greater than or equal to 2.25 wt % and less than or equal to 3.5 wt % P₂O₅, greater than or equal to 2.5 wt % and less than or equal to 3.5 wt % P₂O₅, greater than or equal to 3.0 wt % and less than or equal to 3.5 wt % P₂O₅, greater than or equal to 0.1 wt % and less than or equal to 3.0 wt % P₂O₅, greater than or equal to 0.5 wt % and less than or equal to 3.0 wt % P₂O₅, greater than or equal to 1.0 wt % and less than or equal to 3.0 wt % P₂O₅, greater than or equal to 1.5 wt % and less than or equal to 3.0 wt % P₂O₅, greater than or equal to 2.0 wt % and less than or equal to 3.0 wt % P₂O₅, greater than or equal to 2.25 wt % and less than or equal to 3.0 wt % P₂O₅, greater than or equal to 2.5 wt % and less than or equal to 3.0 wt % P₂O₅, greater than or equal to 0.1 wt % and less than or equal to 2.5 wt % P₂O₅, greater than or equal to 0.5 wt % and less than or equal to 2.5 wt % P₂O₅, greater than or equal to 1.0 wt % and less than or equal to 2.5 wt % P₂O₅, greater than or equal to 1.5 wt % and less than or equal to 2.5 wt % P₂O₅, greater than or equal to 2.0 wt % and less than or equal to 2.5 wt % P₂O₅, greater than or equal to 0.1 wt % and less than or equal to 2.0 wt % P₂O₅, greater than or equal to 0.5 wt % and less than or equal to 2.0 wt % P₂O₅, greater than or equal to 1.0 wt % and less than or equal to 2.0 wt % P₂O₅, greater than or equal to 1.5 wt % and less than or equal to 2.0 wt % P₂O₅, greater than or equal to 0.1 wt % and less than or equal to 1.5 wt % P₂O₅, greater than or equal to 0.5 wt % and less than or equal to 1.5 wt % P₂O₅, greater than or equal to 1.0 wt % and less than or equal to 1.5 wt % P₂O₅, greater than or equal to 0.1 wt % and less than or equal to 1.0 wt % P₂O₅, or greater than or equal to 0.5 wt % and less than or equal to 1.0 wt % P₂O₅. It should be understood that the above ranges include all subranges within the explicitly disclosed ranges.

In addition to the other effects of ZrO₂ described herein, it is generally found that ZrO₂ can improve the stability of Li₂O—Al₂O₃—SiO₂—P₂O₅ glass by significantly reducing glass devitrification during forming and lowering the liquidus temperature. In embodiments, the precursor glasses and glass-ceramics comprise greater than or equal to 1.0 wt % and less than or equal to 15 wt % ZrO₂, greater than or equal to 1.0 wt % and less than or equal to 12 wt % ZrO₂, greater than or equal to 1.0 wt % and less than or equal to 10 wt % ZrO₂, greater than or equal to 1.0 wt % and less than or equal to 9.0 wt % ZrO₂, greater than or equal to 1.0 wt % and less than or equal to 8.0 wt % ZrO₂, greater than or equal to 1.0 wt % and less than or equal to 7.0 wt % ZrO₂, greater than or equal to 1.0 wt % and less than or equal to 6.0 wt % ZrO₂, greater than or equal to 3.0 wt % and less than or equal to 15 wt % ZrO₂, greater than or equal to 4.0 wt % and less than or equal to 15 wt % ZrO₂, greater than or equal to 4.0 wt % and less than or equal to 12 wt % ZrO₂, greater than or equal to 4.0 wt % and less than or equal to 9.0 wt % ZrO₂, greater than or equal to 4.0 wt % and less than or equal to 8.0 wt % ZrO₂, greater than or equal to 5.0 wt % and less than or equal to 8.0 wt % ZrO₂, or greater than or equal to 5.0 wt % and less than or equal to 7.0 wt % ZrO₂. It should be understood that the above ranges include all subranges within the explicitly disclosed ranges.

In some embodiments, the precursor glass compositions and glass-ceramic articles may include CaO. Without being bound by any particular theory, it is believed that the additional calcium oxide increases the density of the glass-ceramics and, therefore, slows the diffusion of ions into the glass-ceramics during chemical strengthening. This slowing of diffusion slows the ion exchange process, but results in glass-ceramics with more compressive stress and central tension than less dense precursor glasses and glass-ceramics. Moreover, in embodiments, the combination of increased amounts of Li₂O, ZrO₂, and CaO, when correctly balanced, in the precursor glass composition yields a better ion exchange profile (e.g., compressive stress and central tension) than conventional precursor glass compositions that do not balance an increase of these components. In embodiments, the precursor glasses and glass-ceramics comprise less than or equal to 4.0 wt % CaO, less than or equal to 2.0 wt % CaO, less than or equal to 1.0 wt % CaO, less than or equal to 0.5 wt % CaO, less than or equal to 0.3 wt % CaO, less than or equal to 0.1 wt % CaO, less than or equal to 0.05 wt % CaO, greater than or equal to 0.0 and less than or equal to 4.0 wt % CaO, greater than or equal to 0.05 and less than or equal to 4.0 wt % CaO, greater than or equal to 0.05 and less than or equal to 3.0 wt % CaO, greater than or equal to 0.05 and less than or equal to 2.0 wt % CaO, or greater than or equal to 0.05 and less than or equal to 1.0 wt % CaO, greater than or equal to 0.5 and less than or equal to 4.0 wt % CaO, greater than or equal to 0.5 and less than or equal to 3.0 wt % CaO, greater than or equal to 0.5 and less than or equal to 2.0 wt % CaO, or greater than or equal to 0.5 and less than or equal to 1.0 wt % CaO. In embodiments, the precursor glasses and glass-ceramics are substantially free of CaO. It should be understood that the above ranges include all subranges within the explicitly disclosed ranges.

In embodiments, the precursor glasses or glass-ceramics may further include HfO₂. Without wishing to be bound by theory, it is believed that additions of HfO₂ may at least partially replace ZrO₂ in the compositions. In embodiments, the precursor glasses and glass-ceramics comprise greater than or equal to 0 wt % and less than or equal to 3.0 wt % HfO₂, greater than or equal to 0 wt % and less than or equal to 2.5 wt % HfO₂, greater than or equal to 0 wt % and less than or equal to 2.0 wt % HfO₂, greater than or equal to 0 wt % and less than or equal to 1.5 wt % HfO₂, greater than or equal to 0 wt % and less than or equal to 1.0 wt % HfO₂, greater than or equal to 0 wt % and less than or equal to 0.5 wt % HfO₂, greater than or equal to 0.01 to less than or equal to 3.0 wt % HfO₂, greater than or equal to 0.01 to less than or equal to 2 wt % HfO₂, greater than or equal to 0.01 to less than or equal to 1.0 wt % HfO₂, greater than or equal to 0.01 to less than or equal to 0.5 wt % HfO₂, greater than or equal to 0.01 to less than or equal to 0.2 wt % HfO₂, greater than or equal to 0.1 to less than or equal to 3 wt % HfO₂, greater than or equal to 0.1 wt % and less than or equal to 2.5 wt % HfO₂, greater than or equal to 0.1 wt % and less than or equal to 2.0 wt % HfO₂, greater than or equal to 0.1 wt % and less than or equal to 1.5 wt % HfO₂, greater than or equal to 0.1 wt % and less than or equal to 1.0 wt % HfO₂, or even greater than or equal to 0.1 wt % and less than or equal to 0.5 wt % HfO₂. In embodiments, the precursor glasses and glass-ceramics are substantially free of HfO₂. It should be understood that the above ranges include all subranges within the explicitly disclosed ranges.

Fe₂O₃ can lower the melting point of the precursor glasses and glass-ceramics. However, adding too much Fe₂O₃ can alter the color of the precursor glass and glass-ceramics. In embodiments, the precursor glasses and glass-ceramics are substantially free of Fe₂O₃. In embodiments, the precursor glasses and glass-ceramics comprise greater than 0.0 wt % and less than or equal to 1.0 wt % Fe₂O₃, greater than or equal to 0 wt % and less than or equal to 0.5 wt % Fe₂O₃, greater than 0.0 wt % and less than or equal to 0.3 wt % Fe₂O₃, greater than or equal to 0.0 wt % and less than or equal to 0.2 wt % Fe₂O₃, or greater than 0.0 wt % and less than or equal to 0.1 wt % Fe₂O₃. It should be understood that the above ranges include all subranges within the explicitly disclosed ranges.

In embodiments, the precursor glass or glass-ceramic may further include a chemical fining agent. Such fining agents include, but are not limited to, SnO₂, As₂O₃, Sb₂O₃, SO₃F, Cl and Br. In some embodiments, the concentrations of the chemical fining agents are kept at a level of 3, 2, 1, or 0.5, >0 wt %. In embodiments, the chemical fining agent is SnO₂ and the precursor glass or glass-ceramic comprises greater than or equal to 0 to less than or equal to 3 wt % SnO₂. In embodiments, the precursor glass or glass-ceramic comprises greater than or equal to 0 wt % and less than or equal to 2.5 wt % SnO₂, greater than or equal to 0 wt % and less than or equal to 2.0 wt % SnO₂, greater than or equal to 0 wt % and less than or equal to 1.5 wt % SnO₂, greater than or equal to 0 wt % and less than or equal to 1.0 wt % SnO₂, greater than or equal to 0 wt % and less than or equal to 0.5 wt % SnO₂, greater than 0.01 wt % to less than or equal to 3 wt % SnO₂, greater than 0.01 wt % and less than or equal to 2.5 wt % SnO₂, greater than 0.01 wt % and less than or equal to 2.0 wt % SnO₂, greater than 0.01 wt % and less than or equal to 1.5 wt % SnO₂, greater than 0.01 wt % and less than or equal to 1.0 wt % SnO₂, or even greater than 0.01 wt % and less than or equal to 0.5 wt % SnO₂. It should be understood that the above ranges include all subranges within the explicitly disclosed ranges.

In some embodiments, the precursor glass or glass-ceramic can be substantially free of Sb₂O₃, As₂O₃, or combinations thereof. For example, the precursor glass or glass-ceramic can comprise 0.05 weight percent or less of Sb₂O₃ or As₂O₃ or a combination thereof, the precursor glass or glass-ceramic may comprise 0 wt % of Sb₂O₃ or As₂O₃ or a combination thereof, or the precursor glass or glass-ceramic may be, for example, free of any intentionally added Sb₂O₃, As₂O₃, or combinations thereof.

In embodiments, glass having the composition described herein may be initially formed by mixing a batch of constituent component sources (e.g., SiO₂ sources, Al₂O₃ sources, and the like), heating the batch to form molten glass, and, thereafter, forming or shaping the molten glass into a glass article using conventional forming processes, such as slot draw, float, rolling, fusion forming, or the like. At this point, the glass or glass article may be referred to as a “precursor glass” which refers to the glass or glass article prior to ceramming to convert the glass to a glass-ceramic, thereby forming a glass-ceramic article. In embodiments, the precursor glass may be formed as a plate having a thickness prior to ceramming, i.e., an “as-formed thickness,” of greater than or equal to 0.6 mm and less than or equal to 6 mm. In embodiments, the as-formed thickness may be greater than or equal to 0.6 mm and less than or equal to 5.00 mm, greater than or equal to 0.6 mm and less than or equal to 4.00 mm, greater than or equal to 0.6 mm and less than or equal to 3.00 mm, greater than or equal to 0.6 mm and less than or equal to 2.00 mm, greater than or equal to 0.6 mm and less than or equal to 1.00 mm, greater than or equal to 0.6 mm and less than or equal to 1.00 mm, greater than or equal to 0.65 mm and less than or equal to 1.00 mm, greater than or equal to 0.7 mm and less than or equal to 1.00 mm, greater than or equal to 0.8 mm and less than or equal to 1.00 mm, or greater than or equal to 0.8 mm and less than or equal to 0.9 mm. It should be understood that the above ranges include all subranges within the explicitly disclosed ranges.

The processes for making glass-ceramics according to embodiments may include heat treating the precursor glass at two preselected temperatures for one or more preselected times to induce glass homogenization and crystallization (i.e., nucleation and growth) of one or more crystalline phases (e.g., having one or more compositions, amounts, morphologies, sizes or size distributions, etc.). These two temperatures may be referred to as the nucleation temperature and the growth temperature, respectively. However, in some embodiments, the process for making the glass-ceramic article may include heat treating the precursor glass at a single preselected temperature, for example, the growth temperature.

With reference now to FIG. 1, embodiments of methods 1000 for making glass-ceramics will generally be described. Initially, at step 1001, a precursor glass is heated in an oven to a nucleation temperature that is greater than or equal to 560° C. and less than or equal to 720° C. It should be understood that the nucleation temperature corresponds to the temperature of the oven in which the precursor glass is heated and that the temperature of the precursor glass may be within +/−5° C. of the nucleation temperature when the temperature of the oven is at the nucleation temperature. At step 1002, the precursor glass is held in the oven for a first duration in a temperature range that is greater than or equal to the nucleation temperature and less than or equal to 720° C. to form a nucleated precursor glass. At step 1003, the nucleated precursor glass is heated to a growth temperature that is greater than or equal to 740° C. and less than or equal to 880° C. At step 1004, the nucleated precursor glass is held for a second duration in a temperature range that is greater than or equal to the growth temperature and less than or equal to 880° C. to form the glass-ceramic. In embodiments, at step 1005, the glass-ceramic may be exposed to an ion exchange medium comprising a molten potassium salt, a molten sodium salt, or combinations thereof, with or without additions of LiNO₃ to the ion exchange bath, to form a strengthened glass-ceramic. Each of these steps will be described in more detail below.

In embodiments, the nucleation stage takes place when a precursor glass is held at the predetermined nucleation temperature for a predetermined duration. In embodiments, the nucleation temperature is greater than or equal to 560° C. and less than or equal to 720° C., greater than or equal to 560° C. and less than or equal to 700° C., greater than or equal to 560° C. and less than or equal to 680° C., greater than or equal to 560° C. and less than or equal to 660° C., greater than or equal to 560° C. and less than or equal to 640° C., greater than or equal to 560° C. and less than or equal to 620° C., or greater than or equal to 560° C. and less than or equal to 600° C. It should be understood that the above ranges include all subranges within the explicitly disclosed ranges.

In embodiments, the precursor glass is held at the nucleation temperature for a duration that is greater than or equal to 0 minutes to less than or equal to 360 minutes, greater than or equal to 0 minutes to less than or equal to 330 minutes, greater than or equal to 0 minutes to less than or equal to 300 minutes, greater than or equal to 0 minutes to less than or equal to 270 minutes, greater than or equal to 0 minutes to less than or equal to 240 minutes, greater than or equal to 0 minutes to less than or equal to 210 minutes, greater than or equal to 0 minutes to less than or equal to 180 minutes, greater than or equal to 0 minutes to less than or equal to 150 minutes, greater than or equal to 0 minutes to less than or equal to 120 minutes, greater than or equal to 1 minute to less than or equal to 360 minutes, greater than or equal to 30 minutes to less than or equal to 360 minutes, greater than or equal to 60 minutes to less than or equal to 360 minutes, greater than or equal to 90 minutes to less than or equal to 360 minutes, greater than or equal to 120 minutes to less than or equal to 360 minutes, greater than or equal to 150 minutes to less than or equal to 360 minutes, greater than or equal to 180 minutes to less than or equal to 360 minutes, greater than or equal to 210 minutes to less than or equal to 360 minutes, greater than or equal to 240 minutes to less than or equal to 360 minutes, greater than or equal to 270 minutes to less than or equal to 360 minutes, greater than or equal to 300 minutes to less than or equal to 360 minutes, greater than or equal to 330 minutes to less than or equal to 360 minutes, greater than or equal to 1 minute to less than or equal to 330 minutes, greater than or equal to 30 minutes to less than or equal to 330 minutes, greater than or equal to 60 minutes to less than or equal to 330 minutes, greater than or equal to 90 minutes to less than or equal to 330 minutes, greater than or equal to 120 minutes to less than or equal to 330 minutes, greater than or equal to 150 minutes to less than or equal to 330 minutes, greater than or equal to 180 minutes to less than or equal to 330 minutes, greater than or equal to 210 minutes to less than or equal to 330 minutes, greater than or equal to 240 minutes to less than or equal to 330 minutes, greater than or equal to 270 minutes to less than or equal to 330 minutes, greater than or equal to 300 minutes to less than or equal to 330 minutes, greater than or equal to 1 minute to less than or equal to 300 minutes, greater than or equal to 30 minutes to less than or equal to 300 minutes, greater than or equal to 60 minutes to less than or equal to 300 minutes, greater than or equal to 90 minutes to less than or equal to 300 minutes, greater than or equal to 120 minutes to less than or equal to 300 minutes, greater than or equal to 150 minutes to less than or equal to 300 minutes, greater than or equal to 180 minutes to less than or equal to 300 minutes, greater than or equal to 210 minutes to less than or equal to 300 minutes, greater than or equal to 240 minutes to less than or equal to 300 minutes, greater than or equal to 270 minutes to less than or equal to 300 minutes, greater than or equal to 1 minute to less than or equal to 270 minutes, greater than or equal to 30 minutes to less than or equal to 270 minutes, greater than or equal to 60 minutes to less than or equal to 270 minutes, greater than or equal to 90 minutes to less than or equal to 270 minutes, greater than or equal to 120 minutes to less than or equal to 270 minutes, greater than or equal to 150 minutes to less than or equal to 270 minutes, greater than or equal to 180 minutes to less than or equal to 270 minutes, greater than or equal to 210 minutes to less than or equal to 270 minutes, greater than or equal to 240 minutes to less than or equal to 270 minutes, greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. After the nucleation stage, the precursor glass is referred to as a nucleated precursor glass.

The growth stage takes place when a nucleated precursor glass is held at the predetermined growth temperature for a predetermined duration. The growth temperature is, in embodiments, greater than the nucleation temperature. In embodiments, the growth temperature is greater than or equal to 740° C. and less than or equal to 880° C., greater than or equal to 760° C. and less than or equal to 880° C., greater than or equal to 760° C. and less than or equal to 870° C., greater than or equal to 760° C. and less than or equal to 860° C., greater than or equal to 760° C. and less than or equal to 850° C., greater than or equal to 760° C. and less than or equal to 840° C., greater than or equal to 760° C. and less than or equal to 830° C., greater than or equal to 760° C. and less than or equal to 820° C., greater than or equal to 770° C. and less than or equal to 820° C., greater than or equal to 770° C. and less than or equal to 815° C., greater than or equal to 775° C. and less than or equal to 815° C., greater than or equal to 775° C. and less than or equal to 810° C., greater than or equal to 780° C. and less than or equal to 810° C., greater than or equal to 780° C. and less than or equal to 805° C., greater than or equal to 785° C. and less than or equal to 805° C., greater than or equal to 780° C. and less than or equal to 880° C., greater than or equal to 790° C. and less than or equal to 880° C., greater than or equal to 800° C. and less than or equal to 880° C., or greater than or equal to 800° C. and less than or equal to 875° C. It should be understood that the above ranges include all subranges within the explicitly disclosed ranges.

In embodiments, the nucleated precursor glass is held at the growth temperature for a duration that is greater than or equal to 1 minute to less than or equal to 240 minutes, greater than or equal to 15 minutes to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. The growth stage transitions the nucleated precursor glass into a glass-ceramic material (i.e., a glass-ceramic or glass-ceramic article).

In embodiments of the methods described herein, the precursor glass comprises: greater than or equal to 65 wt % and less than or equal to 80 wt % SiO₂; greater than 2 wt % and less than or equal to 12 wt % Al₂O₃; greater than or equal to 0.1 wt % and less than or equal to 3.5 wt % P₂O₅; greater than or equal to 8 wt % and less than or equal to 26 wt % Li₂O; greater than or equal to 1 wt % and less than or equal to 15 wt % ZrO₂; and less than or equal to 4 wt % CaO. In one or more embodiments, of the methods described herein, the precursor glass comprises: greater than 4 wt % and less than or equal to 12 wt % Al₂O₃; greater than or equal to 8 wt % and less than or equal to 17 wt % Li₂O; greater than or equal to 4 wt % and less than or equal to 15 wt % ZrO₂; and greater than or equal to 0.05 wt % and less than or equal to 4 wt % CaO. In one or more embodiments of the methods described herein, the precursor glass comprises: greater than 2 wt % and less than or equal to 8 wt % Al₂O₃; greater than or equal to 0.1 wt % and less than or equal to 2 wt % P₂O₅; greater than or equal to 16 wt % and less than or equal to 26 wt % Li₂O; greater than or equal to 1 wt % and less than or equal to 6 wt % ZrO₂; and greater than or equal to 0.5 wt % and less than or equal to 5 wt % Na₂O.

A precursor glass article as disclosed and described herein held at the nucleation temperature and growth temperature for the durations disclosed and described herein will form a glass-ceramic having a phase assemblage comprising a residual amorphous glass phase, a lithium disilicate (Li₂Si₂O₅) crystalline phase, and various combinations of petalite, virgilite, and β-spodumene. As noted herein, this phase assemblage provides a glass-ceramic that has controlled and aesthetically desirable optical properties while maintained improved mechanical properties.

It is believed that the nucleation and growth temperatures and durations disclosed and described herein are the heat treatments that primarily result in the desired phase assemblage in the glass-ceramics. Additional heat treatments may be included before the nucleation stage, between the nucleation stage and the growth stage, and after the growth stage without causing significant deviation in the phase assemblage of the glass-ceramic material. These additional heat treatments include isothermal holds, heating at specific heating schedules including a number of differing heating rates, and combinations thereof.

Accordingly, in embodiments, there may be one of more additional temperature holds between the nucleation temperature and the growth temperature. In embodiments, after maintaining the precursor glass at the nucleation temperature, the article may be heated to one or more intermediate temperatures (wherein the intermediate temperatures are in a range between the nucleation temperature and the growth temperature) and held at the one or more intermediate temperatures for a predetermined time (for example, between 1 minute and 360 minutes and all ranges and subranges there between) and then heated to the growth temperature.

In embodiments, the nucleation stage comprises an isothermal hold at a single nucleation temperature for a duration. However, in other embodiments, the nucleation stage includes heating the precursor glass at one or more heating rates through the nucleation temperature range described herein (e.g., from greater than or equal to 560° C. to less than or equal to 720° C.). Likewise, in embodiments, the growth stage comprises an isothermal hold at a single growth temperature for a duration. However, in other embodiments, the growth stage includes heating or cooling the nucleated precursor glass at one or more heating rates within a growth temperature range described herein (e.g., from greater than or equal to 740° C. to less than or equal to 880° C.).

According to embodiments, heating rates used to heat from room temperature to the nucleation temperature, within the nucleation stage, between the nucleation stage and the growth stage, within the growth stage, and after the growth stage may independently be greater than or equal to 0.1° C./min and less than or equal to 50° C./min, greater than or equal to 5° C./min and less than or equal to 50° C./min, greater than or equal to 10° C./min and less than or equal to 50° C./min, greater than or equal to 15° C./min and less than or equal to 50° C./min, greater than or equal to 20° C./min and less than or equal to 50° C./min, greater than or equal to 25° C./min and less than or equal to 50° C./min, greater than or equal to 30° C./min and less than or equal to 50° C./min, greater than or equal to 35° C./min and less than or equal to 50° C./min, greater than or equal to 40° C./min and less than or equal to 50° C./min, greater than or equal to 45° C./min and less than or equal to 50° C./min, greater than or equal to 0.1° C./min and less than or equal to 45° C./min, greater than or equal to 5° C./min and less than or equal to 45° C./min, greater than or equal to 10° C./min and less than or equal to 45° C./min, greater than or equal to 15° C./min and less than or equal to 45° C./min, greater than or equal to 20° C./min and less than or equal to 45° C./min, greater than or equal to 25° C./min and less than or equal to 45° C./min, greater than or equal to 30° C./min and less than or equal to 45° C./min, greater than or equal to 35° C./min and less than or equal to 45° C./min, greater than or equal to 40° C./min and less than or equal to 45° C./min, greater than or equal to 0.1° C./min and less than or equal to 40° C./min, greater than or equal to 5° C./min and less than or equal to 40° C./min, greater than or equal to 10° C./min and less than or equal to 40° C./min, greater than or equal to 15° C./min and less than or equal to 40° C./min, greater than or equal to 20° C./min and less than or equal to 40° C./min, greater than or equal to 25° C./min and less than or equal to 40° C./min, greater than or equal to 30° C./min and less than or equal to 40° C./min, greater than or equal to 35° C./min and less than or equal to 40° C./min, greater than or equal to 0.1° C./min and less than or equal to 35° C./min, greater than or equal to 5° C./min and less than or equal to 35° C./min, greater than or equal to 10° C./min and less than or equal to 35° C./min, greater than or equal to 15° C./min and less than or equal to 35° C./min, greater than or equal to 20° C./min and less than or equal to 35° C./min, greater than or equal to 25° C./min and less than or equal to 35° C./min, greater than or equal to 30° C./min and less than or equal to 35° C./min, greater than or equal to 0.1° C./min and less than or equal to 30° C./min, greater than or equal to 5° C./min and less than or equal to 30° C./min, greater than or equal to 10° C./min and less than or equal to 30° C./min, greater than or equal to 15° C./min and less than or equal to 30° C./min, greater than or equal to 20° C./min and less than or equal to 30° C./min, greater than or equal to 25° C./min and less than or equal to 30° C./min, greater than or equal to 0.1° C./min and less than or equal to 25° C./min, greater than or equal to 5° C./min and less than or equal to 25° C./min, greater than or equal to 10° C./min and less than or equal to 25° C./min, greater than or equal to 15° C./min and less than or equal to 25° C./min, greater than or equal to 20° C./min and less than or equal to 25° C./min, greater than or equal to 0.1° C./min and less than or equal to 20° C./min, greater than or equal to 5° C./min and less than or equal to 20° C./min, greater than or equal to 10° C./min and less than or equal to 20° C./min, greater than or equal to 15° C./min and less than or equal to 20° C./min, greater than or equal to 0.1° C./min and less than or equal to 15° C./min, greater than or equal to 5° C./min and less than or equal to 15° C./min, greater than or equal to 10° C./min and less than or equal to 15° C./min, greater than or equal to 0.1° C./min and less than or equal to 10° C./min, greater than or equal to 5° C./min and less than or equal to 10° C./min, or greater than or equal to 0.1° C./min and less than or equal to 5° C./min. It should be understood that the above ranges include all subranges within the explicitly disclosed ranges. Such heating rates allow the proper amount of nucleation and crystal growth without damaging the glass-ceramic article. If heating is done to quickly, the material may be damaged. However, if heating is done too slowly, proper nucleation and growth may not occur.

In embodiments, the glass-ceramic is cooled after being held at the growth temperature. In embodiments, the glass-ceramic may be cooled to room temperature in a single stage at a constant cooling rate, in two stages each with a different cooling rate, or in three or more stages each with a different cooling rate. In embodiments, the glass-ceramics are cooled at a controlled rate from the growth temperature to minimize temperature gradients across the articles as well as minimize residual stress across the articles. Temperature gradients and differences in residual stress may lead to the articles warping during cooling. Thus, controlling the cooling to control the temperature gradients and residual stresses may also minimize warpage of the glass-ceramics.

Without wishing to be bound by theory, the phase assemblage of the glass-ceramics described herein (e.g., the respective percentages of the crystalline phases and the residual glass phase) influences the mismatch in indices between the crystals and the residual amorphous glass phase, which controls the translucency of the glass-ceramic article.

In embodiments of the glass-ceramic articles described herein, the weight percentage of the residual amorphous glass phase in the phase assemblage may be greater than or equal to 10 wt % and less than or equal to 30 wt %. In some embodiments, the phase assemblage of the glass-ceramic articles described herein may comprise greater than or equal to 10 wt % and less than or equal to 30 wt %, greater than or equal to 12 wt % and less than or equal to 30 wt %, greater than or equal to 14 wt % and less than or equal to 30 wt %, greater than or equal to 16 wt % and less than or equal to 30 wt %, greater than or equal to 18 wt % and less than or equal to 30 wt %, greater than or equal to 20 wt % and less than or equal to 30 wt %, greater than or equal to 21 wt % and less than or equal to 30 wt %, greater than or equal to 22 wt % and less than or equal to 30 wt %, greater than or equal to 23 wt % and less than or equal to 30 wt %, greater than or equal to 24 wt % and less than or equal to 30 wt %, or greater than or equal to 25 wt % and less than or equal to 30 wt % of the residual amorphous glass phase. It should be understood that the above ranges include all subranges within the explicitly disclosed ranges. In embodiments, the glass-ceramics may comprise about 10, 11, 12, 13, 14, 15, 16, 17, 18, 19, 20, 21, 22, 23, 24, 25, 26, 27, 28, 29, or 30 wt % of the residual amorphous glass phase.

In embodiments, the weight percentage of the lithium disilicate crystalline phase (also referred to herein as “L2S”) in the glass-ceramic articles can be in a range from greater than or equal to 15 wt % and less than or equal to 45 wt %, greater than or equal to 15 wt % and less than or equal to 42 wt %, greater than or equal to 20 wt % and less than or equal to 42 wt %, greater than or equal to 22 wt % and less than or equal to 42 wt %, greater than or equal to 24 wt % and less than or equal to 42 wt %, greater than or equal to 26 wt % and less than or equal to 42 wt %, greater than or equal to 28 wt % and less than or equal to 42 wt %, greater than or equal to 30 wt % and less than or equal to 42 wt %, greater than or equal to 31 wt % and less than or equal to 42 wt %, greater than or equal to 32 wt % and less than or equal to 42 wt %, or greater than or equal to 33% and less than or equal to 42 wt %. It should be understood that the above ranges include all subranges within the explicitly disclosed ranges.

In embodiments, the weight percentage of the spodumene crystalline phase in the glass-ceramic articles may be less than or equal to 45 wt %, less than or equal to 44 wt %, less than or equal to 43 wt %, less than or equal to 42 wt %, less than or equal to 41 wt %, less than or equal to 40.5 wt %, less than or equal to 35 wt %, less than or equal to 33 wt %, less than or equal to 30 wt %, less than or equal to 25 wt %, less than or equal to 20 wt %, less than or equal to 15 wt %, less than or equal to 13 wt %, less than or equal to 12 wt %, greater than or equal to 1 wt % and less than or equal to 42 wt %, greater than or equal to 2 wt % and less than or equal to 42 wt %, greater than or equal to 2 wt % and less than or equal to 40 wt %, greater than or equal to 2 wt % and less than or equal to 38 wt %, greater than or equal to 2 wt % and less than or equal to 36 wt %, greater than or equal to 2 wt % and less than or equal to 35 wt %, greater than or equal to 2 wt % and less than or equal to 34 wt %, greater than or equal to 2 wt % and less than or equal to 33 wt %, greater than or equal to 2 wt % and less than or equal to 30 wt %, greater than or equal to 2 wt % and less than or equal to 25 wt %, greater than or equal to 2 wt % and less than or equal to 20 wt %, greater than or equal to 2 wt % and less than or equal to 18 wt %, greater than or equal to 2 wt % and less than or equal to 16 wt %, greater than or equal to 2 wt % and less than or equal to 15 wt %, greater than or equal to 2 wt % and less than or equal to 14 wt %, greater than or equal to 2 wt % and less than or equal to 13 wt %, greater than or equal to 2 wt % and less than or equal to 12 wt %, greater than or equal to 3 wt % and less than or equal to 40 wt %, greater than or equal to 3 wt % and less than or equal to 38 wt %, greater than or equal to 3 wt % and less than or equal to 36 wt %, greater than or equal to 3 wt % and less than or equal to 35 wt %, greater than or equal to 3 wt % and less than or equal to 34 wt %, greater than or equal to 3 wt % and less than or equal to 33 wt %, greater than or equal to 3 wt % and less than or equal to 30 wt %, greater than or equal to 3 wt % and less than or equal to 25 wt %, greater than or equal to 3 wt % and less than or equal to 20 wt %, greater than or equal to 3 wt % and less than or equal to 18 wt %, greater than or equal to 3 wt % and less than or equal to 16 wt %, greater than or equal to 3 wt % and less than or equal to 15 wt %, greater than or equal to 3 wt % and less than or equal to 14 wt %, greater than or equal to 3 wt % and less than or equal to 13 wt %, or greater than or equal to 3 wt % and less than or equal to 12 wt %. Without wishing to be bound by theory, it is believed that, in embodiments, the opacity of glass-ceramic articles disclosed herein may be controlled within a range of approximately 21% to 36% by controlling the ceramming schedule such that the weight percentage of the spodumene crystalline phase in the glass-ceramic articles to greater than or equal to 3 wt % and less than or equal to 12 wt %. It should be understood that the above ranges include all subranges within the explicitly disclosed ranges.

In embodiments, the weight percentage of the petalite crystalline phase in the glass-ceramic articles may be less than or equal to 45 wt %, less than or equal to 44 wt %, less than or equal to 43 wt %, less than or equal to 42 wt %, less than or equal to 41 wt %, less than or equal to 40 wt %, less than or equal to 38 wt %, less than or equal to 36 wt %, less than or equal to 34 wt %, less than or equal to 32 wt %, less than or equal to 30 wt %, less than or equal to 28 wt %, less than or equal to 26 wt %, less than or equal to 24 wt %, less than or equal to 22 wt %, less than or equal to 20 wt %, less than or equal to 18 wt %, less than or equal to 16 wt %, less than or equal to 15 wt %, less than or equal to 14 wt %, less than or equal to 13 wt %, less than or equal to 12 wt %, less than or equal to 11 wt %, less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, or less than or equal to 1 wt %. It should be understood that the above ranges include all subranges within the explicitly disclosed ranges.

In embodiments, the weight percentage of the virgilite crystalline phase in the glass-ceramic articles may be less than or equal to 45 wt %, greater than or equal to 0.5 wt % and less than or equal to 45 wt %, greater than or equal to 1 wt % and less than or equal to 45 wt %, greater than or equal to 1 wt % and less than or equal to 44 wt %, greater than or equal to 1 wt % and less than or equal to 43 wt %, greater than or equal to 1 wt % and less than or equal to 42 wt %, greater than or equal to 1 wt % and less than or equal to 41 wt %, greater than or equal to 1 wt % and less than or equal to 40 wt %, greater than or equal to 1.5 wt % and less than or equal to 40 wt %, greater than or equal to 2 wt % and less than or equal to 40 wt %, greater than or equal to 2.5 wt % and less than or equal to 40 wt %, greater than or equal to 3 wt % and less than or equal to 40 wt %, greater than or equal to 4 wt % and less than or equal to 40 wt %, greater than or equal to 5 wt % and less than or equal to 40 wt %, greater than or equal to 6 wt % and less than or equal to 40 wt %, greater than or equal to 7 wt % and less than or equal to 40 wt %, greater than or equal to 8 wt % and less than or equal to 40 wt %, greater than or equal to 9 wt % and less than or equal to 40 wt %, greater than or equal to 10 wt % and less than or equal to 40 wt %, greater than or equal to 12 wt % and less than or equal to 40 wt %, greater than or equal to 14 wt % and less than or equal to 40 wt %, greater than or equal to 16 wt % and less than or equal to 40 wt %, greater than or equal to 18 wt % and less than or equal to 40 wt %, greater than or equal to 20 wt % and less than or equal to 40 wt %, greater than or equal to 22 wt % and less than or equal to 40 wt %, greater than or equal to 24 wt % and less than or equal to 40 wt %, greater than or equal to 26 wt % and less than or equal to 40 wt %, greater than or equal to 28 wt % and less than or equal to 40 wt %, greater than or equal to 30 wt % and less than or equal to 40 wt %, greater than or equal to 32 wt % and less than or equal to 40 wt %, or greater than or equal to 25 wt % and less than or equal to 35 wt %. It should be understood that the above ranges include all subranges within the explicitly disclosed ranges.

In embodiments, the weight percentage of the lithium disilicate crystalline phase in the glass-ceramic articles may be less than or equal to 6 wt %, greater than or equal to 0.5 wt % and less than or equal to 6.0 wt %, greater than or equal to 1.0 wt % and less than or equal to 6 wt %, greater than or equal to 1.0 wt % and less than or equal to 5 wt %, greater than or equal to 1.0 wt % and less than or equal to 4.5 wt %, greater than or equal to 1.0 wt % and less than or equal to 4.0 wt %, greater than or equal to 1.0 wt % and less than or equal to 3.5 wt %, greater than or equal to 1.5 wt % and less than or equal to 5.0 wt %, greater than or equal to 1.5 wt % and less than or equal to 4.5 wt %, greater than or equal to 1.5 wt % and less than or equal to 4.0 wt %, or greater than or equal to 1.5 wt % and less than or equal to 3.5 wt %. It should be understood that the above ranges include all subranges within the explicitly disclosed ranges.

In embodiments, the weight percentage of a sum of a virgilite crystalline phase and the spodumene crystalline phase may be greater than or equal to 0 wt % and less than or equal to 50 wt %, greater than or equal to 1.0 wt % and less than or equal to 50 wt %, greater than or equal to 2.0 wt % and less than or equal to 50 wt %, greater than or equal to 4.0 wt % and less than or equal to 50 wt %, greater than or equal to 6.0 wt % and less than or equal to 50 wt %, greater than or equal to 8.0 wt % and less than or equal to 50 wt %, greater than or equal to 10 wt % and less than or equal to 50 wt %, greater than or equal to 12 wt % and less than or equal to 50 wt %, greater than or equal to 14 wt % and less than or equal to 50 wt %, greater than or equal to 16 wt % and less than or equal to 50 wt %, greater than or equal to 18 wt % and less than or equal to 50 wt %, greater than or equal to 20 wt % and less than or equal to 50 wt %, greater than or equal to 22 wt % and less than or equal to 50 wt %, greater than or equal to 24 wt % and less than or equal to 50 wt %, greater than or equal to 26 wt % and less than or equal to 50 wt %, greater than or equal to 28 wt % and less than or equal to 50 wt %, greater than or equal to 29 wt % and less than or equal to 50 wt %, greater than or equal to 30 wt % and less than or equal to 50 wt %, greater than or equal to 30.5 wt % and less than or equal to 50 wt %, greater than or equal to 31 wt % and less than or equal to 50 wt %, greater than or equal to 31.5 wt % and less than or equal to 50 wt %, greater than or equal to 32 wt % and less than or equal to 50 wt %, greater than or equal to 32.5 wt % and less than or equal to 50 wt %, greater than or equal to 33 wt % and less than or equal to 50 wt %, greater than or equal to 33.5 wt % and less than or equal to 50 wt %, greater than or equal to 34 wt % and less than or equal to 50 wt %, greater than or equal to 34.5 wt % and less than or equal to 50 wt %, greater than or equal to 35 wt % and less than or equal to 50 wt %, greater than or equal to 35.5 wt % and less than or equal to 50 wt %, or greater than or equal to 36 wt % and less than or equal to 50 wt %, greater than or equal to 0 wt % and less than or equal to 48 wt %, greater than or equal to 1.0 wt % and less than or equal to 48 wt %, greater than or equal to 2.0 wt % and less than or equal to 48 wt %, greater than or equal to 4.0 wt % and less than or equal to 48 wt %, greater than or equal to 6.0 wt % and less than or equal to 48 wt %, greater than or equal to 8.0 wt % and less than or equal to 48 wt %, greater than or equal to 10 wt % and less than or equal to 48 wt %, greater than or equal to 12 wt % and less than or equal to 48 wt %, greater than or equal to 14 wt % and less than or equal to 48 wt %, greater than or equal to 16 wt % and less than or equal to 48 wt %, greater than or equal to 18 wt % and less than or equal to 48 wt %, greater than or equal to 20 wt % and less than or equal to 48 wt %, greater than or equal to 22 wt % and less than or equal to 48 wt %, greater than or equal to 24 wt % and less than or equal to 48 wt %, greater than or equal to 26 wt % and less than or equal to 48 wt %, greater than or equal to 28 wt % and less than or equal to 48 wt %, greater than or equal to 29 wt % and less than or equal to 48 wt %, greater than or equal to 30 wt % and less than or equal to 48 wt %, greater than or equal to 30.5 wt % and less than or equal to 48 wt %, greater than or equal to 31 wt % and less than or equal to 48 wt %, greater than or equal to 31.5 wt % and less than or equal to 48 wt %, greater than or equal to 32 wt % and less than or equal to 48 wt %, greater than or equal to 32.5 wt % and less than or equal to 48 wt %, greater than or equal to 33 wt % and less than or equal to 48 wt %, greater than or equal to 33.5 wt % and less than or equal to 48 wt %, greater than or equal to 34 wt % and less than or equal to 48 wt %, greater than or equal to 34.5 wt % and less than or equal to 48 wt %, greater than or equal to 35 wt % and less than or equal to 48 wt %, greater than or equal to 35.5 wt % and less than or equal to 48 wt %, or greater than or equal to 36 wt % and less than or equal to 48 wt %, greater than or equal to 0 wt % and less than or equal to 46 wt %, greater than or equal to 1.0 wt % and less than or equal to 46 wt %, greater than or equal to 2.0 wt % and less than or equal to 46 wt %, greater than or equal to 4.0 wt % and less than or equal to 46 wt %, greater than or equal to 6.0 wt % and less than or equal to 46 wt %, greater than or equal to 8.0 wt % and less than or equal to 46 wt %, greater than or equal to 10 wt % and less than or equal to 46 wt %, greater than or equal to 12 wt % and less than or equal to 46 wt %, greater than or equal to 14 wt % and less than or equal to 46 wt %, greater than or equal to 16 wt % and less than or equal to 46 wt %, greater than or equal to 18 wt % and less than or equal to 46 wt %, greater than or equal to 20 wt % and less than or equal to 46 wt %, greater than or equal to 22 wt % and less than or equal to 46 wt %, greater than or equal to 24 wt % and less than or equal to 46 wt %, greater than or equal to 26 wt % and less than or equal to 46 wt %, greater than or equal to 28 wt % and less than or equal to 46 wt %, greater than or equal to 29 wt % and less than or equal to 46 wt %, greater than or equal to 30 wt % and less than or equal to 46 wt %, greater than or equal to 30.5 wt % and less than or equal to 46 wt %, greater than or equal to 31 wt % and less than or equal to 46 wt %, greater than or equal to 31.5 wt % and less than or equal to 46 wt %, greater than or equal to 32 wt % and less than or equal to 46 wt %, greater than or equal to 32.5 wt % and less than or equal to 46 wt %, greater than or equal to 33 wt % and less than or equal to 46 wt %, greater than or equal to 33.5 wt % and less than or equal to 46 wt %, greater than or equal to 34 wt % and less than or equal to 46 wt %, greater than or equal to 34.5 wt % and less than or equal to 46 wt %, greater than or equal to 35 wt % and less than or equal to 46 wt %, greater than or equal to 35.5 wt % and less than or equal to 46 wt %, or greater than or equal to 36 wt % and less than or equal to 46 wt %. It should be understood that the above ranges include all subranges within the explicitly disclosed ranges.

In embodiments, the glass-ceramic articles described herein and the glass-ceramic articles produced by the methods described herein have particular optical properties including opacity, haze, transmittance, reflected color, transmitted color, and combinations thereof. Without wishing to be bound by theory, it is believed that the residual glass content, the crystalline phase assemblage (type and content of crystalline phase(s) present) and crystalline morphology (size and shape of crystalline phase(s) present) control the optical properties of the glass-ceramic articles described herein.

The grain size of the crystals in the crystalline phases is a factor that affects the translucency of the glass-ceramics. In embodiments, the grains have a longest dimension in a range from about 5 nm to about 150 nm, about 5 nm to about 125 nm, about 5 nm to about 100 nm, about 5 nm to about 75 nm, about 5 nm to about 50 nm, about 25 nm to about 150 nm, about 25 nm to about 125 nm, about 25 nm to about 100 nm, about 25 nm to about 75 nm, about 50 nm to about 150 nm, about 50 nm to about 125 nm, about 50 nm to about 100 nm, and all ranges and subranges there between. In embodiments, the longest dimension of the grains is less than 150 nm, less than 125 nm, less than 100 nm, less than 75 nm, less than 50 nm, or less than 25 nm. The longest dimension of the grains is measured using a scanning electron microscope (SEM) and image analysis.

In embodiments, the glass-ceramic articles disclosed herein have an opacity greater than or equal to 10% and less than or equal to 65%, measured on a 0.55 mm thick glass-ceramic article. In one or more embodiments, the glass-ceramic articles disclosed herein have an opacity, measured on a 0.55 mm thick glass-ceramic article, of greater than or equal to 10% and less than or equal to 60%, greater than or equal to 10% and less than or equal to 55%, greater than or equal to 10% and less than or equal to 50%, greater than or equal to 12% and less than or equal to 65%, greater than or equal to 12.5% and less than or equal to 65%, greater than or equal to 13% and less than or equal to 65%, greater than or equal to 13.5% and less than or equal to 65%, greater than or equal to 14% and less than or equal to 65%, greater than or equal to 14.5% and less than or equal to 65%, greater than or equal to 15% and less than or equal to 65%, greater than or equal to 15% and less than or equal to 62%, greater than or equal to 15% and less than or equal to 60%, greater than or equal to 15% and less than or equal to 58%, greater than or equal to 15% and less than or equal to 56%, greater than or equal to 15% and less than or equal to 54%, greater than or equal to 15% and less than or equal to 52%, greater than or equal to 15% and less than or equal to 50%, greater than or equal to 13% and less than or equal to 50%, greater than or equal to 13.5% and less than or equal to 50%, greater than or equal to 14% and less than or equal to 50%, greater than or equal to 14.2% and less than or equal to 50%, greater than or equal to 14.4% and less than or equal to 50%, greater than or equal to 14.6% and less than or equal to 50%, greater than or equal to 14.8% and less than or equal to 50%, greater than or equal to 15% and less than or equal to 50%, greater than or equal to 15.5% and less than or equal to 50%, greater than or equal to 16% and less than or equal to 50%, greater than or equal to 16.5% and less than or equal to 50%, greater than or equal to 17% and less than or equal to 50%, greater than or equal to 17.5% and less than or equal to 50%, greater than or equal to 18% and less than or equal to 50%, greater than or equal to 18.5% and less than or equal to 50%, greater than or equal to 19% and less than or equal to 50%, greater than or equal to 19.5% and less than or equal to 50%, or greater than or equal to 20% and less than or equal to 50%.

In one or more embodiments, the glass-ceramic articles disclosed herein have an opacity, measured on a 0.55 mm thick glass-ceramic article, of greater than or equal to 21% and less than or equal to 50%, greater than or equal to 21% and less than or equal to 48%, greater than or equal to 21% and less than or equal to 46%, greater than or equal to 21% and less than or equal to 44%, greater than or equal to 21% and less than or equal to 42%, greater than or equal to 21% and less than or equal to 40%, greater than or equal to 21% and less than or equal to 38%, or greater than or equal to 21% and less than or equal to 36%.

In one or more embodiments, the glass-ceramic articles disclosed herein have a haze, measured on a 0.5 mm thick glass-ceramic article, of greater than or equal to 0.2% and less than or equal to 98%, greater than or equal to 0.4% and less than or equal to 98%, greater than or equal to 0.6% and less than or equal to 98%, greater than or equal to 0.8% and less than or equal to 98%, greater than or equal to 1.0% and less than or equal to 98%, greater than or equal to 2% and less than or equal to 98%, greater than or equal to 3.0% and less than or equal to 98%, greater than or equal to 4.0% and less than or equal to 98%, greater than or equal to 5.0% and less than or equal to 98%, greater than or equal to 6.0% and less than or equal to 98%, greater than or equal to 7% and less than or equal to 98%, greater than or equal to 8.0% and less than or equal to 98%, greater than or equal to 9.0% and less than or equal to 98%, greater than or equal to 10% and less than or equal to 98%, greater than or equal to 15% and less than or equal to 98%, greater than or equal to 20% and less than or equal to 98%, greater than or equal to 25% and less than or equal to 98%, greater than or equal to 30% and less than or equal to 98%, greater than or equal to 35% and less than or equal to 98%, greater than or equal to 40% and less than or equal to 98%, greater than or equal to 45% and less than or equal to 98%, greater than or equal to 50% and less than or equal to 98%, greater than or equal to 0.2% and less than or equal to 95%, greater than or equal to 0.4% and less than or equal to 95%, greater than or equal to 0.6% and less than or equal to 95%, greater than or equal to 0.8% and less than or equal to 95%, greater than or equal to 1.0% and less than or equal to 95%, greater than or equal to 2% and less than or equal to 95%, greater than or equal to 3.0% and less than or equal to 95%, greater than or equal to 4.0% and less than or equal to 95%, greater than or equal to 5% and less than or equal to 95%, greater than or equal to 6.0% and less than or equal to 95%, greater than or equal to 7% and less than or equal to 95%, greater than or equal to 8.0% and less than or equal to 95%, greater than or equal to 9.0% and less than or equal to 95%, greater than or equal to 10% and less than or equal to 95%, greater than or equal to 15% and less than or equal to 95%, greater than or equal to 20% and less than or equal to 95%, greater than or equal to 25% and less than or equal to 95%, greater than or equal to 30% and less than or equal to 95%, greater than or equal to 35% and less than or equal to 95%, greater than or equal to 40% and less than or equal to 95%, greater than or equal to 45% and less than or equal to 95%, greater than or equal to 50% and less than or equal to 95%, greater than or equal to 0.2% and less than or equal to 90%, greater than or equal to 0.4% and less than or equal to 90%, greater than or equal to 0.6% and less than or equal to 90%, greater than or equal to 0.8% and less than or equal to 90%, greater than or equal to 1.0% and less than or equal to 90%, greater than or equal to 2% and less than or equal to 90%, greater than or equal to 3.0% and less than or equal to 90%, greater than or equal to 4.0% and less than or equal to 90%, greater than or equal to 5.0% and less than or equal to 90%, greater than or equal to 6.0% and less than or equal to 90%, greater than or equal to 7% and less than or equal to 90%, greater than or equal to 8.0% and less than or equal to 90%, greater than or equal to 9.0% and less than or equal to 90%, greater than or equal to 10% and less than or equal to 90%, greater than or equal to 15% and less than or equal to 90%, greater than or equal to 20% and less than or equal to 90%, greater than or equal to 25% and less than or equal to 90%, greater than or equal to 30% and less than or equal to 90%, greater than or equal to 35% and less than or equal to 90%, greater than or equal to 40% and less than or equal to 90%, greater than or equal to 45% and less than or equal to 90%, greater than or equal to 50% and less than or equal to 90%, greater than or equal to 10% and less than or equal to 85%, greater than or equal to 10% and less than or equal to 80%, greater than or equal to 10% and less than or equal to 75%, greater than or equal to 10% and less than or equal to 70%, greater than or equal to 15% and less than or equal to 85%, greater than or equal to 15% and less than or equal to 80%, greater than or equal to 15% and less than or equal to 75%, greater than or equal to 15% and less than or equal to 70%, greater than or equal to 20% and less than or equal to 85%, greater than or equal to 20% and less than or equal to 80%, greater than or equal to 20% and less than or equal to 75%, greater than or equal to 20% and less than or equal to 70%, greater than or equal to 25% and less than or equal to 85%, greater than or equal to 25% and less than or equal to 80%, greater than or equal to 25% and less than or equal to 75%, greater than or equal to 25% and less than or equal to 70%, greater than or equal to 30% and less than or equal to 85%, greater than or equal to 30% and less than or equal to 80%, greater than or equal to 30% and less than or equal to 75%, greater than or equal to 30% and less than or equal to 70%, greater than or equal to 35% and less than or equal to 85%, greater than or equal to 35% and less than or equal to 80%, greater than or equal to 35% and less than or equal to 75%, greater than or equal to 35% and less than or equal to 70%, greater than or equal to 40% and less than or equal to 85%, greater than or equal to 40% and less than or equal to 80%, greater than or equal to 40% and less than or equal to 75%, greater than or equal to 40% and less than or equal to 70%, greater than or equal to 45% and less than or equal to 85%, greater than or equal to 45% and less than or equal to 80%, greater than or equal to 45% and less than or equal to 75%, greater than or equal to 45% and less than or equal to 70%, greater than or equal to 50% and less than or equal to 85%, greater than or equal to 50% and less than or equal to 80%, greater than or equal to 50% and less than or equal to 75%, or greater than or equal to 50% and less than or equal to 70%.

In embodiments, the average total transmittance of the glass-ceramic articles described herein, measured on a 0.55 mm thick glass-ceramic article at wavelengths of 400 nm to 800 nm, may be greater than or equal to 30% and less than or equal to 95%, greater than or equal to 30% and less than or equal to 92%, greater than or equal to 30% and less than or equal to 91%, greater than or equal to 30% and less than or equal to 90%, greater than or equal to 30% and less than or equal to 88%, greater than or equal to 30% and less than or equal to 86%, greater than or equal to 30% and less than or equal to 84%, greater than or equal to 30% and less than or equal to 82%, greater than or equal to 30% and less than or equal to 80%, greater than or equal to 30% and less than or equal to 75%, greater than or equal to 30% and less than or equal to 70%, greater than or equal to 30% and less than or equal to 65%, greater than or equal to 30% and less than or equal to 60%, greater than or equal to 30% and less than or equal to 55%, greater than or equal to 30% and less than or equal to 50%, greater than or equal to 40% and less than or equal to 95%, greater than or equal to 40% and less than or equal to 92%, greater than or equal to 40% and less than or equal to 91%, greater than or equal to 40% and less than or equal to 90%, greater than or equal to 40% and less than or equal to 88%, greater than or equal to 40% and less than or equal to 86%, greater than or equal to 40% and less than or equal to 84%, greater than or equal to 40% and less than or equal to 82%, greater than or equal to 40% and less than or equal to 80%, greater than or equal to 40% and less than or equal to 75%, greater than or equal to 40% and less than or equal to 70%, greater than or equal to 40% and less than or equal to 65%, greater than or equal to 40% and less than or equal to 60%, greater than or equal to 40% and less than or equal to 55%, or greater than or equal to 40% and less than or equal to 50%.

In embodiments, the average total transmittance of the glass-ceramic articles described herein, measured on a 0.55 mm thick glass-ceramic article at wavelengths of 400 nm to 1000 nm, may be greater than or equal to 30% and less than or equal to 95%, greater than or equal to 30% and less than or equal to 92%, greater than or equal to 30% and less than or equal to 91%, greater than or equal to 30% and less than or equal to 90%, greater than or equal to 30% and less than or equal to 88%, greater than or equal to 30% and less than or equal to 86%, greater than or equal to 30% and less than or equal to 84%, greater than or equal to 30% and less than or equal to 82%, greater than or equal to 30% and less than or equal to 80%, greater than or equal to 30% and less than or equal to 75%, greater than or equal to 30% and less than or equal to 70%, greater than or equal to 30% and less than or equal to 65%, greater than or equal to 30% and less than or equal to 60%, greater than or equal to 30% and less than or equal to 55%, greater than or equal to 30% and less than or equal to 50%, greater than or equal to 40% and less than or equal to 95%, greater than or equal to 40% and less than or equal to 92%, greater than or equal to 40% and less than or equal to 91%, greater than or equal to 40% and less than or equal to 90%, greater than or equal to 40% and less than or equal to 88%, greater than or equal to 40% and less than or equal to 86%, greater than or equal to 40% and less than or equal to 84%, greater than or equal to 40% and less than or equal to 82%, greater than or equal to 40% and less than or equal to 80%, greater than or equal to 40% and less than or equal to 75%, greater than or equal to 40% and less than or equal to 70%, greater than or equal to 40% and less than or equal to 65%, greater than or equal to 40% and less than or equal to 60%, greater than or equal to 40% and less than or equal to 55%, greater than or equal to 40% and less than or equal to 50%, greater than or equal to 45% and less than or equal to 90%, greater than or equal to 45% and less than or equal to 88%, greater than or equal to 45% and less than or equal to 86%, greater than or equal to 45% and less than or equal to 84%, greater than or equal to 45% and less than or equal to 82%, greater than or equal to 45% and less than or equal to 80%, greater than or equal to 40% and less than or equal to 75%, greater than or equal to 45% and less than or equal to 70%, greater than or equal to 45% and less than or equal to 65%, greater than or equal to 40% and less than or equal to 60%, greater than or equal to 40% and less than or equal to 55%, or greater than or equal to 45% and less than or equal to 55%.

In embodiments, the glass-ceramics have controlled opacity, haze, and transmittance in the above-disclosed ranges are suitable for use as a protective glass for the backs of electronic devices, such as mobile electronic devices.

In one or more embodiments, the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates: L*=50 to 99; a*=−5.0 to 10.0; and b*=−5.0 to 25.0. In embodiments, the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates: L*=50 to 99; a*=−2.0 to 5.0; and b*=−1.0 to 25.0. In embodiments, the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates: L*=80 to 99; a*=−2.0 to 5.0; and b*=−1.0 to 25.0.

In one or more embodiments, the glass-ceramic article exhibits a reflected color, measured using a D-65-2 illuminant with a black background on a glass-ceramic article having a thickness greater than or equal to 0.5 mm and less than or equal to 0.55 mm, presented in CIELAB color space coordinates: L*=30 to 85; a*=−10.0 to 10.0; and b*=−25.0 to 5.0. In embodiments, the glass-ceramic article exhibits a reflected color, measured using a D-65-2 illuminant with a black background on a glass-ceramic article having a thickness greater than or equal to 0.5 mm and less than or equal to 0.55 mm, presented in CIELAB color space coordinates: L*=30 to 85; a*=−5.0 to 5.0; and b*=−25.0 to 5.0. In embodiments, the glass-ceramic article may exhibit a reflected color, measured using a D-65-2 illuminant with a white background on a glass-ceramic article having a thickness greater than or equal to 0.5 mm and less than or equal to 0.55 mm, presented in CIELAB color space coordinates: L*=80 to 98; a*=−10.0 to 5.0; and b*=−10.0 to 10.0. In embodiments, the glass-ceramic article exhibits a reflected color, measured using a D-65-2 illuminant with a white background on a glass-ceramic article having a thickness greater than or equal to 0.5 mm and less than or equal to 0.55 mm, presented in CIELAB color space coordinates: L*=80 to 98; a*=−5.0 to 2.0; and b*=−10.0 to 5. As with the opacity, haze, and transmittance, the precursor glass compositions and the ceramming schedules disclosed herein allow for the resulting color (transmitted and reflected) of the glass-ceramic articles to be controlled over a wide range. The precursor glass compositions and the ceramming schedules disclosed herein allow for fine control of the aesthetic characteristics of translucent glass-ceramics that also exhibit high mechanical performance, making the glass-ceramic articles disclosed herein particular suitable for electronic devices, such as mobile phones and tablets.

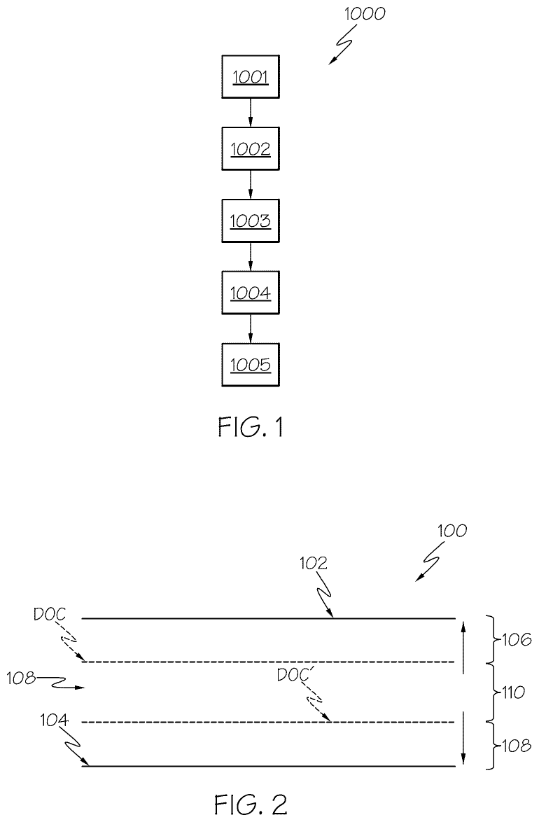

In embodiments, glass-ceramics and glass-ceramic articles may be strengthened to install a compressive stress layer on one or more surface thereof. Referring now to FIG. 2 by way of example, an exemplary cross-sectional side view of a strengthened glass-ceramic article 100 is depicted having a first surface 102 and an opposing second surface 104 separated by a thickness (t). In embodiments, the strengthened glass-ceramic article 100 has been ion exchanged and has a compressive stress (CS) layer 106 (or first region) extending from the first surface 102 to a depth of compression (DOC). In embodiments, as shown in FIG. 2, the glass-ceramic article 100 also has a compressive stress (CS) layer 108 extending from the second surface 104 to a depth of compression DOC′. A central tension region 110 having a central tension (CT) is positioned between DOC and DOC′.

In embodiments, the glass-ceramics and glass-ceramic articles are capable of being chemically tempered (also referred to as chemically strengthened) using one or more ion exchange techniques. In these embodiments, ion exchange can occur by subjecting one or more surfaces of such glass-ceramic or glass-ceramic article to one or more ion exchange mediums (for example molten salt baths), having a specific composition and temperature, for a specified time period to impart to the one or more surfaces with compressive stress layer(s). In embodiments, the ion exchange medium is a molten salt bath containing an ion (for example an alkali metal ion) that is larger than an ion (for example an alkali metal ion) present in the glass-ceramic or glass-ceramic article wherein the larger ion from the molten bath is exchanged with the smaller ion in the glass-ceramic article to impart a compressive stress in the glass-ceramic or glass-ceramic article, and thereby increases the strength of the glass-ceramic or glass-ceramic article.

In embodiments, a one-step ion exchange process can be used. In other embodiments, a multi-step ion exchange process (such as a two-step ion exchange process) can be used. In embodiments, for both one-step and multi-step ion exchange processes, the ion exchange mediums (for example, molten baths) can include potassium nitrate (KNO₃) and/or sodium nitrate (NaNO₃) as primary components. The ion exchange mediums can, in embodiments, further comprise lithium nitrate (LiNO₃), sodium nitrite (NaNO₂), and silicic acid.

In embodiments, the ion exchange medium comprises greater than or equal to 50 wt % and less than or equal to 70 wt % KNO₃, greater than or equal to 55 wt % and less than or equal to 70 wt % KNO₃, greater than or equal to 60 wt % and less than or equal to 70 wt % KNO₃, greater than or equal to 65 wt % and less than or equal to 70 wt % KNO₃, greater than or equal to 50 wt % and less than or equal to 65 wt % KNO₃, greater than or equal to 55 wt % and less than or equal to 65 wt % KNO₃, greater than or equal to 60 wt % and less than or equal to 65 wt % KNO₃, greater than or equal to 50 wt % and less than or equal to 60 wt % KNO₃, greater than or equal to 55 wt % and less than or equal to 60 wt % KNO₃, or greater than or equal to 50 wt % and less than or equal to 55 wt % KNO₃. It should be understood that the above ranges include all subranges within the explicitly disclosed ranges.

In embodiments, the ion exchange medium comprises greater than or equal to 30 wt % and less than or equal to 80 wt % NaNO₃, greater than or equal to 30 wt % and less than or equal to 75 wt % NaNO₃, greater than or equal to 30 wt % and less than or equal to 70 wt % NaNO₃, greater than or equal to 30 wt % and less than or equal to 65 wt % NaNO₃, greater than or equal to 30 wt % and less than or equal to 60 wt % NaNO₃, greater than or equal to 30 wt % and less than or equal to 55 wt % NaNO₃, greater than or equal to 30 wt % and less than or equal to 50 wt % NaNO₃, greater than or equal to 35 wt % and less than or equal to 80 wt % NaNO₃, greater than or equal to 35 wt % and less than or equal to 75 wt % NaNO₃, greater than or equal to 35 wt % and less than or equal to 70 wt % NaNO₃, greater than or equal to 35 wt % and less than or equal to 65 wt % NaNO₃, greater than or equal to 35 wt % and less than or equal to 60 wt % NaNO₃, greater than or equal to 35 wt % and less than or equal to 55 wt % NaNO₃, greater than or equal to 35 wt % and less than or equal to 50 wt % NaNO₃, greater than or equal to 40 wt % and less than or equal to 80 wt % NaNO₃, greater than or equal to 40 wt % and less than or equal to 75 wt % NaNO₃, greater than or equal to 40 wt % and less than or equal to 70 wt % NaNO₃, greater than or equal to 40 wt % and less than or equal to 65 wt % NaNO₃, greater than or equal to 40 wt % and less than or equal to 60 wt % NaNO₃, greater than or equal to 40 wt % and less than or equal to 55 wt % NaNO₃, greater than or equal to 40 wt % and less than or equal to 50 wt % NaNO₃, greater than or equal to 45 wt % and less than or equal to 80 wt % NaNO₃, greater than or equal to 45 wt % and less than or equal to 75 wt % NaNO₃, greater than or equal to 45 wt % and less than or equal to 70 wt % NaNO₃, greater than or equal to 45 wt % and less than or equal to 65 wt % NaNO₃, greater than or equal to 45 wt % and less than or equal to 60 wt % NaNO₃, greater than or equal to 45 wt % and less than or equal to 55 wt % NaNO₃, greater than or equal to 45 wt % and less than or equal to 50 wt % NaNO₃, greater than or equal to 30 wt % and less than or equal to 45 wt % NaNO₃, greater than or equal to 35 wt % and less than or equal to 45 wt % NaNO₃, greater than or equal to 40 wt % and less than or equal to 45 wt % NaNO₃, greater than or equal to 30 wt % and less than or equal to 40 wt % NaNO₃, greater than or equal to 35 wt % and less than or equal to 40 wt % NaNO₃, or greater than or equal to 30 wt % and less than or equal to 35 wt % NaNO₃. It should be understood that the above ranges include all subranges within the explicitly disclosed ranges.

In embodiments, the ion exchange medium comprises greater than or equal to 0.05 wt % and less than or equal to 0.25 wt % LiNO₃, greater than or equal to 0.08 wt % and less than or equal to 0.25 wt % LiNO₃, greater than or equal to 0.10 wt % and less than or equal to 0.25 wt % LiNO₃, greater than or equal to 0.15 wt % and less than or equal to 0.25 wt % LiNO₃, greater than or equal to 0.20 wt % and less than or equal to 0.25 wt % LiNO₃, greater than or equal to 0.05 wt % and less than or equal to 0.20 wt % LiNO₃, greater than or equal to 0.08 wt % and less than or equal to 0.20 wt % LiNO₃, greater than or equal to 0.10 wt % and less than or equal to 0.20 wt % LiNO₃, greater than or equal to 0.15 wt % and less than or equal to 0.20 wt % LiNO₃, greater than or equal to 0.05 wt % and less than or equal to 0.15 wt % LiNO₃, greater than or equal to 0.08 wt % and less than or equal to 0.15 wt % LiNO₃, greater than or equal to 0.10 wt % and less than or equal to 0.15 wt % LiNO₃, greater than or equal to 0.12 wt % and less than or equal to 0.15 wt % LiNO₃, greater than or equal to 0.05 wt % and less than or equal to 0.12 wt % LiNO₃, greater than or equal to 0.08 wt % and less than or equal to 0.12 wt % LiNO₃, greater than or equal to 0.10 wt % and less than or equal to 0.12 wt % LiNO₃, greater than or equal to 0.05 wt % and less than or equal to 0.10 wt % LiNO₃, greater than or equal to 0.08 wt % and less than or equal to 0.10 wt % LiNO₃, or greater than or equal to 0.05 wt % and less than or equal to 0.08 wt % LiNO₃. It should be understood that the above ranges include all subranges within the explicitly disclosed ranges.

In embodiments, the ion exchange medium comprises greater than or equal to 0.40 wt % and less than or equal to 0.60 wt % NaNO₂, greater than or equal to 0.45 wt % and less than or equal to 0.60 wt % NaNO₂, greater than or equal to 0.50 wt % and less than or equal to 0.60 wt % NaNO₂, greater than or equal to 0.55 wt % and less than or equal to 0.60 wt % NaNO₂, greater than or equal to 0.40 wt % and less than or equal to 0.55 wt % NaNO₂, greater than or equal to 0.45 wt % and less than or equal to 0.55 wt % NaNO₂, greater than or equal to 0.50 wt % and less than or equal to 0.55 wt % NaNO₂, greater than or equal to 0.40 wt % and less than or equal to 0.50 wt % NaNO₂, greater than or equal to 0.45 wt % and less than or equal to 0.50 wt % NaNO₂, or greater than or equal to 0.40 wt % and less than or equal to 0.45 wt %. It should be understood that the above ranges include all subranges within the explicitly disclosed ranges.

In embodiments, the ion exchange medium comprises greater than or equal to 0.40 wt % and less than or equal to 0.60 wt % silicic acid, greater than or equal to 0.45 wt % and less than or equal to 0.60 wt % silicic acid, greater than or equal to 0.50 wt % and less than or equal to 0.60 wt % silicic acid, greater than or equal to 0.55 wt % and less than or equal to 0.60 wt % silicic acid, greater than or equal to 0.40 wt % and less than or equal to 0.55 wt % silicic acid, greater than or equal to 0.45 wt % and less than or equal to 0.55 wt % silicic acid, greater than or equal to 0.50 wt % and less than or equal to 0.55 wt % silicic acid, greater than or equal to 0.40 wt % and less than or equal to 0.50 wt % silicic acid, greater than or equal to 0.45 wt % and less than or equal to 0.50 wt % silicic acid, or greater than or equal to 0.40 wt % and less than or equal to 0.45 wt %. It should be understood that the above ranges include all subranges within the explicitly disclosed ranges.

The temperature of the ion exchange medium is, in embodiments, greater than or equal to 430° C. and less than or equal to 550° C., greater than or equal to 450° C. and less than or equal to 550° C., greater than or equal to 475° C. and less than or equal to 550° C., greater than or equal to 500° C. and less than or equal to 550° C., greater than or equal to 525° C. and less than or equal to 550° C., greater than or equal to 530° C. and less than or equal to 550° C., greater than or equal to 430° C. and less than or equal to 530° C., greater than or equal to 450° C. and less than or equal to 530° C., greater than or equal to 475° C. and less than or equal to 530° C., greater than or equal to 500° C. and less than or equal to 530° C., greater than or equal to 525° C. and less than or equal to 530° C., greater than or equal to 430° C. and less than or equal to 525° C., greater than or equal to 450° C. and less than or equal to 525° C., greater than or equal to 475° C. and less than or equal to 525° C., greater than or equal to 500° C. and less than or equal to 525° C., greater than or equal to 430° C. and less than or equal to 500° C., greater than or equal to 450° C. and less than or equal to 500° C., greater than or equal to 475° C. and less than or equal to 500° C., or greater than or equal to 450° C. and less than or equal to 475° C. It should be understood that the above ranges include all subranges within the explicitly disclosed ranges.

According to embodiments, the glass-ceramic article is contacted with the ion exchange medium for a duration that is greater than or equal to 1 hour and less than or equal to 16 hours, greater than or equal to 2 hour and less than or equal to 16 hours, greater than or equal to 4 hour and less than or equal to 16 hours, greater than or equal to 6 hour and less than or equal to 16 hours, greater than or equal to 8 hour and less than or equal to 16 hours, greater than or equal to 10 hour and less than or equal to 16 hours, greater than or equal to 12 hour and less than or equal to 16 hours, greater than or equal to 14 hour and less than or equal to 16 hours, greater than or equal to 1 hour and less than or equal to 14 hours, greater than or equal to 2 hour and less than or equal to 14 hours, greater than or equal to 4 hour and less than or equal to 14 hours, greater than or equal to 6 hour and less than or equal to 14 hours, greater than or equal to 8 hour and less than or equal to 14 hours, greater than or equal to 10 hour and less than or equal to 14 hours, greater than or equal to 12 hour and less than or equal to 14 hours, greater than or equal to 1 hour and less than or equal to 12 hours, greater than or equal to 2 hour and less than or equal to 12 hours, greater than or equal to 4 hour and less than or equal to 12 hours, greater than or equal to 6 hour and less than or equal to 12 hours, greater than or equal to 8 hour and less than or equal to 12 hours, greater than or equal to 10 hour and less than or equal to 12 hours, greater than or equal to 1 hour and less than or equal to 10 hours, greater than or equal to 2 hour and less than or equal to 10 hours, greater than or equal to 4 hour and less than or equal to 10 hours, greater than or equal to 6 hour and less than or equal to 10 hours, greater than or equal to 8 hour and less than or equal to 10 hours, greater than or equal to 1 hour and less than or equal to 8 hours, greater than or equal to 2 hour and less than or equal to 8 hours, greater than or equal to 4 hour and less than or equal to 8 hours, greater than or equal to 6 hour and less than or equal to 8 hours, greater than or equal to 1 hour and less than or equal to 6 hours, greater than or equal to 2 hour and less than or equal to 6 hours, greater than or equal to 4 hour and less than or equal to 6 hours, greater than or equal to 1 hour and less than or equal to 4 hours, greater than or equal to 2 hour and less than or equal to 4 hours, or greater than or equal to 1 hour and less than or equal to 2 hours. It should be understood that the above ranges include all subranges within the explicitly disclosed ranges.

After an ion exchange process is performed, it should be understood that a composition at the surface of the glass-ceramic may be different from the composition of the as-formed glass-ceramic (i.e., the glass-ceramic before it undergoes an ion exchange process). This results from one type of alkali metal ion in the as-formed glass-ceramic, such as, for example Li⁺ or Na⁺, being replaced with larger alkali metal ions, such as, for example Na⁺ or K⁺, respectively. However, in embodiments, the composition of the glass-ceramic at or near the center of the depth of the glass-ceramic may still have the composition of the as-formed glass-ceramic. In other embodiments, the composition of the glass-ceramic at or near the center of the depth of the glass-ceramic may be different from the composition of the as-formed glass-ceramic. As utilized herein, the center of the glass-ceramic article refers to any location in the glass-ceramic article that is a distance of at least 0.5 t from every surface thereof, where t is the thickness of the glass-ceramic or glass-ceramic article.

The mechanical properties of glass-ceramic articles disclosed herein are tested on strengthened glass-ceramic articles unless otherwise indicated. By forming a glass-ceramic having a composition as disclosed and described herein, using the heat treatments and chemical strengthening as disclosed and described herein, glass-ceramics with phase assemblages that provide controllable translucency and improved mechanical properties (as described in detail below) can be achieved. Even though described in separate paragraphs below, the various mechanical properties are present in combination in glass-ceramics of embodiments. The balance of these mechanical properties provide a durable, robust glass-ceramic that is difficult to achieve without sacrificing other mechanical properties. For instance, and as an example only, achieving high compressive stress alone is possible, but achieving high compressive stress and central tension can be more difficult.

In embodiments, DOC and DOC′ are individually 0.09 t and less than or equal to 0.30 t, greater than or equal to 0.15 t and less than or equal to 0.26 t, greater than or equal to 0.15 t and less than or equal to 0.25 t, greater than or equal to 0.16 t and less than or equal to 0.25 t, greater than or equal to 0.17 and less than or equal to 0.25 t, greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.15 t and less than or equal to 0.24 t, greater than or equal to 0.16 t and less than or equal to 0.24 t, greater than or equal to 0.17 and less than or equal to 0.24 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.15 t and less than or equal to 0.23 t, greater than or equal to 0.16 t and less than or equal to 0.23 t, greater than or equal to 0.17 and less than or equal to 0.23 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.15 t and less than or equal to 0.22 t, greater than or equal to 0.16 t and less than or equal to 0.22 t, greater than or equal to 0.17 and less than or equal to 0.22 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.15 t and less than or equal to 0.21 t, greater than or equal to 0.16 t and less than or equal to 0.21 t, greater than or equal to 0.17 and less than or equal to 0.21 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.15 t and less than or equal to 0.20 t, greater than or equal to 0.16 t and less than or equal to 0.20 t, greater than or equal to 0.17 and less than or equal to 0.20 t, greater than or equal to 0.18 t and less than or equal to 0.20 t, greater than or equal to 0.19 t and less than or equal to 0.20 t, greater than or equal to 0.15 t and less than or equal to 0.19 t, greater than or equal to 0.16 t and less than or equal to 0.19 t, greater than or equal to 0.17 and less than or equal to 0.19 t, greater than or equal to 0.18 t and less than or equal to 0.19 t, greater than or equal to 0.15 t and less than or equal to 0.18 t, greater than or equal to 0.16 t and less than or equal to 0.18 t, greater than or equal to 0.17 and less than or equal to 0.18 t, greater than or equal to 0.15 t and less than or equal to 0.17 t, greater than or equal to 0.16 t and less than or equal to 0.17 t, or greater than or equal to 0.15 t and less than or equal to 0.16 t.

Still referring to FIG. 2 and as noted herein, there is also a central tension region 110 under tensile stress in between DOC and DOC′. Accordingly, stress transitions from compressive stress to tensile stress at DOC and DOC′, which are described hereinabove, measured from a surface toward a centerline of the strengthened glass-ceramic article.

In embodiments, the glass-ceramic articles may have a surface compressive stress (CS) of greater than or equal to 150 MPa and less than or equal to 550 MPa, such as greater than or equal to 175 MPa and less than or equal to 550 MPa, greater than or equal to 200 MPa and less than or equal to 550 MPa, greater than or equal to 225 MPa and less than or equal to 550 MPa, greater than or equal to 250 MPa and less than or equal to 550 MPa, greater than or equal to 275 MPa and less than or equal to 550 MPa, greater than or equal to 300 MPa and less than or equal to 550 MPa, greater than or equal to 325 MPa and less than or equal to 550 MPa, greater than or equal to 350 MPa and less than or equal to 550 MPa, greater than or equal to 375 MPa and less than or equal to 550 MPa, greater than or equal to 150 MPa and less than or equal to 500 MPa, greater than or equal to 175 MPa and less than or equal to 500 MPa, greater than or equal to 200 MPa and less than or equal to 500 MPa, greater than or equal to 225 MPa and less than or equal to 500 MPa, greater than or equal to 250 MPa and less than or equal to 500 MPa, greater than or equal to 275 MPa and less than or equal to 500 MPa, greater than or equal to 300 MPa and less than or equal to 500 MPa, greater than or equal to 325 MPa and less than or equal to 500 MPa, greater than or equal to 350 MPa and less than or equal to 500 MPa, greater than or equal to 375 MPa and less than or equal to 500 MPa, greater than or equal to 150 MPa and less than or equal to 450 MPa, greater than or equal to 175 MPa and less than or equal to 450 MPa, greater than or equal to 200 MPa and less than or equal to 450 MPa, greater than or equal to 225 MPa and less than or equal to 450 MPa, greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 150 MPa and less than or equal to 400 MPa, greater than or equal to 175 MPa and less than or equal to 400 MPa, greater than or equal to 200 MPa and less than or equal to 400 MPa, greater than or equal to 225 MPa and less than or equal to 400 MPa, greater than or equal to 250 MPa and less than or equal to 400 MPa, greater than or equal to 275 MPa and less than or equal to 400 MPa, greater than or equal to 300 MPa and less than or equal to 400 MPa, greater than or equal to 325 MPa and less than or equal to 400 MPa, greater than or equal to 350 MPa and less than or equal to 400 MPa, greater than or equal to 375 MPa and less than or equal to 400 MPa, greater than or equal to 150 MPa and less than or equal to 375 MPa, greater than or equal to 175 MPa and less than or equal to 375 MPa, greater than or equal to 200 MPa and less than or equal to 375 MPa, greater than or equal to 225 MPa and less than or equal to 375 MPa, greater than or equal to 250 MPa and less than or equal to 375 MPa, greater than or equal to 275 MPa and less than or equal to 375 MPa, greater than or equal to 300 MPa and less than or equal to 375 MPa, greater than or equal to 325 MPa and less than or equal to 375 MPa, greater than or equal to 350 MPa and less than or equal to 375 MPa, greater than or equal to 150 MPa and less than or equal to 350 MPa, greater than or equal to 175 MPa and less than or equal to 350 MPa, greater than or equal to 200 MPa and less than or equal to 350 MPa, greater than or equal to 225 MPa and less than or equal to 350 MPa, greater than or equal to 250 MPa and less than or equal to 350 MPa, greater than or equal to 275 MPa and less than or equal to 350 MPa, greater than or equal to 300 MPa and less than or equal to 350 MPa, greater than or equal to 325 MPa and less than or equal to 350 MPa, greater than or equal to 150 MPa and less than or equal to 325 MPa, greater than or equal to 175 MPa and less than or equal to 325 MPa, greater than or equal to 200 MPa and less than or equal to 325 MPa, greater than or equal to 225 MPa and less than or equal to 325 MPa, greater than or equal to 250 MPa and less than or equal to 325 MPa, greater than or equal to 275 MPa and less than or equal to 325 MPa, greater than or equal to 300 MPa and less than or equal to 325 MPa, greater than or equal to 150 MPa and less than or equal to 300 MPa, greater than or equal to 175 MPa and less than or equal to 300 MPa, greater than or equal to 200 MPa and less than or equal to 300 MPa, greater than or equal to 225 MPa and less than or equal to 300 MPa, greater than or equal to 250 MPa and less than or equal to 300 MPa, greater than or equal to 275 MPa and less than or equal to 300 MPa, greater than or equal to 150 MPa and less than or equal to 275 MPa, greater than or equal to 175 MPa and less than or equal to 275 MPa, greater than or equal to 200 MPa and less than or equal to 275 MPa, greater than or equal to 225 MPa and less than or equal to 275 MPa, greater than or equal to 250 MPa and less than or equal to 275 MPa, greater than or equal to 150 MPa and less than or equal to 250 MPa, greater than or equal to 175 MPa and less than or equal to 250 MPa, greater than or equal to 200 MPa and less than or equal to 250 MPa, greater than or equal to 225 MPa and less than or equal to 250 MPa, greater than or equal to 150 MPa and less than or equal to 225 MPa, greater than or equal to 175 MPa and less than or equal to 225 MPa, or greater than or equal to 200 MPa and less than or equal to 225 MPa. It should be understood that the above ranges include all subranges within the explicitly disclosed ranges.

In embodiments, the maximum central tension (CT) is greater than or equal to 40 MPa, greater than or equal to 40 MPa and less than or equal to 170 MPa, greater than or equal to 50 MPa and less than or equal to 170 MPa, greater than or equal to 60 MPa and less than or equal to 170 MPa, greater than or equal to 70 MPa and less than or equal to 170 MPa, greater than or equal to 80 MPa and less than or equal to 170 MPa, greater than or equal to 90 MPa and less than or equal to 170 MPa, greater than or equal to 100 MPa and less than or equal to 170 MPa, greater than or equal to 110 MPa and less than or equal to 170 MPa, greater than or equal to 120 MPa and less than or equal to 170 MPa, greater than or equal to 130 MPa and less than or equal to 170 MPa, greater than or equal to 140 MPa and less than or equal to 170 MPa, greater than or equal to 150 MPa and less than or equal to 170 MPa, greater than or equal to 160 MPa and less than or equal to 170 MPa, greater than or equal to 40 MPa and less than or equal to 160 MPa, greater than or equal to 50 MPa and less than or equal to 160 MPa, greater than or equal to 60 MPa and less than or equal to 160 MPa, greater than or equal to 70 MPa and less than or equal to 160 MPa, greater than or equal to 80 MPa and less than or equal to 160 MPa, greater than or equal to 90 MPa and less than or equal to 160 MPa, greater than or equal to 100 MPa and less than or equal to 160 MPa, greater than or equal to 110 MPa and less than or equal to 160 MPa, greater than or equal to 120 MPa and less than or equal to 160 MPa, greater than or equal to 130 MPa and less than or equal to 160 MPa, greater than or equal to 140 MPa and less than or equal to 160 MPa, greater than or equal to 150 MPa and less than or equal to 160 MPa, greater than or equal to 40 MPa and less than or equal to 150 MPa, greater than or equal to 50 MPa and less than or equal to 150 MPa, greater than or equal to 60 MPa and less than or equal to 150 MPa, greater than or equal to 70 MPa and less than or equal to 150 MPa, greater than or equal to 80 MPa and less than or equal to 150 MPa, greater than or equal to 90 MPa and less than or equal to 150 MPa, greater than or equal to 100 MPa and less than or equal to 150 MPa, greater than or equal to 110 MPa and less than or equal to 150 MPa, greater than or equal to 120 MPa and less than or equal to 150 MPa, greater than or equal to 130 MPa and less than or equal to 150 MPa, greater than or equal to 140 MPa and less than or equal to 150 MPa, greater than or equal to 40 MPa and less than or equal to 140 MPa, greater than or equal to 50 MPa and less than or equal to 140 MPa, greater than or equal to 60 MPa and less than or equal to 140 MPa, greater than or equal to 70 MPa and less than or equal to 140 MPa, greater than or equal to 80 MPa and less than or equal to 140 MPa, greater than or equal to 90 MPa and less than or equal to 140 MPa, greater than or equal to 100 MPa and less than or equal to 140 MPa, greater than or equal to 110 MPa and less than or equal to 140 MPa, greater than or equal to 120 MPa and less than or equal to 140 MPa, greater than or equal to 130 MPa and less than or equal to 140 MPa, greater than or equal to 40 MPa and less than or equal to 130 MPa, greater than or equal to 50 MPa and less than or equal to 130 MPa, greater than or equal to 60 MPa and less than or equal to 130 MPa, greater than or equal to 70 MPa and less than or equal to 130 MPa, greater than or equal to 80 MPa and less than or equal to 130 MPa, greater than or equal to 90 MPa and less than or equal to 130 MPa, greater than or equal to 100 MPa and less than or equal to 130 MPa, greater than or equal to 110 MPa and less than or equal to 130 MPa, greater than or equal to 120 MPa and less than or equal to 130 MPa, greater than or equal to 40 MPa and less than or equal to 120 MPa, greater than or equal to 50 MPa and less than or equal to 120 MPa, greater than or equal to 60 MPa and less than or equal to 120 MPa, greater than or equal to 70 MPa and less than or equal to 120 MPa, greater than or equal to 80 MPa and less than or equal to 120 MPa, greater than or equal to 90 MPa and less than or equal to 120 MPa, greater than or equal to 100 MPa and less than or equal to 120 MPa, greater than or equal to 110 MPa and less than or equal to 120 MPa, greater than or equal to 40 MPa and less than or equal to 110 MPa, greater than or equal to 50 MPa and less than or equal to 110 MPa, greater than or equal to 60 MPa and less than or equal to 110 MPa, greater than or equal to 70 MPa and less than or equal to 110 MPa, greater than or equal to 80 MPa and less than or equal to 110 MPa, greater than or equal to 90 MPa and less than or equal to 110 MPa, or greater than or equal to 100 MPa and less than or equal to 110 MPa. It should be understood that the above ranges include all subranges within the explicitly disclosed ranges.

In embodiments, the glass-ceramics have a ratio of CS to CT (CS/CT) that is greater than or equal to 0.75 and less than or equal to 14.0, such as greater than or equal to 0.75 and less than or equal to 13.0, greater than or equal to 0.75 and less than or equal to 12.0, greater than or equal to 0.75 and less than or equal to 11.0, greater than or equal to 0.75 and less than or equal to 10.0, greater than or equal to 0.75 and less than or equal to 9.0, greater than or equal to 0.75 and less than or equal to 8.0, greater than or equal to 0.75 and less than or equal to 7.0, greater than or equal to 0.75 and less than or equal to 6.0, greater than or equal to 0.75 and less than or equal to 5.0, greater than or equal to 0.75 and less than or equal to 4.0, greater than or equal to 0.75 and less than or equal to 3.0, greater than or equal to 1.0 and less than or equal to 10.0, greater than or equal to 1.0 and less than or equal to 9.0, greater than or equal to 1.0 and less than or equal to 8.0, greater than or equal to 1.0 and less than or equal to 7.0, greater than or equal to 1.0 and less than or equal to 6.0, greater than or equal to 1.0 and less than or equal to 5.0, greater than or equal to 1.0 and less than or equal to 4.0, greater than or equal to 1.0 and less than or equal to 3.0, greater than or equal to 1.5 and less than or equal to 10.0, greater than or equal to 1.5 and less than or equal to 9.0, greater than or equal to 1.5 and less than or equal to 8.0, greater than or equal to 1.5 and less than or equal to 7.0, greater than or equal to 1.5 and less than or equal to 6.0, greater than or equal to 1.5 and less than or equal to 5.0, greater than or equal to 1.5 and less than or equal to 4.0, greater than or equal to 1.5 and less than or equal to 3.0, greater than or equal to 2.0 and less than or equal to 10.0, greater than or equal to 2.0 and less than or equal to 9.0, greater than or equal to 2.0 and less than or equal to 8.0, greater than or equal to 2.0 and less than or equal to 7.0, greater than or equal to 2.0 and less than or equal to 6.0, greater than or equal to 2.0 and less than or equal to 5.0, greater than or equal to 2.0 and less than or equal to 4.0, greater than equal to 2.0 and less than or equal to 3.0, greater than or equal to 1.5 and less than or equal to 3.0, greater than or equal to 1.8 and less than or equal to 3.0, greater than or equal to 2.0 and less than or equal to 3.0, greater than or equal to 2.2 and less than or equal to 3.0, greater than or equal to 2.5 and less than or equal to 3.0, greater than or equal to 2.8 and less than or equal to 3.0, greater than or equal to 1.5 and less than or equal to 2.8, such as greater than or equal to 1.8 and less than or equal to 2.8, greater than or equal to 2.0 and less than or equal to 2.8, greater than or equal to 2.2 and less than or equal to 2.8, greater than or equal to 2.5 and less than or equal to 2.8, greater than or equal to 1.5 and less than or equal to 2.5, such as greater than or equal to 1.8 and less than or equal to 2.5, greater than or equal to 2.0 and less than or equal to 2.5, greater than or equal to 2.2 and less than or equal to 2.5, greater than or equal to 1.5 and less than or equal to 2.2, such as greater than or equal to 1.8 and less than or equal to 2.2, greater than or equal to 2.0 and less than or equal to 2.2, greater than or equal to 1.5 and less than or equal to 2.0, such as greater than or equal to 1.8 and less than or equal to 2.0, or greater than or equal to 1.5 and less than or equal to 1.8. It should be understood that the above ranges include all subranges within the explicitly disclosed ranges.

Glass-ceramic articles according to embodiments have a stress that decreases with increasing distance from the surface of the glass article toward the centerline of the glass article, and the stress decreases as a substantially linear function from a depth that is greater than or equal to 0.07 t and less than or equal to 0.26 t, greater than or equal to 0.10 t and less than or equal to 0.26 t, greater than or equal to 0.12 t and less than or equal to 0.26 t, greater than or equal to 0.15 t and less than or equal to 0.26 t, greater than or equal to 0.17 t and less than or equal to 0.26 t, greater than or equal to 0.20 t and less than or equal to 0.26 t, greater than or equal to 0.22 t and less than or equal to 0.26 t, greater than or equal to 0.25 t and less than or equal to 0.26 t, greater than or equal to 0.07 t and less than or equal to 0.25 t, greater than or equal to 0.10 t and less than or equal to 0.25 t, greater than or equal to 0.12 t and less than or equal to 0.25 t, greater than or equal to 0.15 t and less than or equal to 0.25 t, greater than or equal to 0.17 t and less than or equal to 0.25 t, greater than or equal to 0.20 t and less than or equal to 0.25 t, greater than or equal to 0.22 t and less than or equal to 0.25 t, greater than or equal to 0.07 t and less than or equal to 0.22 t, greater than or equal to 0.10 t and less than or equal to 0.22 t, greater than or equal to 0.12 t and less than or equal to 0.22 t, greater than or equal to 0.15 t and less than or equal to 0.22 t, greater than or equal to 0.17 t and less than or equal to 0.22 t, greater than or equal to 0.20 t and less than or equal to 0.22 t, greater than or equal to 0.07 t and less than or equal to 0.20 t, greater than or equal to 0.10 t and less than or equal to 0.20 t, greater than or equal to 0.12 t and less than or equal to 0.20 t, greater than or equal to 0.15 t and less than or equal to 0.20 t, greater than or equal to 0.17 t and less than or equal to 0.20 t, greater than or equal to 0.07 t and less than or equal to 0.17 t, greater than or equal to 0.10 t and less than or equal to 0.17 t, greater than or equal to 0.12 t and less than or equal to 0.17 t, greater than or equal to 0.15 t and less than or equal to 0.17 t, greater than or equal to 0.07 t and less than or equal to 0.15 t, greater than or equal to 0.10 t and less than or equal to 0.15 t, greater than or equal to 0.12 t and less than or equal to 0.15 t, greater than or equal to 0.07 t and less than or equal to 0.12 t, greater than or equal to 0.10 t and less than or equal to 0.12 t, or greater than or equal to 0.07 t and less than or equal to 0.10 t. It should be understood that the above ranges include all subranges within the explicitly disclosed ranges.

According to embodiments, the stress in the glass-ceramic article transitions from compressive stress to tensile stress at a depth measured from a surface of the class-ceramic article toward the centerline of the glass-ceramic article that is greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.18 t and less than or equal to 0.20 t, greater than or equal to 0.19 t and less than or equal to 0.20 t, or greater than or equal to 0.18 t and less than or equal to 0.19 t. It should be understood that the above ranges include all subranges within the explicitly disclosed ranges.

According to embodiments, the glass-ceramic article has a maximum central tension (mCT) and the absolute value of the surface compressive stress measured at a surface of the glass-ceramic article is greater than or equal to 1.5 mCT and less than or equal to 2.5 mCT, greater than or equal to 1.7 mCT and less than or equal to 2.5 mCT, greater than or equal to 2.0 mCT and less than or equal to 2.5 mCT, greater than or equal to 2.2 mCT and less than or equal to 2.5 mCT, greater than or equal to 1.5 mCT and less than or equal to 2.2 mCT, greater than or equal to 1.7 mCT and less than or equal to 2.2 mCT, greater than or equal to 2.0 mCT and less than or equal to 2.2 mCT, greater than or equal to 1.5 mCT and less than or equal to 2.0 mCT, greater than or equal to 1.7 mCT and less than or equal to 2.0 mCT, or greater than or equal to 1.5 mCT and less than or equal to 1.7 mCT. It should be understood that the above ranges include all subranges within the explicitly disclosed ranges.

In embodiments, the stored strain energy of the glass-ceramic article is greater than or equal to 22 J/m² and less than or equal to 60 J/m², such as greater than or equal to 25 J/m² and less than or equal to 60 J/m², greater than or equal to 30 J/m² and less than or equal to 60 J/m², greater than or equal to 35 J/m² and less than or equal to 60 J/m², greater than or equal to 40 J/m² and less than or equal to 60 J/m², greater than or equal to 45 J/m² and less than or equal to 60 J/m², greater than or equal to 50 J/m² and less than or equal to 60 J/m², greater than or equal to 55 J/m² and less than or equal to 60 J/m², greater than or equal to 22 J/m² and less than or equal to 55 J/m², such as greater than or equal to 25 J/m² and less than or equal to 55 J/m², greater than or equal to 30 J/m² and less than or equal to 55 J/m², greater than or equal to 35 J/m² and less than or equal to 55 J/m², greater than or equal to 40 J/m² and less than or equal to 55 J/m², greater than or equal to 45 J/m² and less than or equal to 55 J/m², greater than or equal to 50 J/m² and less than or equal to 55 J/m², greater than or equal to 22 J/m² and less than or equal to 50 J/m², such as greater than or equal to 25 J/m² and less than or equal to 50 J/m², greater than or equal to 30 J/m² and less than or equal to 50 J/m², greater than or equal to 35 J/m² and less than or equal to 50 J/m², greater than or equal to 40 J/m² and less than or equal to 50 J/m², greater than or equal to 45 J/m² and less than or equal to 50 J/m², greater than or equal to 22 J/m² and less than or equal to 45 J/m², such as greater than or equal to 25 J/m² and less than or equal to 45 J/m², greater than or equal to 30 J/m² and less than or equal to 45 J/m², greater than or equal to 35 J/m² and less than or equal to 45 J/m², greater than or equal to 40 J/m² and less than or equal to 45 J/m², greater than or equal to 22 J/m² and less than or equal to 40 J/m², such as greater than or equal to 25 J/m² and less than or equal to 40 J/m², greater than or equal to 30 J/m² and less than or equal to 40 J/m², greater than or equal to 35 J/m² and less than or equal to 40 J/m², greater than or equal to 22 J/m² and less than or equal to 35 J/m², such as greater than or equal to 25 J/m² and less than or equal to 35 J/m², greater than or equal to 30 J/m² and less than or equal to 35 J/m², greater than or equal to 22 J/m² and less than or equal to 30 J/m², such as greater than or equal to 25 J/m² and less than or equal to 30 J/m², or greater than or equal to 22 J/m² and less than or equal to 25 J/m². It should be understood that the above ranges include all subranges within the explicitly disclosed ranges. The glass-ceramic achieves the aforementioned stored strain energy with no bifurcation in crack pattern.

In embodiments, the glass-ceramic article has a thickness t that is greater than or equal to 0.25 mm and less than or equal to 5.0 mm, greater than or equal to 0.3 mm and less than or equal to 5.0 mm, greater than or equal to 0.5 mm and less than or equal to 5.0 mm, greater than or equal to 0.8 mm and less than or equal to 5.0 mm, greater than or equal to 1.0 mm and less than or equal to 5.0 mm, greater than or equal to 1.3 mm and less than or equal to 5.0 mm, greater than or equal to 1.5 mm and less than or equal to 5.0 mm, greater than or equal to 1.8 mm and less than or equal to 5.0 mm, greater than or equal to 0.25 mm and less than or equal to 4.0 mm, greater than or equal to 0.3 mm and less than or equal to 4.0 mm, greater than or equal to 0.5 mm and less than or equal to 4.0 mm, greater than or equal to 0.8 mm and less than or equal to 4.0 mm, greater than or equal to 1.0 mm and less than or equal to 4.0 mm, greater than or equal to 1.3 mm and less than or equal to 4.0 mm, greater than or equal to 1.5 mm and less than or equal to 4.0 mm, greater than or equal to 1.8 mm and less than or equal to 4.0 mm, greater than or equal to 0.25 mm and less than or equal to 3.0 mm, greater than or equal to 0.3 mm and less than or equal to 3.0 mm, greater than or equal to 0.5 mm and less than or equal to 3.0 mm, greater than or equal to 0.8 mm and less than or equal to 3.0 mm, greater than or equal to 1.0 mm and less than or equal to 3.0 mm, greater than or equal to 1.3 mm and less than or equal to 3.0 mm, greater than or equal to 1.5 mm and less than or equal to 3.0 mm, greater than or equal to 1.8 mm and less than or equal to 3.0 mm, greater than or equal to 0.25 mm and less than or equal to 2.0 mm, greater than or equal to 0.3 mm and less than or equal to 2.0 mm, greater than or equal to 0.5 mm and less than or equal to 2.0 mm, greater than or equal to 0.8 mm and less than or equal to 2.0 mm, greater than or equal to 1.0 mm and less than or equal to 2.0 mm, greater than or equal to 1.3 mm and less than or equal to 2.0 mm, greater than or equal to 1.5 mm and less than or equal to 2.0 mm, greater than or equal to 1.8 mm and less than or equal to 2.0 mm, greater than or equal to 0.25 mm and less than or equal to 1.8 mm, greater than or equal to 0.3 mm and less than or equal to 1.8 mm, greater than or equal to 0.5 mm and less than or equal to 1.8 mm, greater than or equal to 0.8 mm and less than or equal to 1.8 mm, greater than or equal to 1.0 mm and less than or equal to 1.8 mm, greater than or equal to 1.3 mm and less than or equal to 1.8 mm, greater than or equal to 1.5 mm and less than or equal to 1.8 mm, greater than or equal to 0.25 mm and less than or equal to 1.5 mm, greater than or equal to 0.3 mm and less than or equal to 1.5 mm, greater than or equal to 0.5 mm and less than or equal to 1.5 mm, greater than or equal to 0.8 mm and less than or equal to 1.5 mm, greater than or equal to 1.0 mm and less than or equal to 1.5 mm, greater than or equal to 1.3 mm and less than or equal to 1.5 mm, greater than or equal to 0.25 mm and less than or equal to 1.3 mm, greater than or equal to 0.3 mm and less than or equal to 1.3 mm, greater than or equal to 0.5 mm and less than or equal to 1.3 mm, greater than or equal to 0.8 mm and less than or equal to 1.3 mm, greater than or equal to 1.0 mm and less than or equal to 1.3 mm, greater than or equal to 0.25 mm and less than or equal to 1.0 mm, greater than or equal to 0.3 mm and less than or equal to 1.0 mm, greater than or equal to 0.5 mm and less than or equal to 1.0 mm, greater than or equal to 0.8 mm and less than or equal to 1.0 mm, greater than or equal to 0.25 mm and less than or equal to 0.8 mm, greater than or equal to 0.3 mm and less than or equal to 0.8 mm, greater than or equal to 0.5 mm and less than or equal to 0.8 mm, greater than or equal to 0.25 mm and less than or equal to 0.5 mm, greater than or equal to 0.3 mm and less than or equal to 0.6 mm, greater than or equal to 0.3 mm and less than or equal to 0.5 mm, or greater than or equal to 0.25 mm and less than or equal to 0.3 mm. It should be understood that the above ranges include all subranges within the explicitly disclosed ranges.

In embodiments, the glass-ceramic article may be substantially planar and flat. In other embodiments, the glass-ceramic article may be shaped, for example it may have a 2.5D or 3D shape. In embodiments, the glass-ceramic article may have a uniform thickness and in other embodiments, the glass-ceramic article may not have a uniform thickness.

In embodiments, the fracture toughness of the glass-ceramic article is greater than or equal to 1.0 MPa√m and less than or equal to 2.4 MPa√m, greater than or equal to 1.0 MPa√m and less than or equal to 2.0 MPa√m, greater than or equal to 1.2 MPa√m and less than or equal to 2.0 MPa√m, greater than or equal to 1.4 MPa√m and less than or equal to 2.0 MPa√m, greater than or equal to 1.5 MPa√m and less than or equal to 2.0 MPa√m, greater than or equal to 1.6 MPa√m and less than or equal to 2.0 MPa√m, greater than or equal to 1.8 MPa√m and less than or equal to 2.0 MPa√m, greater than or equal to 1.0 MPa√m and less than or equal to 1.8 MPa√m, greater than or equal to 1.2 MPa√m and less than or equal to 1.8 MPa√m, greater than or equal to 1.4 MPa√m and less than or equal to 1.8 MPa√m, greater than or equal to 1.5 MPa√m and less than or equal to 1.8 MPa√m, greater than or equal to 1.6 MPa√m and less than or equal to 1.8 MPa√m, greater than or equal to 1.0 MPa√m and less than or equal to 1.6 MPa√m, greater than or equal to 1.2 MPa√m and less than or equal to 1.6 MPa√m, greater than or equal to 1.4 MPa√m and less than or equal to 1.6 MPa√m, greater than or equal to 1.5 MPa√m and less than or equal to 1.6 MPa√m, greater than or equal to 1.0 MPa√m and less than or equal to 1.5 MPa√m, greater than or equal to 1.2 MPa√m and less than or equal to 1.5 MPa√m, greater than or equal to 1.4 MPa√m and less than or equal to 1.5 MPa√m, greater than or equal to 1.0 MPa√m and less than or equal to 1.4 MPa√m, greater than or equal to 1.2 MPa√m and less than or equal to 1.4 MPa√m, or greater than or equal to 1.0 MPa√m and less than or equal to 1.2 MPa√m. It should be understood that the above ranges include all subranges within the explicitly disclosed ranges.

In embodiments, the Young's modulus (also referred to as elastic modulus) of the non-chemically strengthened glass-ceramic article is greater than or equal to 90 GPa and less than or equal to 200 GPa, such as greater than or equal to 100 GPa and less than or equal to 200 GPa, greater than or equal to 120 GPa and less than or equal to 200 GPa, greater than or equal to 140 GPa and less than or equal to 200 GPa, greater than or equal to 160 GPa and less than or equal to 200 GPa, greater than or equal to 180 GPa and less than or equal to 200 GPa, greater than or equal to 90 GPa and less than or equal to 180 GPa, such as greater than or equal to 100 GPa and less than or equal to 180 GPa, greater than or equal to 120 GPa and less than or equal to 180 GPa, greater than or equal to 140 GPa and less than or equal to 180 GPa, greater than or equal to 160 GPa and less than or equal to 180 GPa, greater than or equal to 90 GPa and less than or equal to 160 GPa, such as greater than or equal to 100 GPa and less than or equal to 160 GPa, greater than or equal to 120 GPa and less than or equal to 160 GPa, greater than or equal to 140 GPa and less than or equal to 160 GPa, greater than or equal to 90 GPa and less than or equal to 140 GPa, such as greater than or equal to 100 GPa and less than or equal to 140 GPa, greater than or equal to 120 GPa and less than or equal to 140 GPa, greater than or equal to 90 GPa and less than or equal to 120 GPa, such as greater than or equal to 100 GPa and less than or equal to 120 GPa, or greater than or equal to 90 GPa and less than or equal to 100 GPa. It should be understood that the above ranges include all subranges within the explicitly disclosed ranges.

In embodiments, the non-chemically strengthened glass-ceramic articles have a Poisson's ratio that is greater than or equal to 0.15 and less than or equal to 0.25, greater than or equal to 0.17 and less than or equal to 0.25, greater than or equal to 0.20 and less than or equal to 0.25, greater than or equal to 0.22 and less than or equal to 0.25, greater than or equal to 0.15 and less than or equal to 0.22, greater than or equal to 0.17 and less than or equal to 0.22, greater than or equal to 0.20 and less than or equal to 0.22, greater than or equal to 0.15 and less than or equal to 0.20, greater than or equal to 0.17 and less than or equal to 0.20, or greater than or equal to 0.15 and less than or equal to 0.17. It should be understood that the above ranges include all subranges within the explicitly disclosed ranges.

In embodiments, the non-chemically strengthened glass-ceramic articles have a shear modulus that is greater than or equal to 40 GPa and less than or equal to 50 GPa, greater than or equal to 43 GPa and less than or equal to 50 GPa, greater than or equal to 45 GPa and less than or equal to 50 GPa, greater than or equal to 48 GPa and less than or equal to 50 GPa, greater than or equal to 40 GPa and less than or equal to 48 GPa, greater than or equal to 43 GPa and less than or equal to 48 GPa, greater than or equal to 45 GPa and less than or equal to 48 GPa, greater than or equal to 40 GPa and less than or equal to 45 GPa, greater than or equal to 43 GPa and less than or equal to 45 GPa, or greater than or equal to 40 GPa and less than or equal to 43 GPa. It should be understood that the above ranges include all subranges within the explicitly disclosed ranges.

The fracture strength of the glass-ceramic articles may be measured by applied fracture stress to failure with a 4 point bending test after introducing about 80 m deep flaws using sand paper impact via an 1000 grit, 180 grit, and 80 grit slapper. Testing is performed using an apparatus comprising a simple pendulum-based dynamic impact test having a surface ranging from flat to curved, where the glass-ceramic article test specimen is mounted to a bob of a pendulum, which is then used to cause the test specimen to contact a roughened impact surface. The apparatus is described in detail in International Application Publication No. WO2017/100646, which is hereby incorporated by reference in its entirety. To perform the test, the sample is loaded on the holder and then pulled backwards from the pendulum equilibrium position and released to make a dynamic impact on the impact surface.

The fracture strength of the glass-ceramic according to embodiments measured on a glass-ceramic article having a thickness of 0.6 mm using 1000 grit is greater than or equal to 450 MPa and less than or equal to 550 MPa, greater than or equal to 475 MPa and less than or equal to 550 MPa, greater than or equal to 500 MPa and less than or equal to 550 MPa, greater than or equal to 525 MPa and less than or equal to 550 MPa, greater than or equal to 450 MPa and less than or equal to 525 MPa, greater than or equal to 475 MPa and less than or equal to 525 MPa, greater than or equal to 500 MPa and less than or equal to 525 MPa, greater than or equal to 450 MPa and less than or equal to 500 MPa, greater than or equal to 475 MPa and less than or equal to 500 MPa, or greater than or equal to 450 MPa and less than or equal to 475 MPa. It should be understood that the above ranges include all subranges within the explicitly disclosed ranges.

The fracture strength of the glass-ceramic according to embodiments measured on a glass-ceramic article having a thickness of 0.5 mm using 1000 grit is greater than or equal to 475 MPa and less than or equal to 550 MPa, greater than or equal to 500 MPa and less than or equal to 550 MPa, greater than or equal to 525 MPa and less than or equal to 550 MPa, greater than or equal to 475 MPa and less than or equal to 525 MPa, greater than or equal to 500 MPa and less than or equal to 525 MPa, or greater than or equal to 475 MPa and less than or equal to 500 MPa, It should be understood that the above ranges include all subranges within the explicitly disclosed ranges.

The fracture strength of the glass-ceramic according to embodiments measured on a glass-ceramic article having a thickness of 0.6 mm using 180 grit is greater than or equal to 400 MPa and less than or equal to 500 MPa, greater than or equal to 425 MPa and less than or equal to 500 MPa, greater than or equal to 450 MPa and less than or equal to 500 MPa, greater than or equal to 475 MPa and less than or equal to 500 MPa, greater than or equal to 400 MPa and less than or equal to 475 MPa, greater than or equal to 425 MPa and less than or equal to 475 MPa, greater than or equal to 450 MPa and less than or equal to 475 MPa, greater than or equal to 400 MPa and less than or equal to 450 MPa, greater than or equal to 425 MPa and less than or equal to 450 MPa, or greater than or equal to 400 MPa and less than or equal to 425 MPa. It should be understood that the above ranges include all subranges within the explicitly disclosed ranges.

The fracture strength of the glass-ceramic according to embodiments measured on a glass-ceramic article having a thickness of 0.5 mm using 180 grit is greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 350 MPa and less than or equal to 425 MPa, greater than or equal to 375 MPa and less than or equal to 425 MPa, greater than or equal to 400 MPa and less than or equal to 425 MPa, greater than or equal to 350 MPa and less than or equal to 400 MPa, greater than or equal to 375 MPa and less than or equal to 400 MPa, or greater than or equal to 350 MPa and less than or equal to 375 MPa. It should be understood that the above ranges include all subranges within the explicitly disclosed ranges.

The fracture strength of the glass-ceramic according to embodiments measured on a glass-ceramic article having a thickness of 0.6 mm using 80 grit is greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 350 MPa and less than or equal to 425 MPa, greater than or equal to 375 MPa and less than or equal to 425 MPa, greater than or equal to 400 MPa and less than or equal to 425 MPa, greater than or equal to 350 MPa and less than or equal to 400 MPa, greater than or equal to 375 MPa and less than or equal to 400 MPa, or greater than or equal to 350 MPa and less than or equal to 375 MPa. It should be understood that the above ranges include all subranges within the explicitly disclosed ranges.

The fracture strength of the glass-ceramic according to embodiments measured on a glass-ceramic article having a thickness of 0.5 mm using 80 grit is greater than or equal to 300 MPa and less than or equal to 400 MPa, greater than or equal to 325 MPa and less than or equal to 400 MPa, greater than or equal to 350 MPa and less than or equal to 400 MPa, greater than or equal to 375 MPa and less than or equal to 400 MPa, greater than or equal to 300 MPa and less than or equal to 375 MPa, greater than or equal to 325 MPa and less than or equal to 375 MPa, greater than or equal to 350 MPa and less than or equal to 375 MPa, greater than or equal to 300 MPa and less than or equal to 350 MPa, greater than or equal to 325 MPa and less than or equal to 350 MPa, or greater than or equal to 300 MPa and less than or equal to 325 MPa. It should be understood that the above ranges include all subranges within the explicitly disclosed ranges.

A Drop Test Method may be used to determine the failure height of the glass-ceramic articles described herein. The Drop Test Method involves performing face-drop testing on a puck with a glass-ceramic article attached thereto. The face-drop testing is repeated at increasing heights until the glass-ceramic article fails (i.e., cracks). The failure height is the lowest height from which the puck including the glass-ceramic article is dropped and the glass-ceramic fails. The glass-ceramic article to be tested has a thickness similar or equal to the thickness that will be used in a given hand-held consumer electronic device. A puck refers to a structure meant to mimic the size, shape, and weight distribution of a given device, such as a cell phone. Hereinafter, the term “puck,” refers to a structure that has a weight of 126.0 grams, a length of 133.1 mm, a width of 68.2 mm, and a height of 9.4 mm. The Drop Test Method and an exemplary device-drop machine that may be used to conduct the Drop Test Method is described in detail in U.S. Patent Application Publication No. 2023/0150869, which is hereby incorporated by reference in its entirety.

In embodiments the failure height (referred to as “drop strength” in US 2023/0150869) of a 0.6 mm thick glass-ceramic article is greater than or equal to 190 cm and less than or equal to 250 cm, greater than or equal to 200 cm and less than or equal to 250 cm, greater than or equal to 210 cm and less than or equal to 250 cm, greater than or equal to 220 cm and less than or equal to 250 cm, greater than or equal to 230 cm and less than or equal to 250 cm, greater than or equal to 240 cm and less than or equal to 250 cm, greater than or equal to 190 cm and less than or equal to 240 cm, greater than or equal to 200 cm and less than or equal to 240 cm, greater than or equal to 210 cm and less than or equal to 240 cm, greater than or equal to 220 cm and less than or equal to 240 cm, greater than or equal to 230 cm and less than or equal to 240 cm, greater than or equal to 190 cm and less than or equal to 230 cm, greater than or equal to 200 cm and less than or equal to 230 cm, greater than or equal to 210 cm and less than or equal to 230 cm, greater than or equal to 220 cm and less than or equal to 230 cm, greater than or equal to 190 cm and less than or equal to 220 cm, greater than or equal to 200 cm and less than or equal to 220 cm, greater than or equal to 210 cm and less than or equal to 220 cm, greater than or equal to 190 cm and less than or equal to 210 cm, greater than or equal to 200 cm and less than or equal to 210 cm, or greater than or equal to 190 cm and less than or equal to 200 cm. It should be understood that the above ranges include all subranges within the explicitly disclosed ranges.

In embodiments the failure height of a 0.5 mm thick glass-ceramic article is greater than or equal to 180 cm and less than or equal to 240 cm, greater than or equal to 190 cm and less than or equal to 240 cm, greater than or equal to 200 cm and less than or equal to 240 cm, greater than or equal to 210 cm and less than or equal to 240 cm, greater than or equal to 220 cm and less than or equal to 240 cm, greater than or equal to 230 cm and less than or equal to 240 cm, greater than or equal to 180 cm and less than or equal to 230 cm, greater than or equal to 190 cm and less than or equal to 230 cm, greater than or equal to 200 cm and less than or equal to 230 cm, greater than or equal to 210 cm and less than or equal to 230 cm, greater than or equal to 220 cm and less than or equal to 230 cm, greater than or equal to 180 cm and less than or equal to 220 cm, greater than or equal to 190 cm and less than or equal to 220 cm, greater than or equal to 200 cm and less than or equal to 220 cm, greater than or equal to 210 cm and less than or equal to 220 cm, greater than or equal to 180 cm and less than or equal to 210 cm, greater than or equal to 190 cm and less than or equal to 210 cm, greater than or equal to 200 cm and less than or equal to 210 cm, greater than or equal to 180 cm and less than or equal to 200 cm, greater than or equal to 190 cm and less than or equal to 200 cm, or greater than or equal to 180 cm and less than or equal to 190 cm. It should be understood that the above ranges include all subranges within the explicitly disclosed ranges.

Non-strengthened glass-ceramics according to embodiments disclosed and described herein are also scratch resistant and have an onset load for lateral cracking that is greater than or equal to 0.50 Newtons (N) and less than or equal to 0.75 N, such as greater than or equal to 0.55 N and less than or equal to 0.75 N, greater than or equal to 0.60 N and less than or equal to 0.75 N, greater than or equal to 0.65 N and less than or equal to 0.75 N, greater than or equal to 0.70 N and less than or equal to 0.75 N, greater than or equal to 0.50 N and less than or equal to 0.70 N, greater than or equal to 0.55 N and less than or equal to 0.70 N, greater than or equal to 0.60 N and less than or equal to 0.70 N, greater than or equal to 0.65 N and less than or equal to 0.70 N, greater than or equal to 0.50 N and less than or equal to 0.65 N, greater than or equal to 0.55 N and less than or equal to 0.65 N, greater than or equal to 0.60 N and less than or equal to 0.65 N, greater than or equal to 0.50 N and less than or equal to 0.60 N, greater than or equal to 0.55 N and less than or equal to 0.60 N, or greater than or equal to 0.50 N and less than or equal to 0.55 N. It should be understood that the above ranges include all subranges within the explicitly disclosed ranges.

Glass-ceramics according to embodiments have a Vickers Hardness (at 200 g load) measured on an unstrengthened glass-ceramic that is greater than or equal to 740 Kg_{f}/mm² and less than or equal to 820 Kg_{f}/mm², such as greater than or equal to 760 Kg_{f}/mm² and less than or equal to 820 Kg_{f}/mm², greater than or equal to 780 Kg_{f}/mm² and less than or equal to 820 Kg_{f}/mm², greater than or equal to 800 Kg_{f}/mm² and less than or equal to 820 Kg_{f}/mm², greater than or equal to 740 Kg_{f}/mm² and less than or equal to 800 Kg_{f}/mm², such as greater than or equal to 760 Kg_{f}/mm² and less than or equal to 800 Kg_{f}/mm², greater than or equal to 780 Kg_{f}/mm² and less than or equal to 800 Kg_{f}/mm², greater than or equal to 740 Kg_{f}/mm² and less than or equal to 780 Kg_{f}/mm², such as greater than or equal to 760 Kg_{f}/mm² and less than or equal to 780 Kg_{f}/mm², or greater than or equal to 740 Kg_{f}/mm² and less than or equal to 760 Kg_{f}/mm². It should be understood that the above ranges include all subranges within the explicitly disclosed ranges.

Embodiments of glass-ceramics have an annealing point that is greater than or equal to 740° C. and less than or equal to 770° C., greater than or equal to 750° C. and less than or equal to 770° C., greater than or equal to 755° C. and less than or equal to 770° C., greater than or equal to 760° C. and less than or equal to 770° C., greater than or equal to 765° C. and less than or equal to 770° C., greater than or equal to 740° C. and less than or equal to 765° C., greater than or equal to 750° C. and less than or equal to 765° C., greater than or equal to 755° C. and less than or equal to 765° C., greater than or equal to 760° C. and less than or equal to 765° C., greater than or equal to 740° C. and less than or equal to 760° C., greater than or equal to 750° C. and less than or equal to 760° C., greater than or equal to 755° C. and less than or equal to 760° C., or greater than or equal to 750° C. and less than or equal to 755° C. It should be understood that the above ranges include all subranges within the explicitly disclosed ranges.

Glass-ceramics according to embodiments have a strain point that is greater than or equal to 700° C. and less than or equal to 750° C., greater than or equal to 710° C. and less than or equal to 750° C., greater than or equal to 720° C. and less than or equal to 750° C., greater than or equal to 725° C. and less than or equal to 750° C., greater than or equal to 730° C. and less than or equal to 750° C., greater than or equal to 740° C. and less than or equal to 750° C., greater than or equal to 700° C. and less than or equal to 740° C., greater than or equal to 710° C. and less than or equal to 740° C., greater than or equal to 720° C. and less than or equal to 740° C., greater than or equal to 725° C. and less than or equal to 740° C., greater than or equal to 730° C. and less than or equal to 740° C., greater than or equal to 700° C. and less than or equal to 730° C., greater than or equal to 710° C. and less than or equal to 730° C., greater than or equal to 720° C. and less than or equal to 730° C., greater than or equal to 725° C. and less than or equal to 730° C., greater than or equal to 700° C. and less than or equal to 725° C., greater than or equal to 710° C. and less than or equal to 725° C., greater than or equal to 720° C. and less than or equal to 725° C., greater than or equal to 700° C. and less than or equal to 720° C., greater than or equal to 710° C. and less than or equal to 720° C., or greater than or equal to 700° C. and less than or equal to 710° C. It should be understood that the above ranges include all subranges within the explicitly disclosed ranges.

According to embodiments, glass-ceramics have a refraction index (measured at wavelengths of 598 nm) that is greater than or equal to 1.500 and less than or equal to 1.600, greater than or equal to 1.520 and less than or equal to 1.600, greater than or equal to 1.540 and less than or equal to 1.600, greater than or equal to 1.550 and less than or equal to 1.600, greater than or equal to 1.560 and less than or equal to 1.600, greater than or equal to 1.580 and less than or equal to 1.600, greater than or equal to 1.500 and less than or equal to 1.580, greater than or equal to 1.520 and less than or equal to 1.580, greater than or equal to 1.540 and less than or equal to 1.580, greater than or equal to 1.550 and less than or equal to 1.580, greater than or equal to 1.560 and less than or equal to 1.580, greater than or equal to 1.500 and less than or equal to 1.560, greater than or equal to 1.520 and less than or equal to 1.560, greater than or equal to 1.540 and less than or equal to 1.560, greater than or equal to 1.550 and less than or equal to 1.560, greater than or equal to 1.500 and less than or equal to 1.550, greater than or equal to 1.520 and less than or equal to 1.550, greater than or equal to 1.540 and less than or equal to 1.550, greater than or equal to 1.500 and less than or equal to 1.540, greater than or equal to 1.520 and less than or equal to 1.540, or greater than or equal to 1.500 and less than or equal to 1.520. It should be understood that the above ranges include all subranges within the explicitly disclosed ranges.

The stress optical coefficient (measured at a wavelength of 546 nm) of glass-ceramics according to embodiments is greater than or equal to 25.5 nm/cm/MPa and less than or equal to 26.5 nm/cm/MPa, greater than or equal to 25.8 nm/cm/MPa and less than or equal to 26.5 nm/cm/MPa, greater than or equal to 26.0 nm/cm/MPa and less than or equal to 26.5 nm/cm/MPa, greater than or equal to 26.2 nm/cm/MPa and less than or equal to 26.5 nm/cm/MPa, greater than or equal to 26.4 nm/cm/MPa and less than or equal to 26.5 nm/cm/MPa, greater than or equal to 25.5 nm/cm/MPa and less than or equal to 26.4 nm/cm/MPa, greater than or equal to 25.8 nm/cm/MPa and less than or equal to 26.4 nm/cm/MPa, greater than or equal to 26.0 nm/cm/MPa and less than or equal to 26.4 nm/cm/MPa, greater than or equal to 26.2 nm/cm/MPa and less than or equal to 26.4 nm/cm/MPa, greater than or equal to 25.5 nm/cm/MPa and less than or equal to 26.2 nm/cm/MPa, greater than or equal to 25.8 nm/cm/MPa and less than or equal to 26.2 nm/cm/MPa, greater than or equal to 26.0 nm/cm/MPa and less than or equal to 26.2 nm/cm/MPa, greater than or equal to 25.5 nm/cm/MPa and less than or equal to 26.0 nm/cm/MPa, greater than or equal to 25.8 nm/cm/MPa and less than or equal to 26.0 nm/cm/MPa, or greater than or equal to 25.5 nm/cm/MPa and less than or equal to 25.8 nm/cm/MPa. It should be understood that the above ranges include all subranges within the explicitly disclosed ranges.

According to embodiments, the glass-ceramics have a density that is greater than or equal to 2.40 g/cm³ and less than or equal to 2.60 g/cm³, greater than or equal to 2.42 g/cm³ and less than or equal to 2.60 g/cm³, greater than or equal to 2.45 g/cm³ and less than or equal to 2.60 g/cm³, greater than or equal to 2.48 g/cm³ and less than or equal to 2.60 g/cm³, greater than or equal to 2.50 g/cm³ and less than or equal to 2.60 g/cm³, greater than or equal to 2.52 g/cm³ and less than or equal to 2.60 g/cm³, greater than or equal to 2.55 g/cm³ and less than or equal to 2.60 g/cm³, greater than or equal to 2.58 g/cm³ and less than or equal to 2.60 g/cm³, greater than or equal to 2.40 g/cm³ and less than or equal to 2.58 g/cm³, greater than or equal to 2.42 g/cm³ and less than or equal to 2.58 g/cm³, greater than or equal to 2.45 g/cm³ and less than or equal to 2.58 g/cm³, greater than or equal to 2.48 g/cm³ and less than or equal to 2.58 g/cm³, greater than or equal to 2.50 g/cm³ and less than or equal to 2.58 g/cm³, greater than or equal to 2.52 g/cm³ and less than or equal to 2.58 g/cm³, greater than or equal to 2.55 g/cm³ and less than or equal to 2.58 g/cm³, greater than or equal to 2.40 g/cm³ and less than or equal to 2.55 g/cm³, greater than or equal to 2.42 g/cm³ and less than or equal to 2.55 g/cm³, greater than or equal to 2.45 g/cm³ and less than or equal to 2.55 g/cm³, greater than or equal to 2.48 g/cm³ and less than or equal to 2.55 g/cm³, greater than or equal to 2.50 g/cm³ and less than or equal to 2.55 g/cm³, greater than or equal to 2.52 g/cm³ and less than or equal to 2.55 g/cm³, greater than or equal to 2.40 g/cm³ and less than or equal to 2.52 g/cm³, greater than or equal to 2.42 g/cm³ and less than or equal to 2.52 g/cm³, greater than or equal to 2.45 g/cm³ and less than or equal to 2.52 g/cm³, greater than or equal to 2.48 g/cm³ and less than or equal to 2.52 g/cm³, greater than or equal to 2.50 g/cm³ and less than or equal to 2.52 g/cm³, greater than or equal to 2.40 g/cm³ and less than or equal to 2.50 g/cm³, greater than or equal to 2.42 g/cm³ and less than or equal to 2.50 g/cm³, greater than or equal to 2.45 g/cm³ and less than or equal to 2.50 g/cm³, greater than or equal to 2.48 g/cm³ and less than or equal to 2.50 g/cm³, greater than or equal to 2.40 g/cm³ and less than or equal to 2.48 g/cm³, greater than or equal to 2.42 g/cm³ and less than or equal to 2.48 g/cm³, greater than or equal to 2.45 g/cm³ and less than or equal to 2.48 g/cm³, greater than or equal to 2.40 g/cm³ and less than or equal to 2.45 g/cm³, greater than or equal to 2.42 g/cm³ and less than or equal to 2.45 g/cm³, or greater than or equal to 2.40 g/cm³ and less than or equal to 2.42 g/cm³. It should be understood that the above ranges include all subranges within the explicitly disclosed ranges.

In embodiments, the glass-ceramic articles described herein may be subjected to a media blasting and etching process to provide the glass-ceramic articles with a textured surface with antiglare optical properties. The media blasting and etching process may involve an abrasion step wherein a surface of the glass-ceramic article is abraded by propelling abrasive particles, e.g., SiC or Al₂O₃ particles, against the surface, and an etching step wherein the abraded surface is etched with an etchant to achieve a particular surface roughness.

The abrasion step of the media blasting and etching process may involve abrading the glass-ceramic articles to a surface roughness Ra value of greater than or equal to 10 nm and less than or equal to 1000 nm, greater than or equal to 10 nm and less than or equal to 500 nm, greater than or equal to 10 nm and less than or equal to 400 nm, greater than or equal to 10 nm and less than or equal to 300 nm, greater than or equal to 10 nm and less than or equal to 200 nm, greater than or equal to 5 nm and less than or equal to 200 nm, greater than or equal to 25 nm and less than or equal to 200 nm, greater than or equal to 25 nm and less than or equal to 150 nm, greater than or equal to 25 nm and less than or equal to 100 nm, or greater than or equal to 50 nm and less than or equal to 100 nm. As used herein, surface roughness Ra refers to the arithmetical mean deviation of a measured profile (e.g., by running a 10 mm line trace using a Zygo® Newview™ 9000 Optical Surface Profiler). The etching step of the media blasting and etching process may involve contacting the abraded surface with an etchant to remove material from the surface, e.g., from about to 5 μm to 50 μm, to create a textured surface on the glass-ceramic article. In embodiments, the textured surface of the glass-ceramic articles of the present disclosure may have a surface roughness Ra value of greater than or equal to 10 nm and less than or equal to 5000 nm, greater than or equal to 10 nm and less than or equal to 4000 nm, greater than or equal to 10 nm and less than or equal to 3000 nm, greater than or equal to 10 nm and less than or equal to 2000 nm, greater than or equal to 10 nm and less than or equal to 1800 nm, greater than or equal to 10 nm and less than or equal to 1600 nm, greater than or equal to 10 nm and less than or equal to 1400 nm, greater than or equal to 10 nm and less than or equal to 1200 nm, greater than or equal to 20 nm and less than or equal to 1600 nm, greater than or equal to 20 nm and less than or equal to 1400 nm, greater than or equal to 20 nm and less than or equal to 1200 nm, greater than or equal to 30 nm and less than or equal to 1600 nm, greater than or equal to 30 nm and less than or equal to 1400 nm, greater than or equal to 30 nm and less than or equal to 1200 nm, greater than or equal to 40 nm and less than or equal to 1600 nm, greater than or equal to 40 nm and less than or equal to 1400 nm, greater than or equal to 40 nm and less than or equal to 1200 nm, greater than or equal to 50 nm and less than or equal to 1600 nm, greater than or equal to 50 nm and less than or equal to 1400 nm, greater than or equal to 50 nm and less than or equal to 1200 nm, greater than or equal to 100 nm and less than or equal to 1600 nm, greater than or equal to 100 nm and less than or equal to 1400 nm, greater than or equal to 100 nm and less than or equal to 1200 nm, greater than or equal to 150 nm and less than or equal to 1600 nm, greater than or equal to 150 nm and less than or equal to 1400 nm, greater than or equal to 150 nm and less than or equal to 1200 nm, greater than or equal to 200 nm and less than or equal to 1600 nm, greater than or equal to 200 nm and less than or equal to 1400 nm, or greater than or equal to 200 nm and less than or equal to 1200 nm.

In embodiments, the textured surface of the glass-ceramic articles of the present disclosure may have a surface roughness Ra value of greater than or equal to 300 nm and less than or equal to 1200 nm, greater than or equal to 400 nm and less than or equal to 1200 nm, greater than or equal to 400 nm and less than or equal to 1100 nm, greater than or equal to 400 nm and less than or equal to 1000 nm, greater than or equal to 400 nm and less than or equal to 900 nm, greater than or equal to 500 nm and less than or equal to 900 nm, greater than or equal to 500 nm and less than or equal to 800 nm, or greater than or equal to 600 nm and less than or equal to 800 nm. In embodiments, the textured surface comprises a surface roughness Ra value of about 1000, 900, 800, 700, 600, 500, 400, 300, 200, 100, 50, 25, 10, 5, 1, 0.5, or 0.1 nanometers, and all surface roughness values between these levels.

In embodiments, following the etching step of the media blasting and etching process, the textured surface may subjected to an additional etching treatment comprising a low pH etchant treatment followed by a high pH etchant treatment, such that the resulting surface roughness comprises a low spatial frequency component formed by the abrasion and etching steps, and a high spatial frequency component, formed by the subsequent etching treatment. The low spatial frequency component may be associated with an average lateral feature size that exceeds an average lateral feature size associated with the high spatial frequency component.

Additional details on regarding suitable methods, parameters, and resulting surface textures for the media blasting and etching process may be found in, for example, U.S. Patent Application Publication No. 2023/0076143 entitled “Textured Glass-Based Articles,” filed Aug. 23, 2022, and regarding suitable methods, parameters, and resulting surface textures for the subsequent etching treatment may be found in, for example, U.S. Patent Application Publication No. 2024/0317639 entitled “Textured, Antiglare Glass Articles and Methods of Making the Same,” filed Jun. 4, 2024, both of which are incorporated by reference herein in their entirety.

In one or more embodiments, the glass-ceramic articles described herein may have an antireflective coating disposed on a surface, e.g., a textured surface, of the glass ceramic article. The antireflective coating may comprise a plurality of alternating high refractive index and low refractive index layers. Suitable materials for the low refractive index layer include: SiO₂, Al₂O₃, GeO₂, SiOₓ, AlOₓN_{y}, SiOₓN_{y}, SiAl_{y}OₓN_{y}, MgO and MgAl₂O₄. Suitable materials for the high refractive index layer include: Al₂O₃, AlOₓN_{y}, SiOₓN_{y}, SiAl_{y}OₓN_{y}, AlN, SiNₓ, Si₃N₄, Nb₂O₅, Ta₂O₅, HfO₂, TiO₂, ZrO₂, Y₂O₃, and diamond-like carbon. Further, the thicknesses of each of the low and high refractive index layers and can range from about 1 nm to about 250 nm and the total thickness of the antireflective coating can range from about 5 nm to 3000 nm, 5 nm to 2500 nm, 5 nm to 2000 nm, from 5 nm to 1500 nm, from 5 nm to 1000 nm, from 5 nm to 750 nm, from 5 nm to 500 nm, from 5 nm to 450 nm, from 5 nm to 400 nm, from 5 nm to 350 nm, from 5 nm to 300 nm, from 5 nm to 275 nm, from 5 nm to 260 nm, from 5 nm to 250 nm, from 100 nm to 500 nm, from 100 nm to 400 nm, from 100 nm to 350 nm, from 100 nm to 300 nm, from 100 nm to 275 nm, from 100 nm to 250 nm, from 200 nm to 500 nm, from 200 nm to 400 nm, from 200 nm to 350 nm, from 200 nm to 300 nm, from 200 nm to 275 nm, from 200 nm to 250 nm, from 250 nm to 350 nm, from 250 nm to 340 nm, and all thickness values within the foregoing ranges. Additional details on regarding suitable methods, parameters, and resulting surface textures for antireflective coatings may be found in, for example, U.S. Patent Application Publication No. 2024/0230955 entitled “Display Articles with Antiglare Surfaces and Thin, Durable Antireflection Coatings,” filed Mar. 25, 2024, which is incorporated by reference herein in its entirety.

In one or more embodiments, the glass-ceramic articles disclosed herein comprising a textured surface have a haze, measured on a 0.5 mm thick glass-ceramic article, of greater than or equal to 0.2% and less than or equal to 98%, greater than or equal to 0.4% and less than or equal to 98%, greater than or equal to 0.6% and less than or equal to 98%, greater than or equal to 0.8% and less than or equal to 98%, greater than or equal to 1.0% and less than or equal to 98%, greater than or equal to 2% and less than or equal to 98%, greater than or equal to 3.0% and less than or equal to 98%, greater than or equal to 4.0% and less than or equal to 98%, greater than or equal to 5.0% and less than or equal to 98%, greater than or equal to 6.0% and less than or equal to 98%, greater than or equal to 7% and less than or equal to 98%, greater than or equal to 8.0% and less than or equal to 98%, greater than or equal to 9.0% and less than or equal to 98%, greater than or equal to 10% and less than or equal to 98%, greater than or equal to 15% and less than or equal to 98%, greater than or equal to 20% and less than or equal to 98%, greater than or equal to 25% and less than or equal to 98%, greater than or equal to 30% and less than or equal to 98%, greater than or equal to 35% and less than or equal to 98%, greater than or equal to 40% and less than or equal to 98%, greater than or equal to 45% and less than or equal to 98%, greater than or equal to 50% and less than or equal to 98%, greater than or equal to 0.2% and less than or equal to 95%, greater than or equal to 0.4% and less than or equal to 95%, greater than or equal to 0.6% and less than or equal to 95%, greater than or equal to 0.8% and less than or equal to 95%, greater than or equal to 1.0% and less than or equal to 95%, greater than or equal to 2% and less than or equal to 95%, greater than or equal to 3.0% and less than or equal to 95%, greater than or equal to 4.0% and less than or equal to 95%, greater than or equal to 5% and less than or equal to 95%, greater than or equal to 6.0% and less than or equal to 95%, greater than or equal to 7% and less than or equal to 95%, greater than or equal to 8.0% and less than or equal to 95%, greater than or equal to 9.0% and less than or equal to 95%, greater than or equal to 10% and less than or equal to 95%, greater than or equal to 15% and less than or equal to 95%, greater than or equal to 20% and less than or equal to 95%, greater than or equal to 25% and less than or equal to 95%, greater than or equal to 30% and less than or equal to 95%, greater than or equal to 35% and less than or equal to 95%, greater than or equal to 40% and less than or equal to 95%, greater than or equal to 45% and less than or equal to 95%, greater than or equal to 50% and less than or equal to 95%, greater than or equal to 0.2% and less than or equal to 90%, greater than or equal to 0.4% and less than or equal to 90%, greater than or equal to 0.6% and less than or equal to 90%, greater than or equal to 0.8% and less than or equal to 90%, greater than or equal to 1.0% and less than or equal to 90%, greater than or equal to 2% and less than or equal to 90%, greater than or equal to 3.0% and less than or equal to 90%, greater than or equal to 4.0% and less than or equal to 90%, greater than or equal to 5.0% and less than or equal to 90%, greater than or equal to 6.0% and less than or equal to 90%, greater than or equal to 7% and less than or equal to 90%, greater than or equal to 8.0% and less than or equal to 90%, greater than or equal to 9.0% and less than or equal to 90%, greater than or equal to 10% and less than or equal to 90%, greater than or equal to 15% and less than or equal to 90%, greater than or equal to 20% and less than or equal to 90%, greater than or equal to 25% and less than or equal to 90%, greater than or equal to 30% and less than or equal to 90%, greater than or equal to 35% and less than or equal to 90%, greater than or equal to 40% and less than or equal to 90%, greater than or equal to 45% and less than or equal to 90%, greater than or equal to 50% and less than or equal to 90%, greater than or equal to 10% and less than or equal to 85%, greater than or equal to 10% and less than or equal to 80%, greater than or equal to 10% and less than or equal to 75%, greater than or equal to 10% and less than or equal to 70%, greater than or equal to 15% and less than or equal to 85%, greater than or equal to 15% and less than or equal to 80%, greater than or equal to 15% and less than or equal to 75%, greater than or equal to 15% and less than or equal to 70%, greater than or equal to 20% and less than or equal to 85%, greater than or equal to 20% and less than or equal to 80%, greater than or equal to 20% and less than or equal to 75%, greater than or equal to 20% and less than or equal to 70%, greater than or equal to 25% and less than or equal to 85%, greater than or equal to 25% and less than or equal to 80%, greater than or equal to 25% and less than or equal to 75%, greater than or equal to 25% and less than or equal to 70%, greater than or equal to 30% and less than or equal to 85%, greater than or equal to 30% and less than or equal to 80%, greater than or equal to 30% and less than or equal to 75%, greater than or equal to 30% and less than or equal to 70%, greater than or equal to 35% and less than or equal to 85%, greater than or equal to 35% and less than or equal to 80%, greater than or equal to 35% and less than or equal to 75%, greater than or equal to 35% and less than or equal to 70%, greater than or equal to 40% and less than or equal to 85%, greater than or equal to 40% and less than or equal to 80%, greater than or equal to 40% and less than or equal to 75%, greater than or equal to 40% and less than or equal to 70%, greater than or equal to 45% and less than or equal to 85%, greater than or equal to 45% and less than or equal to 80%, greater than or equal to 45% and less than or equal to 75%, greater than or equal to 45% and less than or equal to 70%, greater than or equal to 50% and less than or equal to 85%, greater than or equal to 50% and less than or equal to 80%, greater than or equal to 50% and less than or equal to 75%, or greater than or equal to 50% and less than or equal to 70%.

In one or more embodiments, the glass-ceramic articles disclosed herein comprising an antireflective coating have a haze, measured on a 0.5 mm thick glass-ceramic article, of greater than or equal to 0.2% and less than or equal to 98%, greater than or equal to 0.4% and less than or equal to 98%, greater than or equal to 0.6% and less than or equal to 98%, greater than or equal to 0.8% and less than or equal to 98%, greater than or equal to 1.0% and less than or equal to 98%, greater than or equal to 2% and less than or equal to 98%, greater than or equal to 3.0% and less than or equal to 98%, greater than or equal to 4.0% and less than or equal to 98%, greater than or equal to 5.0% and less than or equal to 98%, greater than or equal to 6.0% and less than or equal to 98%, greater than or equal to 7% and less than or equal to 98%, greater than or equal to 8.0% and less than or equal to 98%, greater than or equal to 9.0% and less than or equal to 98%, greater than or equal to 10% and less than or equal to 98%, greater than or equal to 15% and less than or equal to 98%, greater than or equal to 20% and less than or equal to 98%, greater than or equal to 25% and less than or equal to 98%, greater than or equal to 30% and less than or equal to 98%, greater than or equal to 35% and less than or equal to 98%, greater than or equal to 40% and less than or equal to 98%, greater than or equal to 45% and less than or equal to 98%, greater than or equal to 50% and less than or equal to 98%, greater than or equal to 0.2% and less than or equal to 95%, greater than or equal to 0.4% and less than or equal to 95%, greater than or equal to 0.6% and less than or equal to 95%, greater than or equal to 0.8% and less than or equal to 95%, greater than or equal to 1.0% and less than or equal to 95%, greater than or equal to 2% and less than or equal to 95%, greater than or equal to 3.0% and less than or equal to 95%, greater than or equal to 4.0% and less than or equal to 95%, greater than or equal to 5% and less than or equal to 95%, greater than or equal to 6.0% and less than or equal to 95%, greater than or equal to 7% and less than or equal to 95%, greater than or equal to 8.0% and less than or equal to 95%, greater than or equal to 9.0% and less than or equal to 95%, greater than or equal to 10% and less than or equal to 95%, greater than or equal to 15% and less than or equal to 95%, greater than or equal to 20% and less than or equal to 95%, greater than or equal to 25% and less than or equal to 95%, greater than or equal to 30% and less than or equal to 95%, greater than or equal to 35% and less than or equal to 95%, greater than or equal to 40% and less than or equal to 95%, greater than or equal to 45% and less than or equal to 95%, greater than or equal to 50% and less than or equal to 95%, greater than or equal to 0.2% and less than or equal to 90%, greater than or equal to 0.4% and less than or equal to 90%, greater than or equal to 0.6% and less than or equal to 90%, greater than or equal to 0.8% and less than or equal to 90%, greater than or equal to 1.0% and less than or equal to 90%, greater than or equal to 2% and less than or equal to 90%, greater than or equal to 3.0% and less than or equal to 90%, greater than or equal to 4.0% and less than or equal to 90%, greater than or equal to 5.0% and less than or equal to 90%, greater than or equal to 6.0% and less than or equal to 90%, greater than or equal to 7% and less than or equal to 90%, greater than or equal to 8.0% and less than or equal to 90%, greater than or equal to 9.0% and less than or equal to 90%, greater than or equal to 10% and less than or equal to 90%, greater than or equal to 15% and less than or equal to 90%, greater than or equal to 20% and less than or equal to 90%, greater than or equal to 25% and less than or equal to 90%, greater than or equal to 30% and less than or equal to 90%, greater than or equal to 35% and less than or equal to 90%, greater than or equal to 40% and less than or equal to 90%, greater than or equal to 45% and less than or equal to 90%, greater than or equal to 50% and less than or equal to 90%, greater than or equal to 10% and less than or equal to 85%, greater than or equal to 10% and less than or equal to 80%, greater than or equal to 10% and less than or equal to 75%, greater than or equal to 10% and less than or equal to 70%, greater than or equal to 15% and less than or equal to 85%, greater than or equal to 15% and less than or equal to 80%, greater than or equal to 15% and less than or equal to 75%, greater than or equal to 15% and less than or equal to 70%, greater than or equal to 20% and less than or equal to 85%, greater than or equal to 20% and less than or equal to 80%, greater than or equal to 20% and less than or equal to 75%, greater than or equal to 20% and less than or equal to 70%, greater than or equal to 25% and less than or equal to 85%, greater than or equal to 25% and less than or equal to 80%, greater than or equal to 25% and less than or equal to 75%, greater than or equal to 25% and less than or equal to 70%, greater than or equal to 30% and less than or equal to 85%, greater than or equal to 30% and less than or equal to 80%, greater than or equal to 30% and less than or equal to 75%, greater than or equal to 30% and less than or equal to 70%, greater than or equal to 35% and less than or equal to 85%, greater than or equal to 35% and less than or equal to 80%, greater than or equal to 35% and less than or equal to 75%, greater than or equal to 35% and less than or equal to 70%, greater than or equal to 40% and less than or equal to 85%, greater than or equal to 40% and less than or equal to 80%, greater than or equal to 40% and less than or equal to 75%, greater than or equal to 40% and less than or equal to 70%, greater than or equal to 45% and less than or equal to 85%, greater than or equal to 45% and less than or equal to 80%, greater than or equal to 45% and less than or equal to 75%, greater than or equal to 45% and less than or equal to 70%, greater than or equal to 50% and less than or equal to 85%, greater than or equal to 50% and less than or equal to 80%, greater than or equal to 50% and less than or equal to 75%, or greater than or equal to 50% and less than or equal to 70%.

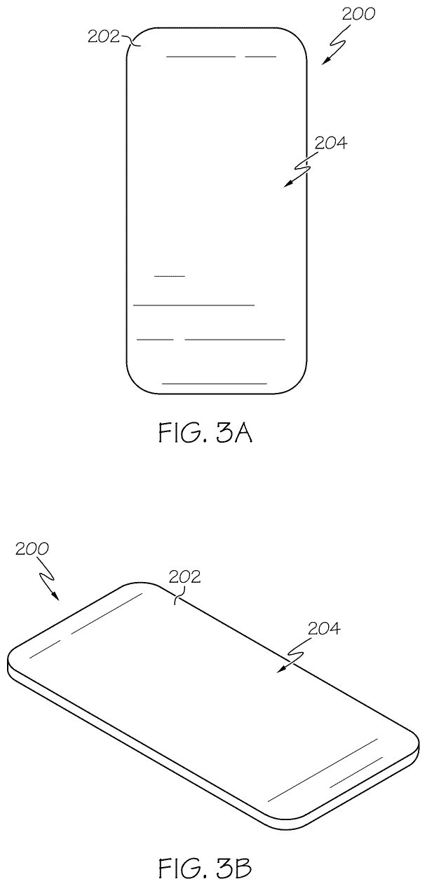

The precursor glass and glass-ceramic articles disclosed herein may be incorporated into another article such as an protective substrate for consumer electronics, including mobile phones, tablets, appliance articles, or any article where controllable translucency and high mechanical performance, including for example, Young's modulus, fracture toughness, scratch-resistance, abrasion resistance, and combinations thereof. An exemplary article incorporating any of the strengthened glass-ceramic articles disclosed herein is shown in FIGS. 3A and 3B.

Specifically, FIGS. 3A and 3B show an electronic device 200 comprising a back side 202 and a front side 206, wherein a protective substrate 202 is positioned on a back side 204. The electronic device 200 further includes electrical components (not shown) that are at least partially inside or entirely within a housing and including at least a controller, a memory, and a display (not shown) at or adjacent to the front side 206 of the device. The protective substrate 202 positioned on the back side 204 may be a glass-ceramic article disclosed herein.

Additionally, the precursor glasses disclosed herein can be cerammed into other shapes (e.g., other than a plate or sheet) with minimal deformation, readily machined to precision shapes, cut, drilled, chamfered, tapped, polished to high luster with conventional ceramic machining tooling and even exhibit various degrees of translucency depending on composition and heat treatment. These properties make the glass-ceramics useful for a broad number of applications in addition to those identified herein, including, without limitation, countertops and other surfaces, appliance doors and exteriors, floor tiles, wall panels, ceiling tiles, white boards, materials storage containers (hollowware) such as beverage bottles, food sales and storage vessels, machine parts requiring light weight, good wear resistance and precise dimensions. The glass-ceramics can be formed in three-dimensional articles using various methods due to its lower viscosity.

Accordingly, various embodiments described herein may be employed to produce glass-ceramic articles having aesthetic translucency properties and reduced warp while not adversely impacting, or even improving, stress in the glass-ceramic articles as compared to glass articles cerammed according to conventional techniques. Such glass-ceramic articles may be particularly well suited for use in portable electronic devices due to their strength performance and aesthetically desirable and controllable translucence.

### EXAMPLES

Various embodiments will be further clarified by the following examples.

The compositions listed in Table 1 were melted and formed into precursor glass plates with thicknesses in the range from 0.75 mm to 0.9 mm. The precursor glass plates were then cerammed according to the ceramming schedules indicated in Tables 2 and 3 for each composition to create glass-ceramic articles, specifically glass-ceramic plates. The exemplary ceramming schedules involved a heating rate of 5° C./min from room temperature to the nucleation temperature, and 2.5° C./min from the nucleation temperature to the growth temperature. Various properties of the glass-ceramic plates were then measured, including the phase assemblage (by Rietveld x-ray diffraction), opacity, haze, transmittance, reflected color, and transmitted color. The properties are reported in Tables 2 and 3 along with the corresponding ceramming schedule for each of the exemplary glass-ceramic articles. For the glass-ceramic articles reported in Table 2, the optical properties were measured on samples that were 0.5 mm thick. For the glass-ceramic articles reported in Table 3, the optical properties were measured on samples that were 0.55 mm thick (unless noted otherwise). Table 2 also describes two comparative glass-ceramic articles (C1 and C2) that do not have particular attributes of the inventive glass-ceramic articles with respect to the phase assemblage. Table 3 includes one comparative glass-ceramic article and corresponding ceramming schedule as well.

TABLE 1
Precursor Glass Compositions

| | Precursor | Precursor |
|---|---|---|
| | Glass | Glass |
| Oxide | Composition | Composition |
| (wt %) | A | B |
| SiO₂ | 72.29 | 70.39 |
| Al₂O₃ | 7.17 | 4.21 |
| P₂O₅ | 2.51 | 0.85 |
| Li₂O | 11.63 | 21.16 |
| Na₂O | 0.07 | 1.5 |
| K₂O | 0.12 | 0.13 |
| ZrO₂ | 5.97 | 1.71 |
| CaO | 0.69 | 0.01 |
| Fe₂O₃ | 0.06 | 0.02 |
| HfO₂ | 0.11 | 0.02 |
| SnO₂ | 0.02 | 0.01 |

TABLE 2
Phase Assemblage and Optical Properties for Glass−
Ceramic Articles Derived from Precursor Glass Composition A

| Example ID | 1 | 2 | 3 | 4 | 5 | 6 | 7 | 8 | 9 | 10 |
|---|---|---|---|---|---|---|---|---|---|---|
| Ceramming Schedule | | | | | | | | | | |
| Nucleation Temp. (° C.) | 580 | 620 | 580 | 660 | 580 | 580 | 580 | 580 | 580 | 575 |
| Nucleation Duration (min) | 240 | 60 | 60 | 60 | 240 | 60 | 60 | 240 | 60 | 240 |
| Growth Temp. (° C.) | 760 | 750 | 750 | 760 | 775 | 760 | 760 | 780 | 780 | 780 |
| Growth Duration (min) | 60 | 60 | 60 | 90 | 60 | 60 | 90 | 45 | 30 | 60 |
| Phase Assemblage (wt %)^{§} | | | | | | | | | | |
| Residual Glass | 14.0 | 20.4 | 20.2 | 20.8 | 24.0 | 11.0 | 11.1 | 24.3 | 15.1 | 24.6 |
| Lithium Disilicate | 39.3 | 38.1 | 38.1 | 34.8 | 37.0 | 40.8 | 41.7 | 36.6 | 38.9 | 35.9 |
| Petalite | 44.4 | 38.5 | 39.4 | 34.9 | 30.2 | 42.8 | 38.1 | 26.8 | 27.2 | 23.1 |
| Virgilite | 2.3 | 3.0 | 2.3 | 6.4 | 8.6 | 5.4 | 4.5 | 12.3 | 17.1 | 16.4 |
| B-Spodumene | 0.0 | 0.0 | 0.0 | 0.8 | 0.0 | 0.0 | 1.3 | 0.0 | 0.0 | 0.0 |
| Lithium Phosphate | 0.0 | 0.0 | 0.0 | 2.4 | 0.0 | 0.0 | 3.4 | 0.0 | 1.8 | 0.0 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.0 | 0.0 | 0.0 | 0.0 | 0.0 |
| Zircon | 0.0 | 0.0 | 0.0 | 0.0 | 0.0 | 0.0 | 0.0 | 0.0 | 0.0 | 0.0 |
| Cristobalite | 0.0 | 0.0 | 0.0 | 0.0 | 0.0 | 0.0 | 0.0 | 0.0 | 0.0 | 0.0 |
| Lithium Metasilicate | 0.0 | 0.0 | 0.0 | 0.0 | 0.0 | 0.0 | 0.0 | 0.0 | 0.0 | 0.0 |
| Sum of Lithium | 46.7 | 41.5 | 41.8 | 42.1 | 38.8 | 48.2 | 43.8 | 39.1 | 44.3 | 39.5 |
| Aluminosilicate Phases | | | | | | | | | | |
| Sum of Virgilite and | 2.3 | 3.0 | 2.3 | 7.1 | 8.6 | 5.4 | 5.7 | 12.3 | 17.1 | 16.4 |
| B-Spodumene | | | | | | | | | | |
| Optical Properties | | | | | | | | | | |
| Opacity (%)^{†} | 13.6 | 13.8 | 13.8 | 13.9 | 14.0 | 14.0 | 14.0 | 14.0 | 14.2 | 14.5 |
| Haze (%)^{#} | 0.21* | 0.22 | 0.22 | 0.57* | 0.50 | 0.62* | 0.63* | 0.71 | 0.86* | 1.12 |
| Average total | 90.52 | — | — | — | — | 90.36 | — | — | 89.53 | — |
| transmittance (%)** | | | | | | | | | | |
| (400-800 nm) | | | | | | | | | | |
| Average total | 90.67 | — | — | — | — | 90.58 | — | — | 89.97 | — |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | 98.43 | 92.46 | 92.41 | 91.15 | — | 98.34 | 92.07 | — | 97.92 | — |
| a* | −0.18 | −1.00 | −1.01 | −0.70 | — | −0.15 | −1.00 | — | −0.04 | — |
| b* | 0.78 | −0.37 | −0.38 | −1.12 | — | 0.92 | −0.58 | — | 1.10 | — |
| Black Background | | | | | | | | | | |
| L* | 42.89 | 40.03 | 40.07 | 39.53 | — | 43.32 | 40.14 | — | 43.38 | — |
| a* | 0.09 | 0.26 | 0.26 | 0.94 | — | 0.10 | 0.34 | — | 0.41 | — |
| b* | −0.35 | 0.90 | 0.91 | −5.23 | — | −0.83 | 0.24 | — | −3.00 | — |
| Example ID | 11 | 12 | 13 | 14 | 15 | 16 | 17 | 18 | 19 | 20 |
| Ceramming Schedule | | | | | | | | | | |
| Nucleation Temp. (° C.) | 580 | 585 | 580 | 580 | 580 | 580 | 660 | 580 | 580 | 655 |
| Nucleation Duration (min) | 255 | 240 | 240 | 225 | 60 | 120 | 60 | 240 | 240 | 60 |
| Growth Temp. (° C.) | 780 | 780 | 780 | 780 | 775 | 780 | 755 | 780 | 780 | 750 |
| Growth Duration (min) | 60 | 60 | 60 | 60 | 120 | 60 | 60 | 75 | 60 | 60 |
| Phase Assemblage (wt %)^{§} | | | | | | | | | | |
| Residual Glass | 25.2 | 25.5 | 24.8 | 25.6 | 19.5 | 14.3 | 19.3 | 24.9 | 14.9 | 20.3 |
| Lithium Disilicate | 36.2 | 35.9 | 36.2 | 36.0 | 36.7 | 39.6 | 32.3 | 36.0 | 36.5 | 28.9 |
| Petalite | 23.1 | 20.7 | 21.2 | 20.4 | 20.6 | 17.7 | 36.8 | 18.1 | 22.2 | 37.9 |
| Virgilite | 15.4 | 17.9 | 17.8 | 18.0 | 20.7 | 26.0 | 5.0 | 21.0 | 24.2 | 4.2 |
| B-Spodumene | 0.0 | 0.0 | 0.0 | 0.0 | 0.0 | 0.0 | 0.0 | 0.0 | 0.0 | 0.0 |
| Lithium Phosphate | 0.0 | 0.0 | 0.0 | 0.0 | 2.5 | 2.5 | 2.6 | 0.0 | 2.2 | 2.5 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.0 | 0.0 | 0.0 | 0.0 | 0.0 |
| Zircon | 0.0 | 0.0 | 0.0 | 0.0 | 0.0 | 0.0 | 0.0 | 0.0 | 0.0 | 0.0 |
| Cristobalite | 0.0 | 0.0 | 0.0 | 0.0 | 0.0 | 0.0 | 0.7 | 0.0 | 0.0 | 1.5 |
| Lithium Metasilicate | 0.0 | 0.0 | 0.0 | 0.0 | 0.0 | 0.0 | 3.4 | 0.0 | 0.0 | 4.7 |
| Sum of Lithium | 38.5 | 38.6 | 39.0 | 38.4 | 41.3 | 43.7 | 41.8 | 39.1 | 46.4 | 42.1 |
| Aluminosilicate Phases | | | | | | | | | | |
| Sum of Virgilite and | 15.4 | 17.9 | 17.8 | 18.0 | 20.7 | 26.0 | 5.0 | 21.0 | 24.2 | 4.2 |
| B-Spodumene | | | | | | | | | | |
| Optical Properties | | | | | | | | | | |
| Opacity (%)^{†} | 14.5 | 14.6 | 14.7 | 14.8 | 15.0 | 15.3 | 15.3 | 15.4 | 15.5 | 15.5 |
| Haze (%)^{#} | 1.12 | 1.14 | 1.32 | 1.33 | 1.77 | 2.11* | 2.55 | 1.82 | 2.38* | 2.79 |
| Average total | — | — | — | — | — | 87.91 | — | — | 86.65 | — |
| transmittance (%)** | | | | | | | | | | |
| (400-800 nm) | | | | | | | | | | |
| Average total | — | — | — | — | — | 88.86 | — | — | 87.91 | — |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | — | — | — | — | — | 97.62 | — | — | 97.21 | — |
| a* | — | — | — | — | — | 0.16 | — | — | 0.25 | — |
| b* | — | — | — | — | — | 0.19 | — | — | 0.62 | — |
| Black Background | | | | | | | | | | |
| L* | — | — | — | — | — | 44.61 | — | — | 44.69 | — |
| a* | — | — | — | — | — | 0.73 | — | — | 0.89 | — |
| b* | — | — | — | — | — | −7.74 | — | — | −8.86 | — |
| Example ID | 21 | 22 | 23 | 24 | 25 | 26 | 27 | 28 | 29 | 30 |
| Ceramming Schedule | | | | | | | | | | |
| Nucleation Temp. (° C.) | 580 | 660 | 660 | 660 | 660 | 660 | 660 | 665 | 660 | 580 |
| Nucleation Duration (min) | 60 | 60 | 75 | 45 | 60 | 60 | 60 | 60 | 60 | 60 |
| Growth Temp. (° C.) | 780 | 750 | 750 | 750 | 750 | 750 | 750 | 750 | 745 | 780 |
| Growth Duration (min) | 60 | 75 | 60 | 60 | 60 | 60 | 45 | 60 | 60 | 105 |
| Phase Assemblage (wt %)^{§} | | | | | | | | | | |
| Residual Glass | 12.5 | 20.1 | 21.6 | 21.5 | 23.4 | 21.7 | 22.6 | 22.8 | 23.0 | 19.5 |
| Lithium Disilicate | 39.3 | 30.3 | 28.2 | 27.6 | 33.4 | 27.1 | 24.6 | 25.5 | 23.2 | 36.6 |
| Petalite | 17.9 | 37.2 | 36.4 | 37.5 | 35.8 | 37.2 | 37.2 | 37.2 | 37.5 | 9.7 |
| Virgilite | 28.0 | 4.4 | 4.4 | 3.6 | 5.2 | 4.1 | 3.8 | 3.8 | 3.5 | 28.1 |
| B-Spodumene | 0.0 | 0.0 | 0.0 | 0.0 | 0.0 | 0.0 | 0.0 | 0.0 | 0.0 | 4.0 |
| Lithium Phosphate | 2.4 | 2.5 | 2.4 | 2.5 | 0.0 | 2.3 | 2.4 | 2.3 | 2.4 | 2.3 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.0 | 0.0 | 0.0 | 0.0 | 0.0 |
| Zircon | 0.0 | 0.0 | 0.0 | 0.0 | 0.0 | 0.0 | 0.0 | 0.0 | 0.0 | 0.0 |
| Cristobalite | 0.0 | 1.2 | 1.8 | 1.8 | 0.5 | 2.0 | 2.8 | 2.3 | 3.2 | 0.0 |
| Lithium Metasilicate | 0.0 | 4.3 | 5.2 | 5.5 | 1.7 | 5.7 | 6.6 | 6.1 | 7.4 | 0.0 |
| Sum of Lithium | 45.9 | 41.6 | 40.8 | 41.1 | 41.0 | 41.3 | 41.0 | 41.0 | 41.0 | 41.7 |
| Aluminosilicate Phases | | | | | | | | | | |
| Sum of Virgilite and | 28.0 | 4.4 | 4.4 | 3.6 | 5.2 | 4.1 | 3.8 | 3.8 | 3.5 | 32.1 |
| B-Spodumene | | | | | | | | | | |
| Optical Properties | | | | | | | | | | |
| Opacity (%)^{†} | 15.7 | 15.9 | 16.6 | 16.8 | 16.8 | 17.1 | 17.6 | 18.0 | 18.3 | 18.7 |
| Haze (%)^{#} | 2.61* | 3.09 | 3.91 | 4.09 | 4.24 | 4.48 | 4.85 | 5.50 | 5.70 | 4.93 |
| Average total | 87.08 | — | — | — | — | — | — | — | — | — |
| transmittance (%)** | | | | | | | | | | |
| (400-800 nm) | | | | | | | | | | |
| Average total | 88.24 | — | — | — | — | — | — | — | — | — |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | 97.29 | — | — | — | 91.10 | — | — | — | — | — |
| a* | 0.24 | — | — | — | −0.91 | — | — | — | — | — |
| b* | 0.24 | — | — | — | −2.31 | — | — | — | — | — |
| Black Background | | — | — | — | | — | — | — | — | — |
| L* | 44.98 | — | — | — | 42.93 | — | — | — | — | — |
| a* | 0.86 | — | — | — | 0.33 | — | — | — | — | — |
| b* | −9.47 | — | — | — | −12.98 | — | — | — | — | — |
| Example ID | 31 | 32 | 33 | 34 | 35 | 36 | 37 | 38 | 39 | 40 |
| Ceramming Schedule | | | | | | | | | | |
| Nucleation Temp. (° C.) | 580 | 580 | 580 | 580 | 580 | 580 | 580 | 580 | 580 | 580 |
| Nucleation Duration (min) | 60 | 60 | 120 | 60 | 60 | 60 | 60 | 60 | 240 | 60 |
| Growth Temp. (° C.) | 780 | 790 | 790 | 780 | 805 | 780 | 785 | 800 | 785 | 785 |
| Growth Duration (min) | 90 | 60 | 60 | 120 | 60 | 135 | 60 | 30 | 60 | 120 |
| Phase Assemblage (wt %)^{§} | | | | | | | | | | |
| Residual Glass | 15.0 | 15.3 | 14.1 | 20.1 | 21.1 | 19.4 | 20.8 | 19.0 | 25.7 | 19.1 |
| Lithium Disilicate | 39.7 | 38.2 | 38.7 | 41.0 | 35.0 | 36.6 | 40.4 | 36.3 | 34.9 | 36.6 |
| Petalite | 10.2 | 0.0 | 0.0 | 0.0 | 0.0 | 4.8 | 0.0 | 0.0 | 0.0 | 0.0 |
| Virgilite | 32.3 | 38.6 | 39.0 | 33.6 | 29.1 | 33.7 | 32.0 | 36.8 | 36.4 | 37.9 |
| B-Spodumene | 0.0 | 5.8 | 5.8 | 3.2 | 11.1 | 3.1 | 4.5 | 5.2 | 3.0 | 3.9 |
| Lithium Phosphate | 2.8 | 2.2 | 2.5 | 2.2 | 2.8 | 2.4 | 2.3 | 2.7 | 0.0 | 2.5 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.0 | 0.0 | 0.0 | 0.0 | 0.0 |
| Zircon | 0.0 | 0.0 | 0.0 | 0.0 | 0.8 | 0.0 | 0.0 | 0.0 | 0.0 | 0.0 |
| Cristobalite | 0.0 | 0.0 | 0.0 | 0.0 | 0.0 | 0.0 | 0.0 | 0.0 | 0.0 | 0.0 |
| Lithium Metasilicate | 0.0 | 0.0 | 0.0 | 0.0 | 0.0 | 0.0 | 0.0 | 0.0 | 0.0 | 0.0 |
| Sum of Lithium | 42.5 | 44.4 | 44.8 | 36.8 | 40.3 | 41.6 | 36.5 | 42.0 | 39.4 | 41.8 |
| Aluminosilicate Phases | | | | | | | | | | |
| Sum of Virgilite and | 32.3 | 44.4 | 44.8 | 36.8 | 40.3 | 36.8 | 36.5 | 42.0 | 39.4 | 41.8 |
| B-Spodumene | | | | | | | | | | |
| Optical Properties | | | | | | | | | | |
| Opacity (%)^{†} | 19.3 | 21.7 | 22.6 | 22.6 | 22.7 | 23.4 | 24.1 | 25.0 | 25.4 | 26.5 |
| Haze (%)^{#} | 6.78* | 5.12* | 7.46* | 9.27 | 7.78* | 10.60 | 11.38* | 13.72* | 13.65 | 16.81 |
| Average total | 83.65 | 80.87 | 79.92 | — | — | — | 81.74 | — | — | — |
| transmittance (%)** | | | | | | | | | | |
| (400-800 nm) | | | | | | | | | | |
| Average total | 85.76 | 83.59 | 82.90 | — | — | — | 84.34 | — | — | — |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | 97.41 | 97.81 | 97.81 | — | 97.51 | — | 91.23 | 91.78 | — | — |
| a* | −0.41 | −0.63 | −0.67 | — | −0.72 | — | −0.99 | −1.52 | — | — |
| b* | −0.91 | −0.57 | −0.53 | — | −0.70 | — | −1.85 | −2.64 | — | — |
| Black Background | | | | | | | | | | |
| L* | 49.26 | 52.05 | 52.97 | — | 52.89 | — | 50.38 | 51.53 | — | — |
| a* | −0.09 | −0.57 | −0.72 | — | −0.81 | — | −0.65 | −0.84 | — | — |
| b* | −15.81 | −16.26 | −16.80 | — | −17.66 | — | −20.20 | −19.74 | — | — |
| Example ID | 41 | 42 | 43 | 44 | 45 | 46 | 47 | 48 | 49 | 50 |
| Ceramming Schedule | | | | | | | | | | |
| Nucleation Temp. (° C.) | 580 | 620 | 580 | 580 | 580 | 585 | 580 | 580 | 575 | 580 |
| Nucleation Duration (min) | 240 | 60 | 240 | 60 | 60 | 240 | 240 | 225 | 240 | 240 |
| Growth Temp. (° C.) | 795 | 800 | 800 | 800 | 795 | 800 | 800 | 800 | 800 | 800 |
| Growth Duration (min) | 60 | 60 | 45 | 60 | 60 | 60 | 60 | 60 | 60 | 60 |
| Phase Assemblage (wt %)^{§} | | | | | | | | | | |
| Residual Glass | 20.2 | 20.6 | 20. | 14.3 | 19.6 | 19.4 | 15.7 | 19.9 | 19.7 | 18.0 |
| Lithium Disilicate | 36.2 | 35.6 | 36.1 | 37.8 | 36.4 | 35.7 | 36.8 | 35.3 | 35.4 | 36.2 |
| Petalite | 0.0 | 0.0 | 0.0 | 0.0 | 0.0 | 0.0 | 0.0 | 0.0 | 0.0 | 0.0 |
| Virgilite | 37.8 | 34.1 | 34.9 | 36.1 | 35.0 | 35.8 | 36.8 | 35.8 | 35.5 | 36.0 |
| B-Spodumene | 3.5 | 6.8 | 6.5 | 9.0 | 6.2 | 6.9 | 8.1 | 6.9 | 7.2 | 7.3 |
| Lithium Phosphate | 2.4 | 2.8 | 1.7 | 2.7 | 3.0 | 2.2 | 2.6 | 2.1 | 2.2 | 2.6 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.0 | 0.0 | 0.0 | 0.0 | 0.0 |
| Zircon | 0.0 | 0.0 | 0.0 | 0.0 | 0.0 | 0.0 | 0.0 | 0.0 | 0.0 | 0.0 |
| Cristobalite | 0.0 | 0.0 | 0.0 | 0.0 | 0.0 | 0.0 | 0.0 | 0.0 | 0.0 | 0.0 |
| Lithium Metasilicate | 0.0 | 0.0 | 0.0 | 0.0 | 0.0 | 0.0 | 0.0 | 0.0 | 0.0 | 0.0 |
| Sum of Lithium | 41.3 | 40.9 | 41.4 | 45.1 | 41.2 | 42.7 | 44.9 | 42.7 | 42.7 | 43.3 |
| Aluminosilicate Phases | | | | | | | | | | |
| Sum of Virgilite and | 41.3 | 40.9 | 41.4 | 45.1 | 41.2 | 42.7 | 44.9 | 42.7 | 42.7 | 43.3 |
| B-Spodumene | | | | | | | | | | |
| Optical Properties | | | | | | | | | | |
| Opacity (%)^{†} | 27.2 | 27.3 | 27.8 | 27.9 | 28.3 | 29.2 | 29.2 | 29.6 | 30.0 | 30.2 |
| Haze (%)^{#} | 24.61 | 19.54* | 19.03 | 20.99* | 22.16* | 23.79 | 24.52* | 17.77 | 25.32 | 26.52 |
| Average total | — | — | — | 74.57 | 77.63 | — | 73.75 | — | — | — |
| transmittance (%)** | | | | | | | | | | |
| (400-800 nm) | | | | | | | | | | |
| Average total | — | — | — | 78.25 | 80.87 | — | 77.71 | — | — | — |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | — | 92.00 | — | 97.91 | 91.65 | — | 97.94 | — | — | — |
| a* | — | −1.50 | — | −0.69 | −1.23 | — | −0.78 | — | — | — |
| b* | — | −2.39 | — | −0.08 | −1.70 | — | −0.01 | — | — | — |
| Black Background | | | | | | | | | | |
| L* | — | 53.69 | — | 58.01 | 54.31 | — | 59.19 | — | — | — |
| a* | — | 0.96 | — | −1.25 | −1.18 | — | −1.61 | — | — | — |
| b* | — | −18.59 | — | −16.59 | −19.55 | — | −17.66 | — | — | — |
| Example ID | 51 | 52 | 53 | 54 | 55 | 56 | 57 | 58 | 59 | 60 |
| Ceramming Schedule | | | | | | | | | | |
| Nucleation Temp. (° C.) | 580 | 580 | | 580 | 660 | 580 | 580 | | 580 | 580 |
| Nucleation Duration | 240 | 60 | | 240 | 60 | 255 | 60 | | 240 | 60 |
| (min) | | | | | | | | | | |
| Growth Temp. (° C.) | 800 | 780 | 800 | 805 | 800 | 800 | 810 | 800 | 820 | 820 |
| Growth Duration (min) | 75 | 120 | 60 | 60 | 60 | 60 | 60 | 60 | 60 | 60 |
| Phase Assemblage (wt %)^{§} | | | | | | | | | | |
| Residual Glass | 18.8 | 20.4 | 20.2 | 20.1 | 20.3 | 21.8 | 20.4 | 21.0 | 17.3 | 16.8 |
| Lithium Disilicate | 35.7 | 38.7 | 36.4 | 35.1 | 35.7 | 33.8 | 33.2 | 37.2 | 32.2 | 32.6 |
| Petalite | 0.0 | 0.0 | 0.0 | 0.0 | 0.0 | 0.0 | 0.0 | 0.0 | 0.0 | 0.0 |
| Virgilite | 35.5 | 33.6 | 33.9 | 32.8 | 32.4 | 28.5 | 21.9 | 31.6 | 13.1 | 8.5 |
| B-Spodumene | 7.8 | 4.7 | 6.9 | 8.8 | 9.2 | 12.0 | 17.1 | 7.3 | 27.9 | 32.2 |
| Lithium Phosphate | 2.2 | 2.7 | 2.6 | 2.1 | 2.5 | 2.0 | 2.8 | 2.5 | 2.5 | 2.7 |
| Tetragonal ZrO₂ | 0.0 | 0.0 | 0.0 | 0.0 | 0.0 | 0.0 | 0.0 | 0.0 | 0.0 | 0.0 |
| K₂Zr₂O₅ | 0.0 | 0.0 | 0.0 | 0.0 | 0.0 | 0.6 | 0.9 | 0.0 | 1.5 | 1.6 |
| Zircon | 0.0 | 0.0 | 0.0 | 0.0 | 0.0 | 0.0 | 3.7 | 0.4 | 5.5 | 5.2 |
| Cristobalite | 0.0 | 0.0 | 0.0 | 0.0 | 0.0 | 0.0 | 0.0 | 0.0 | 0.0 | 0.3 |
| Lithium Metasilicate | 0.0 | 0.0 | 0.0 | 1.1 | 0.0 | 1.2 | 0.0 | 0.0 | 0.0 | 0.0 |
| Sum of Lithium | 43.3 | 38.2 | 40.8 | 41.6 | 41.6 | 40.5 | 39.0 | 38.9 | 40.9 | 40.7 |
| Aluminosilicate Phases | | | | | | | | | | |
| Sum of Virgilite and | 43.3 | 38.2 | 40.8 | 41.6 | 41.6 | 40.5 | 39.0 | 38.9 | 40.9 | 40.7 |
| B-Spodumene | | | | | | | | | | |
| Optical Properties | | | | | | | | | | |
| Opacity (%)^{†} | 32.7 | 33.1 | 33.2 | 34.3 | 35.0 | 35.1 | 40.5 | 42.7 | 46.5 | 47.7 |
| Haze (%)^{#} | 33.54 | 34.38* | 34.74* | 44.57 | 39.36* | 38.00 | 53.47* | 59.16* | 69.01* | 72.23* |
| Average total | — | — | — | — | — | — | 69.91 | — | 55.59 | 55.51 |
| transmittance (%)** | | | | | | | | | | |
| (400-800 nm) | | | | | | | | | | |
| Average total | — | — | — | — | — | — | 74.04 | — | 61.59 | 61.49 |
| transmittance (%) | | | | | | | | | | |
| (400-1000 nm) | | | | | | | | | | |
| Reflected Color | | | | | | | | | | |
| Coordinates | | | | | | | | | | |
| White Background | | | | | | | | | | |
| L* | — | 98.23 | 98.32 | — | 92.42 | — | 93.00 | 98.40 | 98.42 | 98.46 |
| a* | — | −0.59 | −0.55 | — | −1.33 | — | −0.93 | −0.42 | −0.40 | −0.38 |
| b* | — | 0.27 | 0.37 | — | −1.96 | — | −0.82 | 0.58 | 0.48 | 0.46 |
| Black Background | | | | | | | | | | |
| L* | — | 62.62 | 62.73 | — | 60.01 | — | 64.34 | 69.84 | 72.36 | 73.21 |
| a* | — | −1.63 | −2.22 | — | −1.91 | — | −1.86 | −2.02 | −2.05 | −1.90 |
| b* | — | −15.15 | −16.34 | — | −17.28 | — | −14.48 | −10.70 | −10.70 | −9.94 |

| Example ID | 61 | 62 | 63 | C1 | C2^{‡} |
|---|---|---|---|---|---|
| Ceramming Schedule | | | | | |
| Nucleation Temp. (° C.) | 580 | 580 | 580 | 585 | 765 |
| Nucleation Duration (min) | 240 | 60 | 60 | 175 | 240 |
| Growth Temp. (° C.) | 840 | 840 | 830 | 735 | 890 |
| Growth Duration (min) | 60 | 60 | 60 | 55 | 240 |
| Phase Assemblage (wt %)^{§} | | | | | |
| Residual Glass | 16.8 | 14.4 | 21.4 | 12.6 | 0.0 |
| Lithium Disilicate | 32.5 | 33.3 | 31.7 | 44.8 | 39.8 |
| Petalite | 0.0 | 0.0 | 0.0 | 42.2 | 0.0 |
| Virgilite | 1.8 | 1.1 | 2.3 | 0.0 | 0.0 |
| B-Spodumene | 38.7 | 40.3 | 36.3 | 0.0 | 45.4 |
| Lithium Phosphate | 3.0 | 3.1 | 3.2 | 0.0 | 4.9 |
| Tetragonal ZrO₂ | 0.0 | 0.0 | 0.0 | 0.0 | 2.2 |
| K₂Zr₂O₅ | 1.6 | 1.6 | 1.4 | 0.0 | 1.8 |
| Zircon | 5.8 | 5.9 | 3.7 | 0.0 | 4.9 |
| Cristobalite | 0.0 | 0.5 | 0.0 | 0.0 | 0.0 |
| Lithium Metasilicate | 0.0 | 0.0 | 0.0 | 0.0 | 0.0 |
| Sum of Lithium | 40.4 | 41.4 | 38.7 | 42.2 | 45.4 |
| Aluminosilicate Phases | | | | | |
| Sum of Virgilite and | 40.4 | 41.4 | 38.7 | 0.0 | 45.4 |
| B-Spodumene | | | | | |
| Optical Properties | | | | | |
| Opacity (%)^{†} | 57.3 | 57.5 | 60.1 | 14.4 | 93.6 |
| Haze (%)^{#} | 96.9* | 97.32* | N/A | 0.12 | N/A |
| Average total | 44.91 | 46.31 | 52.39 | 92.1^{‡} | X |
| transmittance (%)** | | | | | |
| (400-800 nm) | | | | | |
| Average total | 50.87 | 52.13 | 58.57 | 91.9^{‡} | X |
| transmittance (%) | | | | | |
| (400-1000 nm) | | | | | |
| Reflected Color | | | | | |
| Coordinates | | | | | |
| White Background | | | | | |
| L* | 98.49 | 98.50 | 93.86 | 91.99 | 96.08 |
| a* | −0.37 | 0.37 | −0.76 | 0.97 | −0.61 |
| b* | 0.49 | 0.52 | −0.52 | −0.94 | −1.09 |
| Black Background | | | | | |
| L* | 78.98 | 79.07 | 76.59 | 41.28 | 93.58 |
| a* | −1.14 | −1.11 | −1.66 | 0.10 | −1.01 |
| b* | −5.82 | −5.80 | −7.72 | 0.13 | −3.31 |

*Modeled based on measured opacity (low opacity model (opacity ≤ 20): haze = 1.1541 × opacity − 15.518; high opacity model (opacity > 20): haze = 2.5763 × opacity − 50.763)
**Transmittance measured using Perkin Elmer Lambda 950 spectrophotometer
^{§}X-ray diffraction (XRD) is measured on powdered samples using a Bruker D4 Endeavor equipped with Cu radiation and LynxEye detector. Phase assemblage is calculated using Bruker's Topas software package.
^{†}Opacity measured using a CM3700 Colorimeter
^{††}Measured using a 0.6 mm thick sample
^{‡}Comparative Example C2 also contained wt % Baddeleyite
^{#}Haze measured using a BYK Gardner Haze-Gard I haze meter
“—” indicates that the relevant measurement was not performed
“N/A” indicates that the sample fully opaque

TABLE 3
Color Properties for Glass-Ceramic Articles Derived from Precursor Glass
Composition B

| Example ID | 64 | 65 | 66 | 67 | 68 | 69 | 70 | 71 | 72* | 73* |
|---|---|---|---|---|---|---|---|---|---|---|
| Ceramming Schedule | | | | | | | | | | |
| Nucleation Temp. (° C.) | 585 | 585 | 585 | 585 | 585 | 585 | 720 | 720 | 580 | 580 |
| Nucleation Duration (min) | 180 | 180 | 180 | 180 | 180 | 180 | 240 | 240 | 180 | 180 |
| Growth Temp. (° C.) | 800 | 820 | 820 | 820 | 840 | 860 | 850 | 875 | 835 | 845 |
| Growth Duration (min) | 60 | 30 | 45 | 60 | 60 | 60 | 240 | 240 | 60 | 60 |
| Phase Assemblage (wt %)^{§} | | | | | | | | | | |
| Residual Glass | 24.4 | 23.7 | 26.7 | 27.3 | 25.3 | 22.5 | 21.1 | 21.3 | — | — |
| Lithium Disilicate | 38.9 | 38.8 | 38.3 | 37.8 | 37.9 | 37.8 | 38.5 | 37.7 | — | — |
| Petalite | 17.9 | 8.3 | 0.0 | 0.0 | 0.0 | 0.0 | 0.0 | 0.0 | — | — |
| Virgilite | 15.9 | 24.4 | 33 | 32.9 | 29.1 | 5.4 | 0.0 | 0.0 | — | — |
| B-Spodumene | 0.8 | 3 | 0.0 | 0.0 | 5.7 | 31.4 | 37.1 | 37.5 | — | — |
| Lithium Phosphate | 1.9 | 1.9 | 2.1 | 2.1 | 2 | 3 | 3.3 | 3.5 | — | — |
| Tetragonal ZrO₂ | trace | trace | 0.0 | 0.0 | 0.0 | 0.0 | 0.0 | 0.0 | — | — |
| Sum of Lithium | 34.6 | 35.7 | 33 | 32.9 | 34.8 | 36.8 | 37.1 | 37.5 | — | — |
| Aluminosilicate Phases | | | | | | | | | | |
| Sum of Virgilite and | 16.7 | 27.4 | 33 | 32.9 | 34.8 | 36.8 | 37.1 | 37.5 | — | — |
| B-Spodumene | | | | | | | | | | |
| Optical Properties | | | | | | | | | | |
| Opacity (%)^{†} | 19.6 | 27.1 | 30.1 | 28.1 | 34.1 | 49.7 | 49.1 | 48.6 | | |
| Haze (%)^{#} | 18.2 | 32.6 | 43.4 | 45.8 | 71.8 | 94.9 | 97.1 | 96.8 | 67.2 | 78.0 |
| Reflected Color | | | | | | | | | | |
| Coordinates | | | | | | | | | | |
| Black Background | | | | | | | | | | |
| L* | 36.8 | 47 | 50.2 | 47 | 57.9 | 67.7 | 67.2 | 67.1 | 56.8 | 58.9 |
| a* | 0.4 | −1.4 | −1.7 | −1.4 | −1.7 | −1.4 | −1.3 | −1.1 | −1.7 | −1.6 |
| b* | −9.4 | −11.2 | −10.5 | −10.5 | −7.4 | −4 | −3.8 | −3.5 | −7.9 | −7 |
| Transmitted Color | | | | | | | | | | |
| Coordinates | | | | | | | | | | |
| L* | 96.83 | 92.95 | 91.46 | 90.81 | 87.66 | 82.16 | — | — | 87.27 | 85.08 |
| a* | −0.04 | 0.23 | 0.41 | 0.47 | 0.47 | 0.67 | — | — | 0.51 | 0.51 |
| b* | 2.98 | 4.02 | 4.33 | 4.23 | 3.89 | 3 | — | — | 4.1 | 3.63 |

| Example ID | 74* | 75* | 76* | C3 |
|---|---|---|---|---|
| Ceramming Schedule | | | | |
| Nucleation Temp. (° C.) | 590 | 590 | 585 | 585 |
| Nucleation Duration (min) | 180 | 180 | 180 | 180 |
| Growth Temp. (° C.) | 835 | 845 | 835 | 735 |
| Growth Duration (min) | 60 | 60 | 60 | 60 |
| Phase Assemblage (wt %)^{§} | | | | |
| Residual Glass | — | — | 25.6 | 20.0 |
| Lithium Disilicate | — | — | 37.6 | 43.0 |
| Petalite | — | — | 0.0 | 38.0 |
| Virgilite | — | — | 29.8 | 0.0 |
| B-Spodumene | — | — | 4.9 | 0.0 |
| Lithium Phosphate | — | — | 2.1 | 0.0 |
| Tetragonal ZrO₂ | — | — | 0.0 | 0.0 |
| Sum of Lithium | — | — | 34.7 | 38.0 |
| Aluminosilicate Phases | | | | |
| Sum of Virgilite and | — | — | 34.7 | 0.0 |
| B-Spodumene | | | | |
| Optical Properties | | | | |
| Opacity (%)^{†} | — | — | — | — |
| Haze (%)^{#} | 65.4 | 79.1 | 71.5 | — |
| Reflected Color | | | | |
| Coordinates | | | | |
| Black Background | | | | |
| L* | 57.5 | 60.2 | 58.03 | — |
| a* | −1.6 | −1.6 | −1.60 | — |
| b* | −7.5 | −6.7 | −7.36 | — |
| Transmitted Color | | | | |
| Coordinates | | | | |
| L* | 86.71 | 86.04 | 86.00 | — |
| a* | 0.59 | 0.49 | 0.69 | — |
| b* | 3.84 | 3.80 | 5.01 | — |

^{§}X-ray diffraction (XRD) is measured on powdered samples using a Bruker D4 Endeavor equipped with Cu radiation and LynxEye detector. Phase assemblage is calculated using Bruker's Topas software package.
^{†}Opacity measured using a CM3700 Colorimeter
*Sample thickness for measurements was 0.55 mm
^{#}Haze measured using a BYK Gardner Haze-Gard I haze meter
“—” indicates that the relevant measurement was not performed

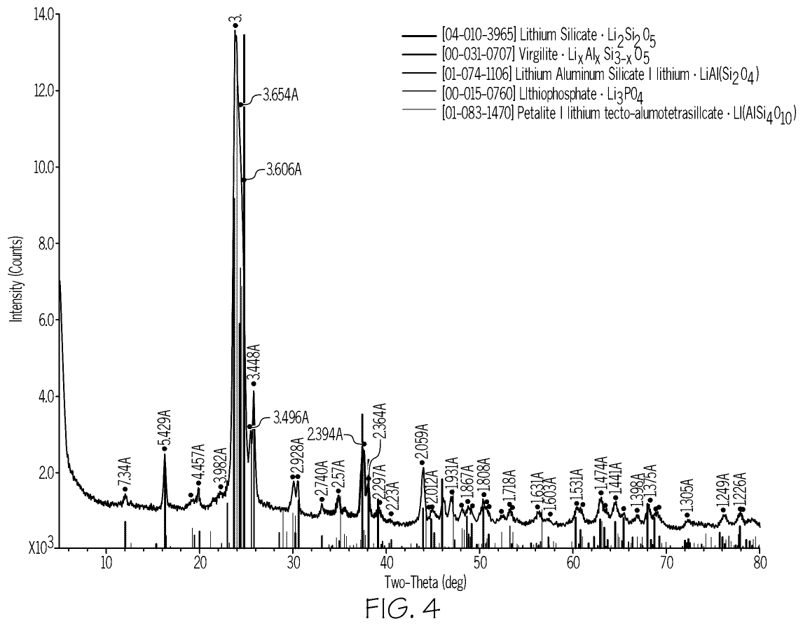

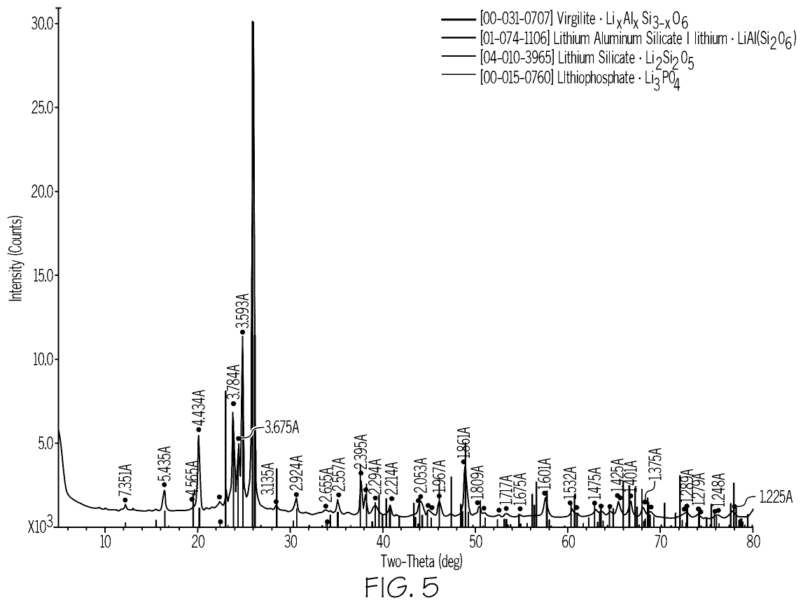

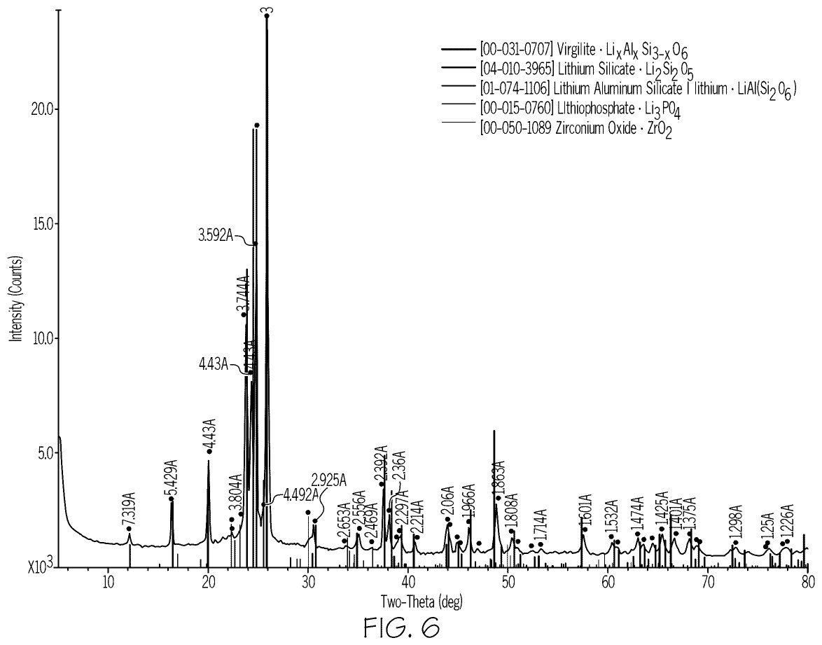

FIG. 4 is an XRD spectrum measured on the glass-ceramic article of Example 7 wherein precursor glass composition A was used and a ceramming schedule consisting of a 1-hour nucleation step at 580° C. and a 1.5-hour growth step at 760° C. The XRD spectrum shown in FIG. 4 indicates the presence of lithium disilicate, petalite, virgilite, β-spodumene, and lithium phosphate. FIG. 5 is an XRD spectrum measured on the glass-ceramic article of Example 47 wherein precursor glass composition A was used and a ceramming schedule consisting of a 4-hour nucleation step at 580° C. and a 1-hour growth step at 800° C. It can be seen from the XRD spectrum shown in FIG. 5 the glass-ceramic article of Example 47 includes lithium disilicate, virgilite, β-spodumene, and lithium phosphate, but no petalite. That is, lengthening the nucleation duration and increasing the growth temperature from 760° C. (e.g., as used in Example 7) to 800° C. resulted in petalite being removed from the phase assemblage and an increased amount of virgilite and β-spodumene in the phase assemblage. FIG. 6 is an XRD spectrum measured on the glass-ceramic article of Example 65 wherein precursor glass composition B was used and a ceramming schedule consisting of a 3-hour nucleation step at 585° C. and a 0.5-hour growth step at 820° C. The XRD spectrum shown in FIG. 6 indicates the presence of lithium disilicate, petalite, virgilite, β-spodumene, lithium phosphate, as well as tetragonal Zr₂O.

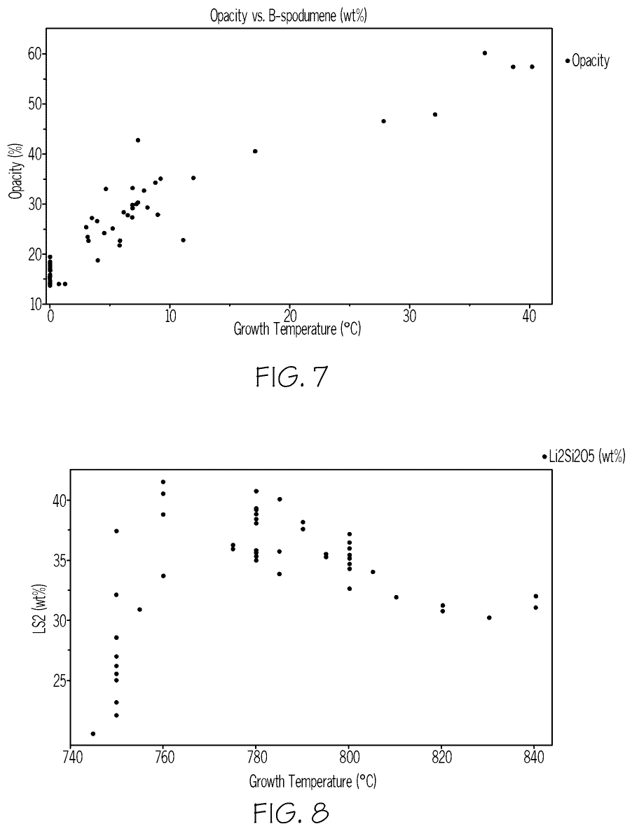

FIG. 7 graphically depicts the relationship between the opacity (y-axis) and the β-spodumene content (x-axis) for glass-ceramic articles formed from precursor glass composition A, where it can be seen that increased levels of β-spodumene in the phase assemblage correlates with increasing opacity.

FIG. 8 graphically depicts the relationship between the growth temperature (x-axis) and the lithium disilicate content (y-axis) for glass-ceramic articles formed from precursor glass composition A, which indicates that the lithium disilicate content is relatively stable over the range of growth temperatures used for the examples.

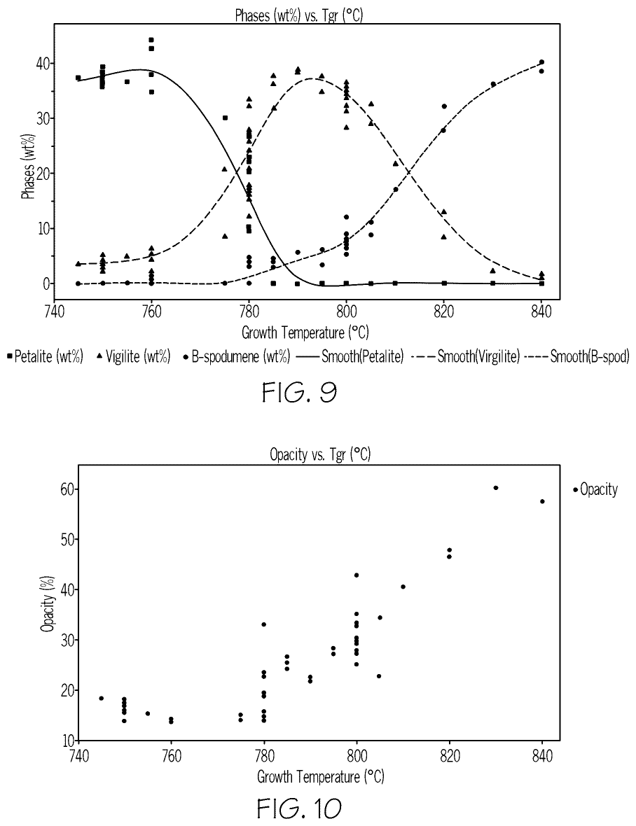

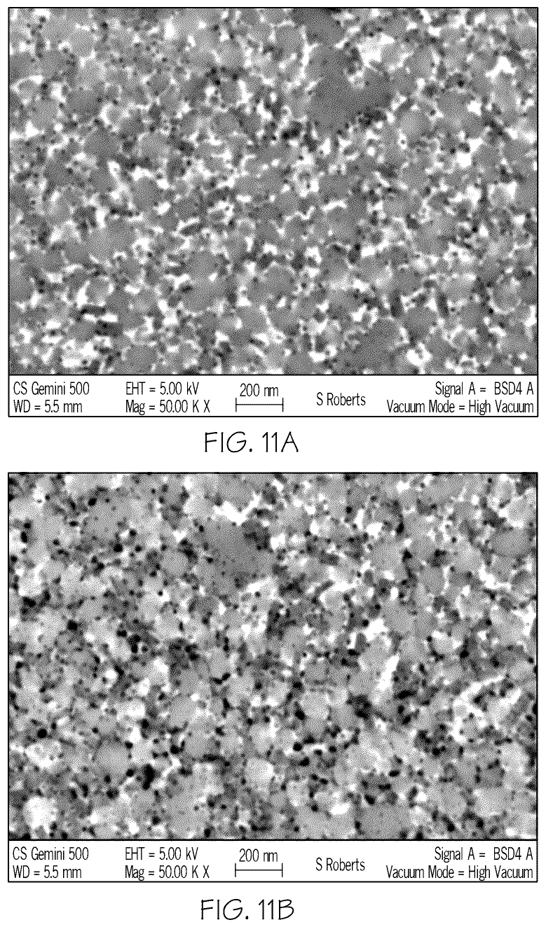

FIG. 9 graphically depicts the relationship between β-spodumene, petalite, and virgilite content (y-axis) and growth temperature (x-axis) for glass-ceramic articles formed from precursor glass composition A. FIG. 9 highlights a surprising phase assemblage sensitivity with respect to the growth temperature in the range of from 760° C. to 840° C. for the glass-ceramic articles described herein. FIG. 10 graphically depicts opacity (y-axis) as a function of growth temperature (x-axis) for glass-ceramic articles formed from precursor glass composition A. When viewed together, FIGS. 9 and 10 demonstrate how the opacity of the glass-ceramic articles can be controlled over a wide range from about 13% to about 65% by adjusting the growth temperature within a relatively small temperature range of from 760° C. to 840° C. Furthermore, and significantly, it can be seen that an opacity between 20% and 50%, which is considered an aesthetically preferred range, can be obtained by selecting a growth temperature in the small range of from 770° C. to 820° C., which coincides well with inflection points in each of the virgilite, β-spodumene, and petalite smoothed curves shown in FIG. 9. Furthermore, it can be seen that by utilizing a growth temperature in an even smaller window of from about 785° C. to about 805° C. (i.e., the peak of the virgilite curve in FIG. 9), the opacity of the glass-ceramic article can be maintained in the aesthetically preferred range of about 20% and 50%.

Furthermore, the discovered ability to control the phase assemblage by varying the ceramming schedule, particularly the growth temperature, is also beneficial because the ability to control the phase assemblage, particularly the β-spodumene content, allows for improved control of ion-exchange procedures for providing the glass-ceramic articles with improved mechanical properties.

FIGS. 11A and 11B show SEM images of Example 47 (4 hours at 580° C. followed by 1 hour at 800° C.; XRD spectrum shown in FIG. 5), where different phases of the phase assemblage can be seen. FIG. 11A is an SEM image of a polished surface and FIG. 11B is an SEM image of a polished and etched (0.5% hydrofluoric acid for 10 seconds) surface. The mid-sized grey grains, on the order of 200 nm, are presumed to be β-spodumene; dark rods are lithium disilicate; and the brightest background is believed to be the residual amorphous glass phase.

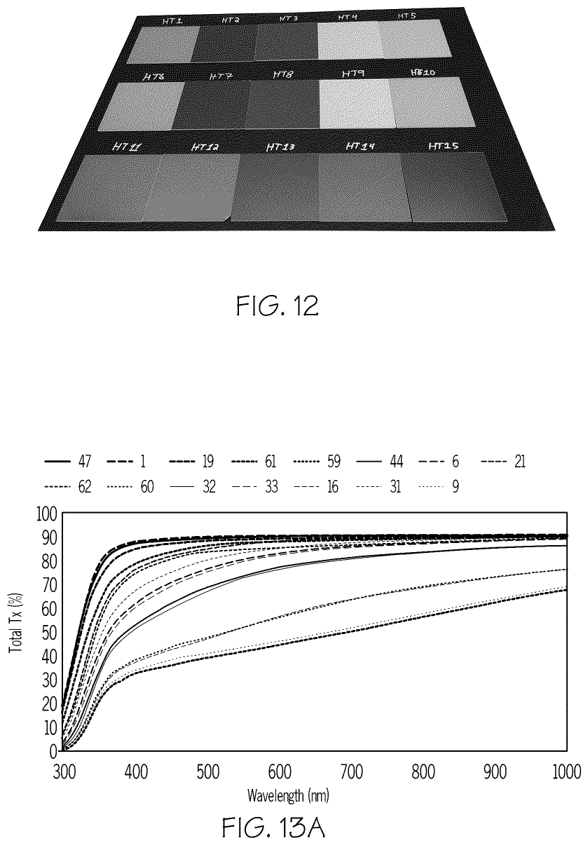

FIG. 12 is a photograph of several exemplary glass-ceramic articles formed from precursor glass composition A on a black background where the varying levels of translucency with relatively small changes to the growth temperature and duration can be observed. HT1 through HT15 correspond to Examples 47 (580-4 h/800-1 h), 1 (580-4 h/760-1 h), 19 (580-4 h/780-1 h), 61 (580-4 h/840-1 h), 59 (580-4 h/820-1 h), 44 (580-1 h/800-1 h), 6 (580-1 h/760-1 h), 21 (580-1 h/780-1 h), 62 (580-1 h/840-1 h), 60 (580-1 h/820-1 h), 32 (580-1 h/790-1 h), 33 (580-2 h/790-1 h), 16 (580-2 h/780-1 h), 31 (580-1 h/780-1.5 h), and 9 (580-1 h/780-0.5 h).

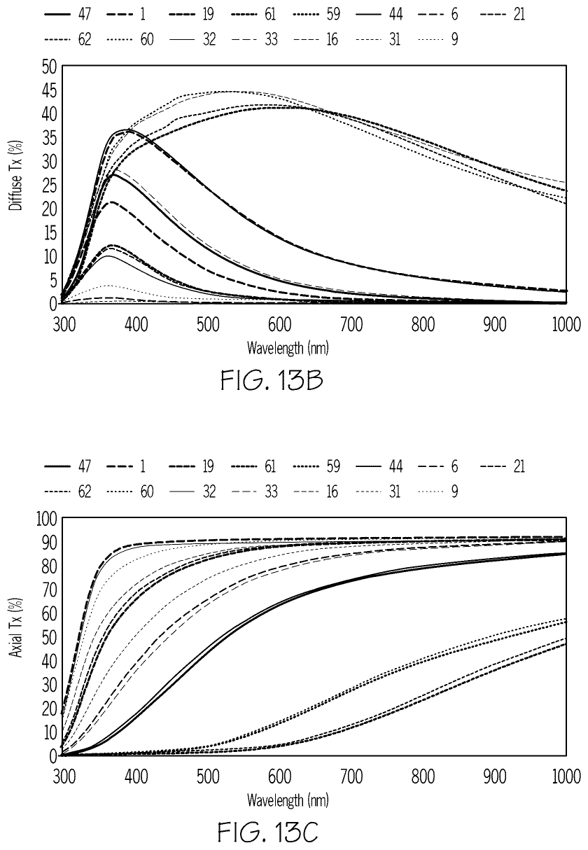

FIGS. 13A-13C graphically depict the total transmittance, diffuse transmittance, and axial transmittance, respectively, as a function of wavelength for the exemplary glass-ceramic articles shown in the photograph in FIG. 12. It can be seen from FIGS. 13A-13C that in addition to controlling the opacity, varying the ceramming schedules to obtain different phase assemblages also allows for significant control of the transmittance spectrum of the glass-ceramic articles.

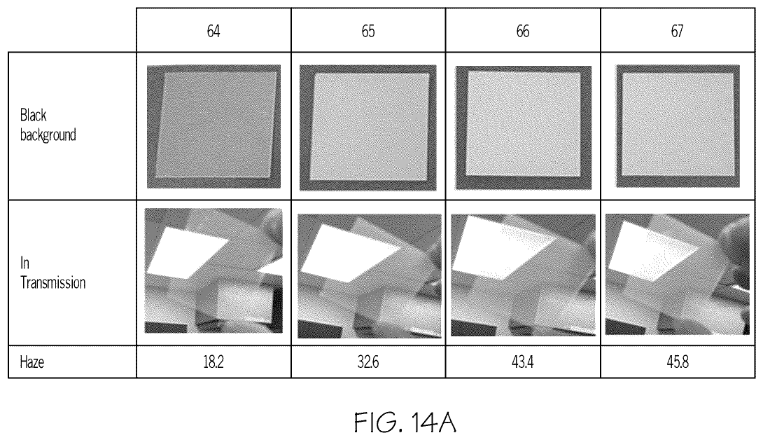

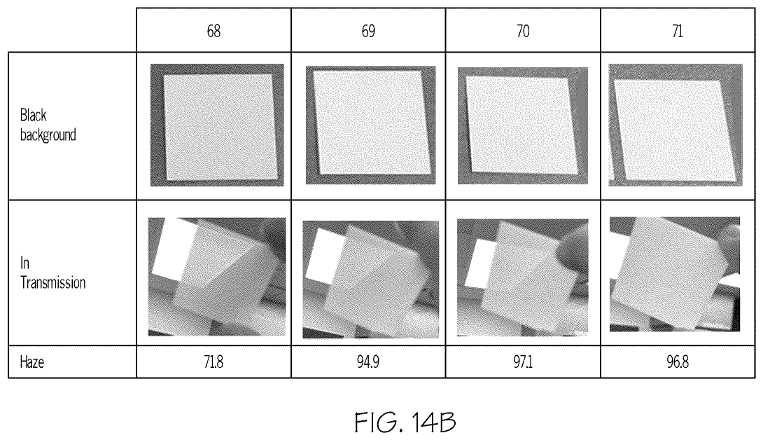

FIGS. 14A and 14B include photographs taken under similar conditions for Examples 64-71, each formed from precursor glass composition B but with varying ceramming schedules, along with the haze of each example reported below the corresponding photograph.

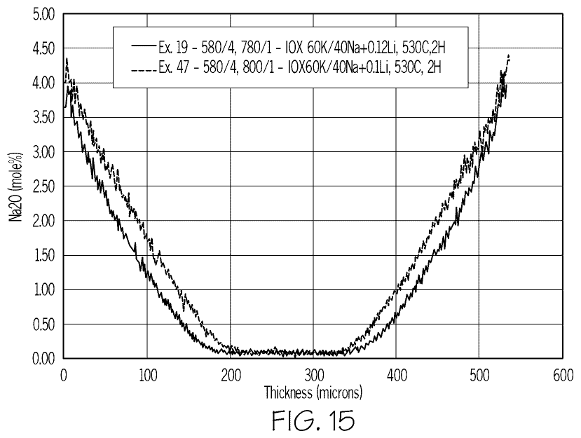

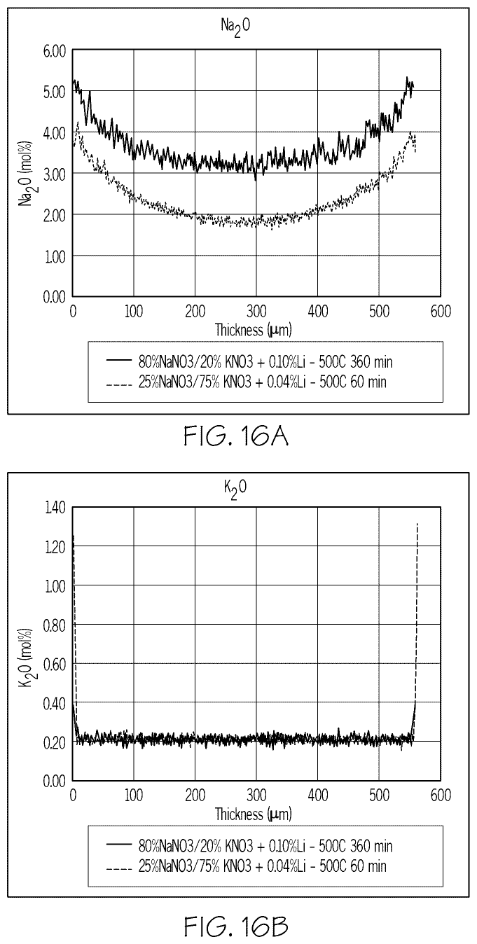

To investigate the ion-exchange capabilities of the glass-ceramic articles described herein, a few example glass-ceramic articles were subject to ion-exchange treatments and then characterized in terms of the Na₂O and/or K₂O concentration profiles (measured by electron microprobe). FIG. 15 graphically depicts the Na₂O concentration profile for glass-ceramic articles according to Examples 19 and 47 (0.55 mm thick) that have been ion-exchanged at 530° C. for 2 hours in a 60% KNO₃/40% NaNO₃ bath+0.12% LiNO₃. FIGS. 16A and 16B graphically depicts the Na₂O and K₂O concentration profiles for glass-ceramic articles according to Example 76, subject to two different ion-exchange procedures: (i) one involving a 20% KNO₃/80% NaNO₃ bath at 500° C. for 6 hours; and (ii) one involving a 75% KNO₃/25% NaNO₃ bath+0.04% LiNO₃ at 500 C for 1 hour, both using a 0.55 mm thick sample.

FIGS. 15, 16A, and 16B show that the level of chemical strengthening via the salt bath can be tuned to achieve the desired mechanical performance. For example, FIG. 16A shows in both examples a deep range of Na for Li replacement is achieved, which is indicative of a high DOC˜20% of the sample thickness. For these two ion-exchange treatments, the results also demonstrate how the bath chemistry impacts the Na₂O concentration at deeper depths, with a higher level of Na₂O at deeper depths enabling increased central tension levels. In FIG. 16B, the two examples shows how the salt bath chemistry helps achieve a near surface portion of the profile enriched in K₂O, which further increases the compression level at or near the surface over the deeper section of the profile which is governed by the Na for Li replacement.

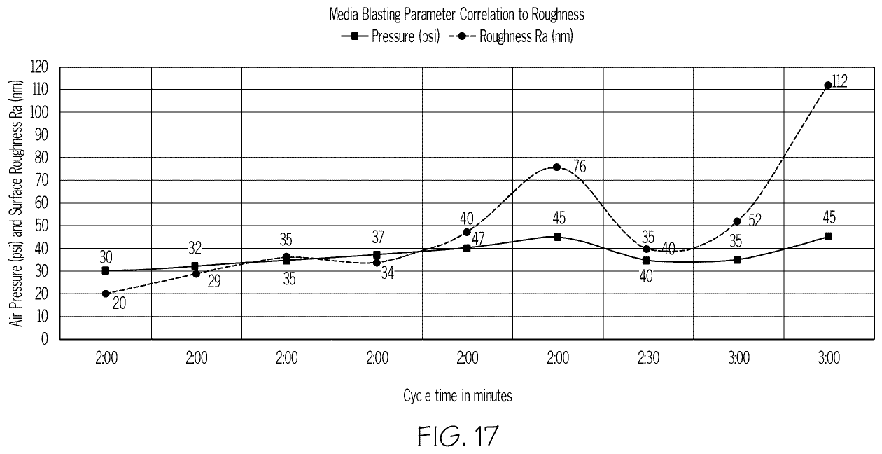

To investigate the ability of the glass-ceramic articles to be textured, a media blasting and etching process was performed on a glass-ceramic according to Example 76. The media blasting process requires sufficient damage site density and specific surface roughness to obtain a targeted pre-etch texture. For example, for a target surface roughness Ra of 50 nm, the media blasting step involved propelling Al₂O₃ particles having an average particle size of 120 μm at a pressure of 35 psi at an angle orthogonal to the surface, from a distance of 6 inches from the surface, and for three minutes. Additional media blasting conditions and the resulting surface roughness Ra values are shown in FIG. 17.

Surface roughness targets as defined by Ra using profilometer were 15 nm, 50 nm and 100 nm. The media blasting process can achieve a broad range of Ra from 5 nm to 200+nm if required. Unless otherwise specified, Ra is measured by a Zygo® Newview™ 9000 Optical Surface Profiler manufactured by Zygo® Corporation, with the following settings: Scan size was 180 microns by 220 microns; Objective: 20× or 50× Mirau; Image Zoom 2×; Camera resolution 0.2777 microns; Filter: low Pass; Filter Type: Average; Filter Low Wavelength 0; Filter High Wavelength: 0.83169 microns. The data obtained by the Zygo® Newview™ 9000 Optical Surface Profiler is analyzed using Montainsmap software per ISO 25178. As used herein, “Sq” refers to root square mean roughness. As used herein, “Sdq” refers to root mean square of slopes. As used herein, “Ssc” refers to the mean summit curvature. Each of Sq, Sdq, pitch, and Ssc are also measured using a Zygo® Newview™ 9000 Optical Surface Profiler.

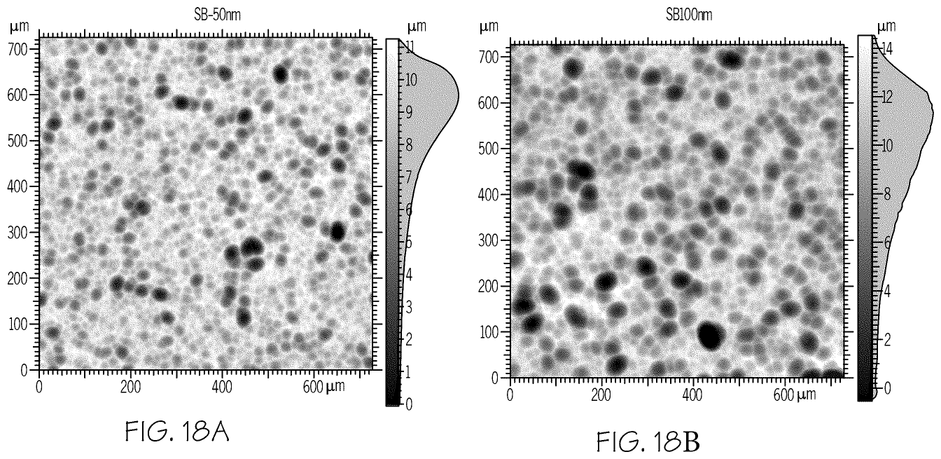

After the media blasting process, the samples were etched using a 5 vol % HF (or 1.45M, or 2.5 wt %) solution for 90 minutes to remove ˜15-20 μm from the surface and create a fine texture on the samples. The etching parameters and obtained etch rates on these samples are presented in Table 4. After the etching process, a surface roughness (Ra) of 0.18 μm, 0.8 μm to 1.0 μm can be obtained on the glass-ceramic articles, as reported in Table 5 and shown in FIGS. 18A and 18B. FIG. 18A shows the roughness obtained when the glass-ceramic article was media blasted to an initial roughness of 50 nm (Ra) followed by etching in HF to remove about 20 μm from the surface. FIG. 18B shows the roughness obtained when the glass-ceramic article was media blasted to an initial roughness of 100 nm (Ra) followed by etching in HF to remove about 20 μm from the surface.

TABLE 4
Removal and etch rates obtained on glass-ceramic
samples (585 C./3 hr + 835 C./1 hr ceram)
media blasted to 50 nm and 100 nm initial roughness

| | | | Initial | Single | Single |
|---|---|---|---|---|---|
| | | Etch | Thick- | side | Side |
| | | time | ness | removal | Etch rate |
| Sample ID | Solution | (min) | (mm) | (um) | (um/min) |
| 50 nm MediaBlast | 5 vol % HF | 90 | 0.55 | 15.59 | 0.17 |
| 100 nm MediaBlast | 5 vol % HF | 90 | 0.55 | 18.34 | 0.20 |

TABLE 5
Roughness measured on translucent/hazy glass-ceramic samples (585
C./3 hr + 835 C./1 hr ceram) media blasted to 50 nm and 100
nm initial roughness after ~20 μm of removal by etching in HF.

| | Ra | Sq | | Pitch, | Ssc, |
|---|---|---|---|---|---|
| Sample | (μm) | (μm) | Sdq | μm | 1/μm |
| Mediablast-100 nm, | 1.02 | 2.66 | 0.51 | 38.2 | 1.16 |
| 20 um etch | | | | | |
| Mediablast-50 nm, | 0.80 | 1.77 | 0.47 | 27.0 | 1.13 |
| 20 um etch | | | | | |
| Mediablast-15 nm, | 0.182 | 0.255 | 0.34 | 5.3 | 1.05 |
| 20 um etch | | | | | |

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in embodiments,” “in one or more embodiments,” “in certain embodiments,” “in various embodiments,” “in one embodiment” or “in an embodiment” in various places throughout this specification are not necessarily referring to the same embodiment, or to only one embodiment. Furthermore, the particular features, structures, materials, or characteristics may be combined in any suitable manner in one or more embodiments.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass-ceramic article comprising:
a phase assemblage comprising:
greater than or equal to 10 wt % and less than or equal to 30 wt % residual amorphous glass phase;
greater than or equal to 20 wt % and less than or equal to 42 wt % lithium disilicate crystalline phase;
less than or equal to 42 wt % spodumene crystalline phase; and
less than or equal to 40 wt % petalite crystalline phase, wherein the glass-ceramic article has:
an opacity greater than or equal to 10% and less than or equal to 65%, measured on a 0.55 mm thick glass-ceramic article; and
a haze greater than or equal to 0.2% and less than or equal to 98%, measured on a 0.5 mm thick glass-ceramic article.

2. The glass-ceramic article of claim 1, wherein the phase assemblage comprises greater than or equal to 2 wt % and less than or equal to 50 wt % of a sum of a virgilite crystalline phase and the spodumene crystalline phase.

3. The glass-ceramic article of claim 2, wherein the phase assemblage comprises greater than or equal to 30 wt % and less than or equal to 50 wt % of the sum of the virgilite crystalline phase and the spodumene crystalline phase, and wherein the glass-ceramic article has at least one of the following optical properties:
the opacity greater than or equal to 18.5% and less than or equal to 65%, measured on a 0.55 mm thick glass-ceramic article; or
the haze greater than or equal to 40% and less than or equal to 95%, measured on a 0.5 mm thick glass-ceramic article.

4. The glass-ceramic article of claim 1, wherein the phase assemblage comprises greater than or equal to 1 wt % and less than or equal to 40 wt % virgilite crystalline phase, and wherein the glass-ceramic article has the haze greater than or equal to 0.2% and less than or equal to 95%, measured on a 0.5 mm thick glass-ceramic article.

5. The glass-ceramic article of claim 4, wherein the phase assemblage comprises less than or equal to 9 wt % of the petalite crystalline phase, and wherein the glass-ceramic article has the opacity greater than or equal to 20% and less than or equal to 50%, measured on a 0.55 mm thick glass-ceramic article.

6. The glass-ceramic article of claim 4, wherein the phase assemblage comprises greater than or equal to 30 wt % and less than or equal to 50 wt % of the sum of the virgilite crystalline phase and the spodumene crystalline phase, and wherein the glass-ceramic article has the opacity greater than or equal to 18.5% and less than or equal to 50%, measured on a 0.55 mm thick glass-ceramic article.

7. The glass-ceramic article of claim 1, wherein the phase assemblage comprises greater than 14 wt % and less than or equal to 30 wt % of the residual amorphous glass phase.

8. The glass-ceramic article of claim 1, wherein the phase assemblage comprises greater than or equal to 2 wt % and less than or equal to 33 wt % of the spodumene crystalline phase.

9. The glass-ceramic article of claim 1, wherein the phase assemblage comprises greater than or equal to 1 wt % and less than or equal to 6 wt % lithium phosphate crystalline phase.

10. The glass-ceramic article of claim 1, comprising:
greater than or equal to 65 wt % and less than or equal to 80 wt % SiO₂;
greater than 2 wt % and less than or equal to 12 wt % Al₂O₃;
greater than or equal to 0.1 wt % and less than or equal to 3.5 wt % P₂O₅;
greater than or equal to 8 wt % and less than or equal to 26 wt % Li₂O;
greater than or equal to 1 wt % and less than or equal to 15 wt % ZrO₂; and
less than or equal to 4 wt % CaO.

11. The glass-ceramic article of claim 10, comprising:
greater than 4 wt % and less than or equal to 12 wt % Al₂O₃;
greater than or equal to 8 wt % and less than or equal to 17 wt % Li₂O;
greater than or equal to 4 wt % and less than or equal to 15 wt % ZrO₂; and
greater than or equal to 0.05 wt % and less than or equal to 4 wt % CaO.

12. The glass-ceramic article of claim 10, comprising:
greater than 2 wt % and less than or equal to 8 wt % Al₂O₃;
greater than or equal to 0.1 wt % and less than or equal to 2 wt % P₂O₅;
greater than or equal to 16 wt % and less than or equal to 26 wt % Li₂O;
greater than or equal to 1 wt % and less than or equal to 6 wt % ZrO₂; and
greater than or equal to 0.5 wt % and less than or equal to 5 wt % Na₂O.

13. The glass-ceramic article of claim 10, comprising less than or equal to 0.1 wt % CaO.

14. The glass-ceramic article of claim 1, wherein the glass-ceramic article has an average total transmittance greater than or equal to 30% and less than or equal to 95%, measured on a 0.55 mm thick glass-ceramic article at wavelengths of 400 nm to 800 nm.

15. The glass-ceramic article of claim 1, wherein the glass-ceramic article exhibits a transmitted color, measured using a D-65-2 illuminant on a glass-ceramic article having a thickness greater than or equal to 0.5 mm and less than or equal to 0.55 mm, presented in CIELAB color space coordinates:
L*=50 to 99;
a*=−5.0 to 10.0; and
b*=−5.0 to 25.0.

16. The glass-ceramic article of claim 1, further comprising:
a compressive stress layer extending from a surface of the glass-ceramic to a depth of compression; and
a central tension, wherein the central tension is greater than or equal to 40 MPa and less than or equal to 170 MPa.

17. The glass-ceramic article of claim 1, wherein the glass-ceramic article has a fracture toughness greater than or equal to 1.0 MPa·m^{1/2} and less than or equal to 2.4 MPa·m^{1/2} prior to strengthening by ion exchange, and the glass-ceramic article has an elastic modulus greater than or equal to 90 GPa and less than or equal to 200 GPa.

18. The glass-ceramic article of claim 1, wherein the glass-ceramic article comprises a textured surface having a surface roughness Ra of greater than or equal to 0.2 μm and less than or equal to 1.2 μm.

19. A glass-ceramic article comprising:
a phase assemblage comprising:
greater than or equal to 10 wt % and less than or equal to 30 wt % residual amorphous glass phase;
greater than or equal to 20 wt % and less than or equal to 42 wt % lithium disilicate crystalline phase;
less than or equal to 42 wt % spodumene crystalline phase; and
greater than or equal to 2 wt % and less than or equal to 50 wt % of a sum of a virgilite crystalline phase and the spodumene crystalline phase, wherein the glass-ceramic article has:
an opacity greater than or equal to 10% and less than or equal to 65%, measured on a 0.55 mm thick glass-ceramic article; and
a haze greater than or equal to 0.2% and less than or equal to 95%, measured on a 0.5 mm thick glass-ceramic article.

20. A method of manufacturing a glass-ceramic article, the method comprising:
maintaining a precursor glass at a nucleation temperature of from 560° C. to 720° C. for a first duration of from 0 to 4.5 hours, thereby forming a nucleated precursor glass, wherein the precursor glass comprises:
greater than or equal to 65 wt % and less than or equal to 80 wt % SiO₂;
greater than 2 wt % and less than or equal to 12 wt % Al₂O₃;
greater than or equal to 0.1 wt % and less than or equal to 3.5 wt % P₂O;
greater than or equal to 8 wt % and less than or equal to 26 wt % Li₂O;
greater than or equal to 1 wt % and less than or equal to 15 wt % ZrO₂; and
less than or equal to 4 wt % CaO; and
maintaining the nucleated precursor glass at a growth temperature of from 740° C. to 880° C. for a second duration of from 0.25 to 4 hours, thereby forming the glass-ceramic article having a phase assemblage comprising:
greater than or equal to 10 wt % and less than or equal to 30 wt % residual amorphous glass phase;
greater than or equal to 20 wt % and less than or equal to 42 wt % lithium disilicate crystalline phase;
less than or equal to 42 wt % spodumene crystalline phase; and
greater than or equal to 2 wt % and less than or equal to 50 wt % of a sum of a virgilite crystalline phase and the spodumene crystalline phase, wherein the glass-ceramic article has:
an opacity greater than or equal to 10% and less than or equal to 65%, measured on a 0.55 mm thick glass-ceramic article; and
a haze greater than or equal to 0.2% and less than or equal to 98%, measured on a 0.5 mm thick glass-ceramic article.
